(19) United States
(12) Patent Application Publication
(10) Pub. No.: US 2025/0078574 A1
(43) Pub. Date: Mar. 6, 2025

(54) AUTOMATIC SIGN LANGUAGE INTERPRETING

(71) Applicant: David Lynn Thomson, Bountiful, UT (US)

(72) Inventor: David Lynn Thomson, Bountiful, UT (US)

(21) Appl. No.: 18/459,415

(22) Filed: Aug. 31, 2023

(51) Int. Cl. G06V 40/20; G06F 40/58; G06V 20/40

(52) U.S. Cl. CPC G06V 40/28; G06F 40/58; G06V 20/46

(57) ABSTRACT

A method may include obtaining a first video data including sign language originating at a first device during a communication session, obtaining one or more features from the first video data, and determining one or more matching functions from the one or more features. The method may further include determining, using a language model, a first set of one or more symbols from the one or more matching functions, and determining a second set of one or more symbols from the first set of one or more symbols.

### CROSS-REFERENCE TO RELATED APPLICATION

This application claims the benefit of U.S. Provisional Patent Application No. 63/374,241, filed Sep. 1, 2022, which is incorporated by reference herein in its entirety.

### FIELD

The embodiments discussed herein are related to sign language communication.

### BACKGROUND

Deaf and hard of hearing people frequently communicate with each other using sign language, but they often face difficulties in communicating with hearing people. Although some deaf can voice and read lips to a degree, their voice may be difficult to understand and their ability to understand what is being said through lip reading may be limited.

The Americans with Disabilities Act (ADA) provides equal access for the deaf for a wide range of services such as law enforcement, medical, business, employment, transportation, government, and telecommunication services. Service providers are required to make accommodations so that their services are accessible to deaf users and to shoulder the cost. The Communications & Video Accessibility Act (CVAA) requires TV, IP-delivered video, and other communication media to be captioned or interpreted.

Currently, accommodations may be provided by human interpreters. When a deaf person who communicates primarily using sign language wishes to communicate with a hearing person who does not know sign language, an interpreter who knows sign language may serve to translate what the hearing person says into sign language (which may be referred to as “interpreting” or “forward interpreting”) and translate sign language from the deaf person into spoken language (which may be referred to as “interpreting” or “reverse interpreting”). Employing human interpreters can be expensive, scheduling can be complicated and inconvenient, and inserting a third party (e.g., the interpreter) into a conversation may raise privacy concerns. Even with accessibility programs in place for some services, it can be difficult for a deaf person to receive services of a human interpreter in some situations encountered in daily life.

The subject matter claimed herein is not limited to embodiments that solve any disadvantages or that operate only in environments such as those described above. Rather, this background is only provided to illustrate one example technology area where some embodiments described herein may be practiced.

### SUMMARY

In some embodiments, a method may include obtaining a first video data including sign language originating at a first device during a communication session, obtaining one or more features from the first video data, and determining one or more matching functions from the one or more features. The method may further include determining, using a language model, a first set of one or more symbols from the one or more matching functions and translating the first set of one or more symbols into a second set of one or more symbols.

### BRIEF DESCRIPTION OF THE DRAWINGS

Example embodiments will be described and explained with additional specificity and detail through the use of the accompanying drawings in which:

FIG. 1 illustrates an example environment for sign language communication.

FIG. 2 illustrates an example environment for sign language communication.

FIG. 2A illustrates an example environment for sign language communication.

FIG. 2B illustrates an example environment for sign language communication.

FIG. 2C illustrates an example environment for sign language communication.

FIG. 3 illustrates an example environment for sign language communication.

FIG. 4 illustrates an example environment for state tying.

FIG. 5 illustrates an example environment for sign language communication.

FIG. 6 illustrates an example environment for optic modeling.

FIG. 7 illustrates an example environment 700 for sign language communication.

FIG. 8 is a flowchart of an example method to interpret sign language.

FIG. 9 illustrates example environments for sign language communication.

FIG. 10 illustrates an example environment for training a network.

FIG. 11 illustrates an example environment for sign language communication.

FIG. 12 illustrates an example system used for sign language communication as described in this disclosure.

### DESCRIPTION OF EMBODIMENTS

Some embodiments in this disclosure describe systems and methods that may be used to facilitate communication between deaf and hearing people. The systems and methods may use machine-based interpreters to convert sign language to speech using automatic sign language recognition (ASLR), achieved by an automatic sign language recognizer (also ASLR). The ASLR may accurately recognize sign language, including continuously-presented, naturally-produced signs spontaneously performed by various signers with various lighting conditions, backgrounds, image quality levels, and types of clothing. The systems and methods may also use machine-based interpreters to convert speech audio to sign language using automatic sign language synthesis (ASLS), achieved by an automatic sign language synthesizer (also ASLS). The machine may include one or more of networks, systems, computers, automated apparatus, and combinations thereof.

Systems currently exist to convert speech audio to text using automatic speech recognition (ASR), performed by an automatic speech recognizer (also ASR). Systems also exist to convert text into speech audio using text-to-speech synthesis (TTS), performed by a TTS synthesizer (TTSS). There is a need to automate interpreting so that deaf parties and hearing parties can communicate with reduced or eliminated reliance on a human interpreter.

In some embodiments, an ASLS may convert audio spoken by a hearing party (HP) into sign language that may be presented on a display for a deaf party (DP). An ASLR may convert video of sign language performed by a DP into audio played for an HP. By at least partly automating the process of converting between sign language and text or audio, communication between deaf and hearing parties may be relatively less expensive, more accessible, and more private, compared to using human interpreters alone.

In some embodiments, terminology used herein may refer to one or more of the definitions described below.

Where neural networks are described herein, the neural networks may be configured as one or more of deep neural networks (DNNs), convolutional neural networks (CNNs), long short-term memory neural networks (LSTMs), recurrent neural networks (RNNs), encoders, decoders, recurrent neural network language models (RNNLMs), temporal convolutional networks (TCNs), time delay networks (TDNNs), transformers, transformers with attention, neural networks with transfer learning, stochastic transformers, generative adversarial networks (GANs), embedding networks, and combinations thereof. Neural networks may include one or more layers. The layers may include one or more of feed-forward, sparsely-connected, densely-connected, fully-connected, linear, CNN, pooling, RNN, LSTM, gated recurrent unit (GRU), temporal convolutional network (TCN), time delay neural network (TDNN), ResNet, WaveNet, attention, self-attention, multi-head attention, masked multi-head attention, mask, hierarchical neural attention, flattened, one-dimensional, two-dimensional, three-dimensional, bottleneck, addition, normalization, SoftMax, and dropout layers.

In the present disclosure, a person may be identified as hearing or deaf, based on the role the person assumes in the communication process. A designation of hearing person (HP) may apply to a person who communicates by speaking, listening, or speaking and listening. A designation of deaf person (DP) may apply to a person who communicates using sign language. The DP may perform, read, or perform and read sign language. A designation of signer may apply to a person who performs sign language and may be least one of an HP, DP, agent, and interpreter. These designations may apply regardless of a person's ability or disability. For example, a person such as an interpreter or instructor who communicates by one or more of signing and reading sign language, may be designated as a DP, even if the person has partial or full hearing. As another example, a deaf person who communicates by one or more of speaking and listening may be designated as an HP.

In some embodiments, sign language may be performed by an avatar. An avatar may be a machine-generated video of one or more of a person, a sequence of video clips extracted from a video of a human signer, a cartoon character, a representation of a skeleton, and a sequence of images performing one or more of sign language, gestures, facial expressions, and speaking. An avatar may be created using an automated system and may be rendered by one or more of concatenating one or more sequences of video clips, graphics hardware, graphics software, and neural networks. The sequences of video clips may include video of a human signer.

The avatar may be based on a particular person so that the avatar resembles that particular person. The DP may use a tool such as a DP client or website to select an avatar. The avatar may be selected to resemble a calling party such as an HP on the call. For example, the avatar may be generated based on one or more of an image or video of an HP on the call. Additionally or alternatively, the tool may enable one or more of the HP and the DP to select the avatar from multiple options in a library of avatars. The avatars may resemble selected people, including one or more of a celebrity, cartoon character, animal, the HP, and a specific human interpreter such as a human interpreter on the call. The tool may enable the DP to select avatar characteristics such as gender, ethnic features, skin color, hair color, hair style, facial hair options, glasses, eye color, clothing, body type, and other features. The avatar may include one or more of a cartoon animation, a drawing, a sketch, a painting, a computer-generated graphic, a photograph, a video, a skeleton, and a realistic representation of a person.

In the present disclosure, the term sign language may apply to communication using visual gestures and signs. Methods may be illustrated using examples of sign languages such as American Sign Language (ASL), British Sign Language (BSL), and Lengua de Señas Mexicana (LSM) and examples of spoken and written languages such as English and Spanish, but it is to be understood that the methods described herein pertain as well to other signed, spoken, and written languages.

A sign may include one or more of a physical position and movement such as a signer pointing to his/her chest (a sign for “I” in ASL) or touching the middle finger of one hand to the back of the other hand (a sign for “touch” in ASL). In some embodiments, a sign may include multiple signs, such as the sign for “teacher,” which may include of the sign for “teach” followed by the “person” gesture. A sign may include one or more of a base sign and one or more attributes such as one or more of positions and movements of multiple parts of the body in sequence or simultaneously. An sign may include one or more of a base sign, hand position, hand orientation, hand shape, motion (including one or more of speed, trajectory and direction), orientation, initialization (the position of fingers representing one or more letters of the alphabet), facial expression, mouth position, mouth movement (for example, the signer may mouth the word being signed to facilitate lip reading), motion of the body, orientation of the head, orientation of the shoulders, and other facets of body position and movement that may be visible when watching a signer and which may convey information. A sign may include sound made by the signer such as one or more of puffing, clapping, snapping fingers, striking the body, blowing, and manipulation of objects such as paper, keys, hair, or clothing.

A symbol may be a form of a discrete unit of language such as one or more of a representation of a spoken word, a recording of a word, a typed word, a written word, a sign, a video of a sign, an illustration of a sign (e.g., a drawing such as may appear in a sign language dictionary), a written description of a sign, a gloss (described below), a state, and a subsign. For example, the audio of the spoken word “boat,” the written form “boat,” the gloss for “boat,” and a sign for “boat” may each be considered a symbol. A phrase may be a sequence of one or more symbols such as audio of a person saying, “I rode in the boat,” the text, “I rode in the boat,” the glossed form of a person signing “I rode in the boat,” and video of a person signing “I rode in the boat,” A sentence may include one or more phrases.

A sentence or phrase may be divided into one or more signs. A sign may be divided into one or more subsigns, where each subsign may be at least part of a sign. A subsign may include one or more states. In some embodiments, signs, subsigns, and states may be analogous to words, subwords (such as phonemes), and states, respectively, for a spoken language. In some embodiments, signs, subsigns, and states in an ASLR system may be analogous to words, subwords, and states, respectively, in an ASR system. States may be tied by grouping into clusters of states with similar characteristics. A sign may include one or more of one or more signs, subsigns, and states.

A subsign may include at least part of a sign. For example, the ASL sign “off” may include three subsigns where the right hand (1) approaches the back of the left hand, (2) touches the left hand, and (3) pulls up and away. A subsign may be divided into one or more states. A state may be represented by one or more features extracted from one or more images. In some embodiments, features may describe a motion, which may be comparable to a sequence of images. In some embodiments, features may describe one or more of positions, velocities (including speed and direction), and shapes (e.g., a hand may be in the shape of a letter) of one or more body parts. Additionally or alternatively, features may include velocity measurements, which may be represented as mathematical derivatives or delta parameters that describe the trajectories (e.g., one or more of velocity, rotation, and direction) of video components such as hands or fingers.

A sign may be encoded as a gloss. A gloss may be represented by one or more of text, binary, graphics, images, illustrations, non-text symbols, and other representations. The text representation of a gloss may include a written or typed label that indicates actions of a signer. A gloss may be considered to be a transliteration of one or more signs, since it may describe what the hands, face, and body do to create an ASL symbol in sign language. In some contexts herein, a “gloss” may refer to a document or body of text including one or more glosses. For example, the term “gloss” may be used as in “Write the gloss for each sentence.” The term “gloss” may also refer to a representation of written sign language as in “ASL gloss is a written or typed form of ASL,” Some glosses may represent multiple signs. Some signs may be represented by multiple glosses. In the description herein, the terms “gloss” and “sign” may be used interchangeably in some contexts, since a gloss may be a symbolic representation of a sign.

The present disclosure may refer to a “spoken form” as a representation of spoken language in one or more of an audio signal, an audio recording, text, a text form of the spoken language, and a written form of the spoken language. The spoken form may follow one or more of grammar, syntax, punctuation, capitalization, spelling, pronunciation, and language conventions typically followed by hearing parties when communicating in written or spoken language. Voicemail, email, books, audio from phone calls, audio from video calls, audio from lectures, audio from news broadcasts, text or short message service (SMS) messages, closed captioning, instant messages (IMs), and letters may be examples of spoken forms. In some embodiments, the term “spoken form” may be read as one or more of “one or more of audio and text,” “one or more of audio and script,” and “one or more of audio and text corresponding to spoken language conventions and grammar.”

The present disclosure may refer to a “script” as one or more of a typed form or written form of a spoken language. A sequence of one or more glosses may be distinct from the written form, or script, of one or more words in a spoken language. For example, a sentence performed in sign language may be glossed to create a text string that describes actions of the signer. Similarly, a spoken sentence may be transcribed to create a script that describes the words spoken. The script may be a literal transcription of spoken words.

The present disclosure may refer to a “gloss” as a typed or written form of a sign and to a “script” as a typed or written form of a spoken sequence of one or more words. A gloss and a script may each include one or more markings such as one or more of text, punctuation, graphics, icons, pictures, illustrations, videos, audio descriptions, and diagrams, among other markings. A gloss may correspond to language and grammar used by a signer and may follow sign language rules, grammar, syntax, and other conventions used in sign language. A script may correspond to rules, grammar, syntax, and other conventions used in spoken language. In British English, for example, a gloss may include text that shows how a concept may be performed in BSL and a script may include text of the words used to render a concept in spoken British English. As another example, if a hearing person says, “I went to the store” in American English, the corresponding script may read “I went to the store,” An ASL signer may render the same concept with signs corresponding to “finish,” “touch,” and “store.” The gloss may appear as “FINISH TOUCH STORE.” The meaning of an English sentence “Is he a teacher?” may be rendered in sign language using the signs “he” and “teacher” with eyebrows raised and the signs may be glossed as “HE TEACHER (eyebrows raised).”

A gloss may include a base sign. A gloss may further include one or more of markings, attributes, and annotations such as direction and initialization. Initialization may include letters formed using the shape of one or more hands and fingers. A gloss may be cast in a data structure such as an array, where each element of the array represents a part of the text. A gloss may be formatted using standards such as one or more of CSV, XML, JSON, name-value pairs, and key-value pairs, among other standards.

In some embodiments, a transcript may include one or more symbols. The symbols may be represented in a text format. Additionally or alternatively, a transcript may include a body of text. A transcript may include one or more of a script and a gloss. A transcript may include a text form of one or more of an audio and video sample. The audio sample may include speech. The video sample may include sign language. A video sample may include one or more images. At least part of the transcript may correspond to at least part of one or more of the audio and video sample. For example, an ASR or a data entry person may transcribe an audio recording into a transcript. As another example, a sign language interpreter may voice a presentation given in sign language, record the voice interpretation, and type the contents of the recording into a transcript.

A transcript may be generated by one or more of ASRs, ASLRs, and human transcribers. A transcript that is automatically generated may be designated as a hypothesis. For example, the output of one or more of an ASR and an ASLR may be designated as a hypothesis. A transcript presumed to be sufficiently accurate that it may be used as a standard to evaluate another transcript may be designated as a reference. A reference may be produced by one or more human labelers. A reference may be used to determine the accuracy of a hypothesis by comparing the reference to the hypothesis. Symbols in a hypothesis that are different, missing, or added, compared to the reference, may be designated as errors. An error rate may be determined by dividing the number of errors by the number of symbols in the reference. The number of errors may be determined by totaling the number of word insertions, deletions, and substitutions.

For convenience, we may refer herein to a call as one or more of an audio, text, and video communication session between two or more parties. Additionally or alternatively, a call may denote creation of one or more of an audio, text, and video by a first party that may or may not be received by a second party in near real-time or at a future time. For example, the first party may create a journal entry or other record. The record may be stored and not received by a second party or it may be replayed by a second party. The parties may be one or more of human (e.g., hearing, hard of hearing, deaf) and non-human (e.g., a recorded announcement or greeting, recording system, messaging system such as a voicemail system or answering machine, interactive voice response (IVR) system, artificial intelligence (AI) system). The term “call” may refer to a communication session such as one or more of a video communication, audio communication, phone call, landline telephone call, cell phone call, VoIP call, conference call between three or more parties, text communication session such as an IM session or chat session, event such as a presentation, broadcast such as a TV show, movie, news report, or other media transmission, conversation between two or more people in the same location (e.g., sufficiently close that hearing people would hear each other via sound transmission through the air), and conversation between multiple parties in different locations. The term “call” may refer to a relay call, where communication is facilitated, using one or more of one or more humans and machines, a language translator, sign language interpreter, call captioning system, and other assistive technologies.

A party on a call may be referred to herein as one or more of a call participant and a caller. A call participant may be denoted as a caller, regardless of which calling party initiates the call. A call participant may be a human. Additionally or alternatively, a call participant may be an automated system such as a voice messaging service, an IVR system, a sign language analog to an IVR system that provides one or more of voice and sign language communication, an automated call center agent, an information access portal, and a chatbot. The call may be initiated by one or more of one or more call participants and another party such as one or more of an administrative assistant, meeting scheduler, callback service, IVR system, reminder service, predictive dialer, auto dialer, progressive dialer, robocall or telemarketing call generator, and call generator such as an automated calling system in a call center.

The above definitions are provided as an aid to understanding and may apply to some embodiments, though usages in at least some parts of the present disclosure may vary from those described above.

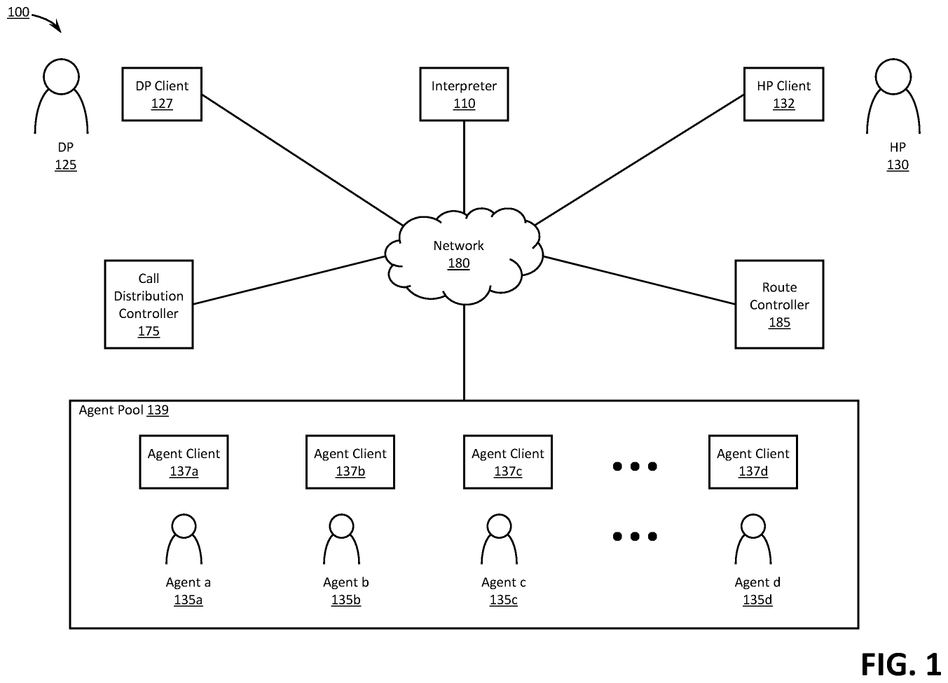

Turning to the figures, FIG. 1 illustrates an example environment 100 for sign language communication. The environment 100 may be arranged in accordance with at least one embodiment described in the present disclosure. The environment 100 may include an interpreter 110, a DP client 127, an HP client 132, an agent pool 139, a DP 125, an HP 130, a call distribution controller 175, a route controller 185, and a network 180. The agent pool 139 may include one or more agent clients 137a, 137b, 137c, and so on, collectively agent clients 137, and associated agents 135a, 135b, 135c, and so on, collectively agents 135. The agents 135 may be human interpreters. Each agent client 137 may be associated with a corresponding agent 135. The association between the agent 135 and the agent client 137 may include the agent 135 using the agent client 137. The DP client 127 may be associated with the DP 125. The association between the DP 125 and the DP client 127 may include the DP 125 using the DP client 127. The HP client 132 may be associated with the HP 130. The association between the HP 130 and the HP client 132 may include the HP 130 using the HP client 132.

The network 180 may be configured to communicatively couple the interpreter 110, the DP client 127, the HP client 132, the agent pool 139, the DP 125, the HP 130, the call distribution controller 175, the route controller 185, and the network 180. In some embodiments, the network 180 may be any network or configuration of networks configured to send and receive communications between systems and devices. In some embodiments, the network 180 may include one or more of a wired network, an optical network, and a wireless network, and may have numerous different configurations, including multiple different types of networks, network connections, and protocols to communicatively couple devices and systems in the environment 100. In some embodiments, the network 180 may also be coupled to or may include portions of a telecommunications network, including telephone lines, for sending data in a variety of different communication protocols, such as a plain old telephone system (POTS).

In some embodiments, the network 180 may include one or more of a wireless network, short-range wireless network, local area network (LAN), wireless local area network (WLAN), Digital Enhanced Cordless Telecommunications (DECT) network, IEEE 802.11 network (commonly referred to as WiFi®), Zigbee network, wireless mesh network (WMN), infrared network, and direct infrared connection. Additionally or alternatively, the network 180 may include one or more networks that use one or more of Bluetooth® Class 2 and Class 3 communications with protocols managed by the Bluetooth® Special Interest Group (SIG).

In some embodiments, the network 180 may include wireless cellular communication networks for sending and receiving information. The information may be formatted in one or more of hypertext transfer protocol (HTTP) and wireless application protocol (WAP). The network 180 may include a mobile data network that may include third-generation (3G), fourth-generation (4G), fifth-generation (5G), sixth generation (6G), seventh generation (7G), long-term evolution (LTE), long-term evolution advanced (LTE-A), Voice-over-LTE (“VOLTE”), and any other mobile data network or combination of mobile data networks. The network 180 may include one or more of one or more data switches, network switches, hubs, routers, wired Ethernet networks, optical networks, automatic call distribution (ACD) systems, and POTS lines. In these and other embodiments, the network may include any combination of analog, digital, and optical networks that form a network, including an Internet Protocol (IP) based network and a public switched telephone network (PSTN).

Additionally or alternatively, in this and other embodiments described herein, signals and other information may be sent between one or more components of FIG. 100 via direct connections or connections through components in addition to or instead of the network 180. For example, some components may be one or more of connected using cables or wires, part of a shared component, configured to pass signals internal to the shared component, and connected via one or more other networks. As another example, one or more of the interpreter 110, the DP client 127, the HP client 132, the agent pool 139, the DP 125, and the HP 130 may be communicatively coupled to one or more separate instances of the network 180. The interpreter 110 may include one or more of ASLRs and ASLSs.

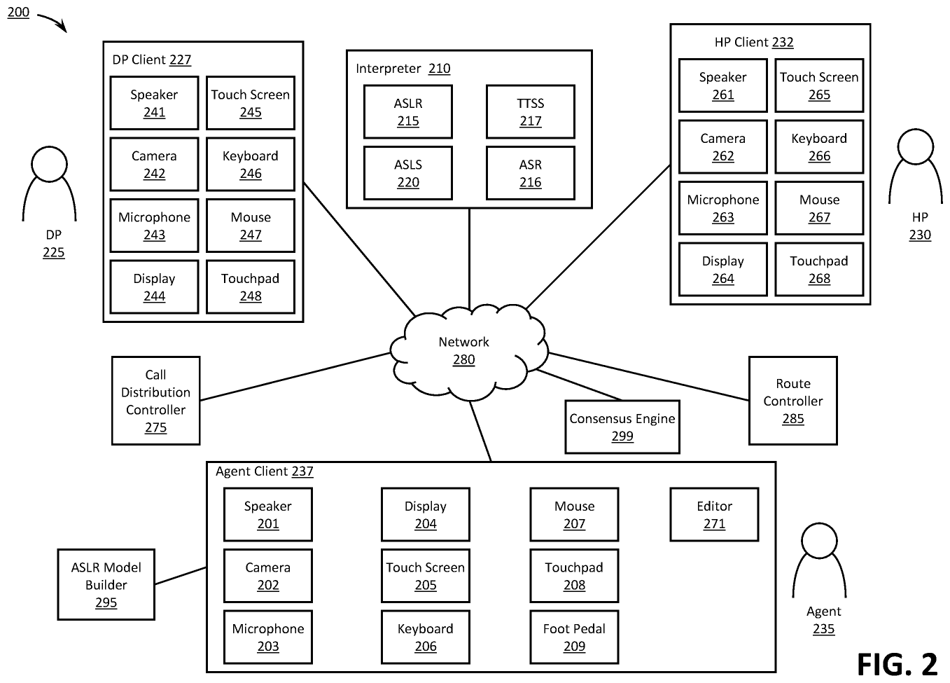

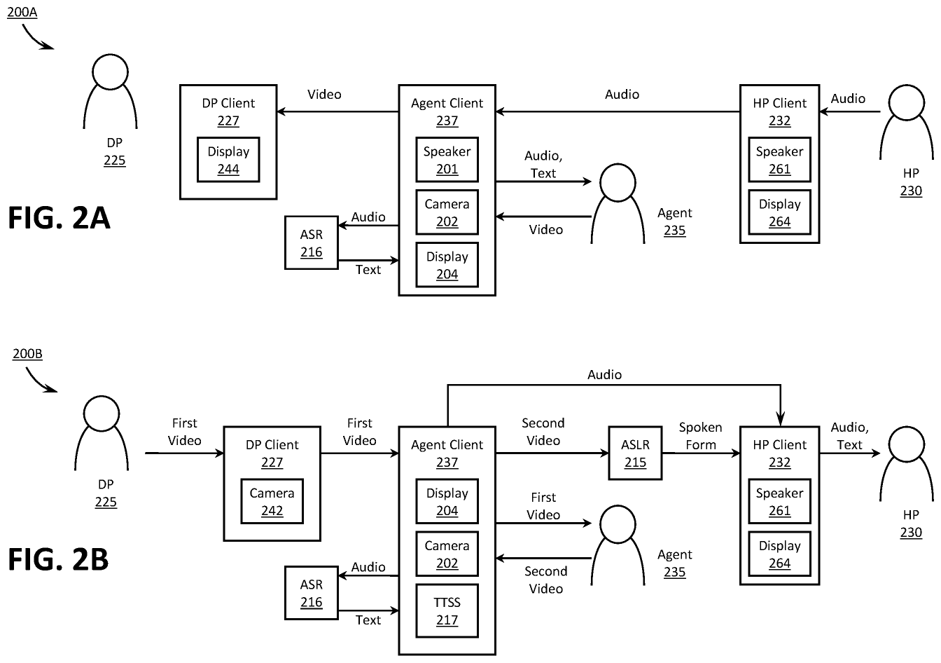

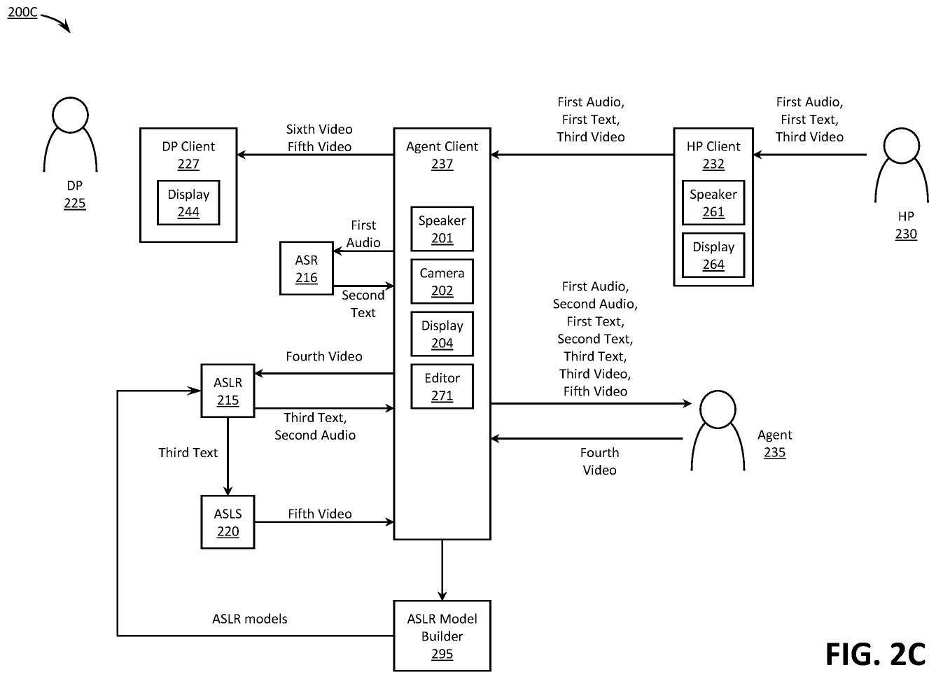

The description of the makeup and operation of network 180 may apply to other networks described herein such as network 280 of FIG. 2.

The DP client 127, HP client 132, and agent client 137 may be communication devices and may be communicatively coupled so that the DP 125, HP 130, and agent 135 can communicate with each other.

Each of the DP client 127, HP client 132, and agent client 137 may include or be any electronic or digital computing device and may each include one or more of a speaker, camera, microphone, display, touch screen, keyboard, mouse, touchpad, foot pedal, and one or more other input/output devices. Further descriptions of the DP Client 127 and HP Client 132 in some embodiments are described with respect to at least FIG. 2 of this disclosure. Additionally or alternatively, other communication devices may be used by the DP 125, HP 130, agent 135, and other parties within the scope of the present disclosure.

In some embodiments, one or more of the interpreter 110, DP client 127, HP client 132, agent pool 139, DP 125, HP 130, call distribution controller 175, and route controller 185 may include memory and at least one processor, which may be configured to perform operations as described in this disclosure, among other operations. The interpreter 110, DP client 127, HP client 132, agent client 137, call distribution controller 175, and route controller 185 may include computer hardware and software such as an operating system, signal routing software, sign language interpreting software, a processing unit such as a CPU, GPU, TPU, or array processor, memory such as RAM, a hard drive, a solid-state drive, one or more network interfaces such as LAN or WAN interfaces, among other computer hardware. In some embodiments, each of the interpreter 110, DP client 127, HP client 132, agent pool 139, DP 125, HP 130, call distribution controller 175, and route controller 185 may include a computing device such as a compute server, cloud server, virtual machine (VM), desktop computer, laptop, tablet, smartphone, smartwatch, smart glasses, VR goggles, entertainment system such as a TV, and wearable computer. In some embodiments, each of the interpreter 110, DP client 127, HP client 132, agent pool 139, DP 125, HP 130, call distribution controller 175, and route controller 185 may include computer-readable instructions that are configured to be executed by each of the interpreter 110, DP client 127, HP client 132, agent pool 139, DP 125, HP 130, call distribution controller 175, and route controller 185, respectively, to perform operations described in this disclosure.

The interpreter 110, DP client 127, HP client 132, and agent client 137 may convert between analog and digital signals, providing an interface between digital components and analog components. The digital components may include computers, memory, hard or solid-state drives, and networks, among other digital components. The analog components may include speakers, microphones, cameras, touchpads, mice, and displays, among other analog components. In some embodiments, the DP client 127, the HP client 132, and the agent client 137 may each be a communication device such as a desktop computer, a laptop computer, a smartphone, a mobile phone, a tablet computer, a smart watch, a smart device, a smart speaker, a smart television, a telephone, a phone console, a video phone, a captioning device, a captioning telephone, a TTY, a TDD, a device configured for Braille communication such as a device with a Braille display and keyboard input, a tablet computer, a VOIP phone, a smart speaker, a smart display, a phone console, a communication system integrated into or connected to a vehicle, a wearable device such as a watch or pair of glasses configured for communication, or any other computing device that may be used for communication between one or more of the DP 125, the HP 130, and the agent 135. The Braille device may include one or more of a QWERTY-keyboard and a Braille keyboard such as a SMART Brailler or a Perkins-style Braille keyboard. The Braille keyboard may include 6, 7, 8, 9, 10, or 11 keys. The Braille display may include a tactile display such as an array of pins that may be raised or lowered and that may be arranged in cells.

The speaker may be a speaker on a phone, smartphone, computer, or other communications device, a speaker in a Bluetooth® headset, a Bluetooth® or other wireless speaker, a headset with a microphone, a speaker in an induction hearing loop, an earpiece, an earbud, a speaker in an AirPod, a speaker in an EarPod, a speaker in a hearing aid, a speaker in a speakerphone, an earpiece (a.k.a., “receiver”) in a telephone handset, a piezoelectric, electrostatic, or dynamic speaker, or another transducer configured to convert electrical energy to acoustic energy.

The microphone may be a microphone on a phone, smartphone, computer, or other communications device, a microphone in a Bluetooth® headset, a Bluetooth® or other wireless microphone, a microphone in a headset, a microphone built into an induction hearing loop, an earpiece, an earbud, a microphone in an AirPod, a microphone in an EarPod, a microphone in a hearing aid, a microphone or speaker (acting as a microphone) in a speakerphone, a throat microphone, a microphone (or “transmitter”) in a telephone handset, a lavalier microphone, a piezoelectric, electrostatic, or dynamic microphone, or another transducer configured to convert acoustic energy to electrical energy.

In some embodiments, calls and call participants may have characteristics such as one or more of the language preferred by or used by one or more call participants (e.g., English, Spanish, ASL, BSL, LSM), conversation topic (e.g., calls with a medical provider, social calls, business calls, toll-free calls, government calls, prison calls), degree or type of disability attributed to the DP 125, HP 130, or agent 135, account status, call priority (e.g., 911 calls, calls where at least one call participant has a premier subscription to an interpreting or other service, calls assigned a priority by virtue of a characteristic of the call such as conversation topic), and the type of device (e.g., cell phone, PC, videophone, telephone, DP client 127, HP client 132) used by at least one call participant. These characteristics may be referred to herein as call variables. The preferred language of a call participant may be determined by an entry in the call participant's profile or another paper or electronic document, such as an information page or database record of preferences, associated with the call participant's account, such as a sign language interpreting subscription.

The route controller 185 may determine one or more treatments for a call, where a treatment may include a decision of whether to use the interpreter 110 or a human agent 135 or both to interpret the call. Call treatment options may include one or more of prompting one or more call participants for more information, placing a call on hold, placing a call in a queue while waiting for a resource such as one or more of the interpreter 110 and agent 135 to become available, routing a call to an agent 135, and routing a call to an automated interpreting system such as the interpreter 110. In some embodiments, call variables may include one or more of call characteristics, account status, and call type. In some embodiments, the treatment for a call may be responsive to one or more call variables. In some embodiments, an automated interpreter may handle overflow traffic when a human interpreter is not available. For example, calls may be handled by human interpreters when a sufficient number of human interpreters are available and by automated interpreters when a sufficient number of human interpreters are not available.

In determining one or more treatments for a call, the route controller 185 may respond to one or more call variables such as one or more of the number of available agents 135, the number of busy agents 135, the number of logged-in agents 135, the number of interpreter 110 resources available, the number of busy interpreter 110 resources, the types of available agents (e.g., agents 135 allocated to handle certain types of calls), the skill levels of available agents 135, the language (e.g., English, Spanish, ASL) proficiency of agents 135, the regional dialect of the DP 125, the regional accent of the agent 135, the percentage or fraction of agents 135 that are busy or available, characteristics of a call, characteristics of one or more call participants, a determination or estimate of the difficulty of interpreting a call using one or more of a human and a machine, estimated video quality, video brightness, video contrast, video sharpness, audio quality, audio loudness, audio signal-to-noise ratio, audio background noise characteristics (e.g., car noise, voices, machinery), audio background noise level, the language preferred by or used by one or more of the call participants, an indication of preference for automated vs. human interpreting by one or more of the call participants, and the geographical location or time zone of one or more of one or more call participants and agents 135. Skill levels of agents 135 may be determined using testing, amount of experience, or qualifications such as knowledge of certain languages. The number of logged-in agents 135 may be determined from the number of agents 135 who have successfully provided an agent ID and password and thus currently have access to an agent client 137. The number of logged-in agents 135 may be substantially equal to the number of available agents 135 plus the number of busy agents 135. Additionally or alternatively, the number of logged-in agents 135 may be substantially the number of agents 135 in the agent pool 139.

Call variables may include one or more of the cost of automatically interpreting a call, the cost of using a human interpreter to interpret a call, the current number of simultaneous calls (e.g., traffic load across at least part of the environment 100), the projected or forecasted number of simultaneous calls, the geographical location of one or more call participants, the geographical location or time zone of available agents 135, the estimated or projected length of the call, the average length of multiple calls, the phone number area code of one or more call participants, an indication of whether the call is being recorded, an indication of the preferred language of one or more of the call participants based on an analysis of at least one call participant's name, an indication of which call participant initiated the call, and the account status of one or more call participants.

The account status may include one or more of what type of account a participant is subscribed to (e.g., no subscription, trial, free, paid, monthly, annual, lifetime, contract, no contract, auto-renewing, premium), the number of calls placed by or received by the call participant, the amount of time (e.g., number of minutes) the call participant spends using the interpreting service over a selected period (e.g., the most recent month), whether the call is an emergency or 911 call, the call type, the cost of the call participant's subscription to the interpreting service, a measure of at least one call participant's need for assistive services, whether the cost of the subscription service is paid by the call participant or another party, contractual requirements to provide a service with one or more of humans, automated systems, a maximum call answer time, a maximum error rate, a minimum quality level, an indication of subscription payment status (e.g., current, payment due, payment overdue), and length of time the call participant's subscription has been active. A participant's need for assistive services may include the extent of deafness or other factors that make the call participant more or less dependent on interpreting services than other prospective users. In some embodiments, call participants with higher account status, such as call participants whose accounts are paid at premium rates or call participants that have a greater need for service, may receive at least one of a higher quality and a higher cost service, than call participants with lower account status. In some embodiments, an automated interpreter may interpret a call for a participant with a free account whereas a human interpreter may interpret a call for a participant with a paid account. Additionally or alternatively, an automated interpreter may interpret a call for a participant with an account in a delinquent payment status whereas a human interpreter may interpret a call for a participant with a paid account in good standing.

The call type may include an indication that the call is one or more of a residential call, a business call, a government call, a messaging system such as a voicemail system or answering machine, IVR system, a chatbot, an announcement system that plays recorded messages, an AI system, a call to a busy number, and a call to a non-working number. Additional examples of call types are described below with reference to FIG. 2.

Call variables may include business objectives such as cost or profitability targets on the part of the entity providing the interpreting service. Call variables may include one or more of the availability of the network 180, including one or more of outages, traffic loading, status of operational alarms indicating potential difficulties in providing the interpreting service using particular resources, and other factors that may impact performance. For example, if a network outage renders one or more agents 135 unreachable or unavailable, the route controller 185 may send more traffic to the interpreter 110.

Call variables may include one or more of the type of phone (e.g., videophone, landline phone, cell phone, smartphone, VOIP phone, softphone, smart speaker, display), date/time of call (e.g., calendar date, time of day, day of week, holiday), interpreting quality for a human interpreter such as an agent 135, and one or more of interpreting quality for an automated interpreter such as the interpreter 110. Quality may include one or more of accuracy, error rate, speed, performance, and latency (how far the interpretation lags behind). Interpreting quality for a human interpreter may include accuracy, error rate, speed, and performance in one or more areas of expertise. One or more of interpreting accuracy, error rate, and quality may be determined by measuring a confidence score from one or more of an ASLR and ASLS system. A confidence score for an ASLR may be determined by measuring a likelihood function determined by the ASLR. A confidence score for one or more of an ASLR and ASLS system may be determined using methods adapted from those used by ASR systems to determine confidence scores.

In some embodiments, the route controller 185 may use call variables, such as call variables related to quality, to initiate transfers between agents 135 or between agents 135 and the interpreter 110. For example, if the quality of the interpreter 110 falls below a selected threshold, the route controller 185 may disconnect the interpreter 110 from the call and connect an agent 135 to the call. Additionally or alternatively, if the interpreting quality of a first agent 135 falls below a selected threshold, the route controller 185 may disconnect the first agent 135 from the call and connect the interpreter 110 or a second agent 135 to the call. Additionally or alternatively, if the interpreting quality of a deaf agent 135 falls below a selected threshold, the route controller 185 may disconnect the deaf agent 135 from the call and connect the interpreter 110 or a hearing agent 135 to the call.

In some embodiments, a call may be interpreted by both the interpreter 110 and an agent 135. The output of the interpreter 110 or the agent 135 may be sent to one or more of the DP client 127 and the HP client 132. The route controller 185 may compare the quality of the interpreter 110 and the agent 135. Based on the comparison of the quality of the interpreter 110 and the agent 135, the route controller 185 may initiate a transfer or disconnect one of the interpreter 110 and the agent 135. For example, if the quality of the interpreter 110 exceeds a selected delta below the quality of the agent 135, the route controller 185 may disconnect the agent 135 and the interpreter 110 may continue to interpret for the call. For example, if the selected delta is 2% and the interpreter 110 score is within 1% of the agent 135 score, the route controller 185 may disconnect the agent 135 and let the interpreter 110 interpret for the call.

Call variables may include one or more of the number of communication devices connected to the call, the number of people visible in a video sample, a measure of speaking rate for each of one or more participants, an estimate of how accurately ASR can transcribe an audio signal, and network 180 statistics such as traffic load and packet loss.

Call variables may include one or more of demographics of one or more call participants such as one or more of age, gender, geographical region, time zone, dialect, accent, spoken language (e.g., English, French), language of sign language (e.g., ASL, BSL), and an indication of preference by one or more participants as to whether they prefer a human interpreter or an automated interpreter. Call variables may include one or more of words used on the call, call types, one or more topics discussed on the call, audio attributes such as sampling rate and encoding method, audio quality level such as background noise level and voice quality, video attributes such as resolution and dynamic range, and video quality levels such as a compression ratio.

Call variables may include a constant value, which may be used to apply a bias factor into the treatment determination. The bias factor may be used to balance resources, such as human vs. automatic interpreting resources, and to prompt the route controller 185 to favor treatment options, such as cost reductions, that support business priorities.

Call variables may include a request by a call participant for a service other than or in addition to interpreting. For example, a DP 125 may request action from a virtual assistant or smart speaker such as one or more of weather information, setting an alarm, timer, or reminder, checking email, checking SignMail or video mail (comparable to voicemail in a telephone service), placing a call, asking questions, shopping, requesting information, and booking restaurants, entertainment, or travel. As another example, the DP 125 may make a request that can be handled by an IVR. In this and other embodiments described herein, it is to be understood that an IVR may include a voice-based automated dialog system or a sign language analog to an IVR where sign language video is used instead of or in addition to voice. In some embodiments, if requests by the DP 125 can be effectively handled by an automated system, the route controller 185 may connect the call to an automated interpreter such as the interpreter 110 or to an automated dialog system or sign language analog to an IVR.

Call variables may include an indication of whether the DP 125 is signing with both hands or with one hand, such as when holding a DP client 127 in one hand and signing with the other. The indication may be determined through analyzing the video of the DP 125. The indication may be inferred from the type of device used for DP client 127. For example, if the DP client 127 is a smartphone, the DP 125 may be assumed to be signing with one hand. If the DP client 127 is a PC or a type of videophone typically placed on a table or desk, such as a tablet or desktop videophone, the DP 125 may be assumed to be signing with both hands.

Call variables may include one or more of call information, call variables, and call treatment saved from a previous call. The previous call may be one using the same communication device or with the same call participant. Call information, variables, and treatment saved from a previous call may be retrieved and used as call variables for subsequent calls and may serve as a starting point for one or more of estimating current call variables and in determining a treatment for subsequent calls. Additional call variables are described below with reference to FIG. 2.

In some embodiments, the route controller 185 may combine one or more call variables to determine call treatment. Combining call variables may include one or more of linear methods, nonlinear methods, linear classification, non-linear classification, regression, estimation, and rules. For example, the route controller 185 may use linear discriminant analysis to assign a weight to each of one or more call variables, multiply each variable by an associated weight, and total the products to determine a discriminant function. The route controller 185 may compare the discriminant function to a threshold and select a treatment based on whether the product total is greater than or less than the threshold. As another example, the route controller 185 may input one or more call variables into a neural network, support vector machine (SVM), random forest, or other process trained using machine learning (ML) and the output of the neural network, SVM, random forest, or ML-based process, respectively, may determine the call treatment, such as by comparing the output to a threshold.

Additionally or alternatively, the route controller 185 may use one or more rules to determine call treatment. For example, if one or more call participants indicate preference for an automatic interpreter, the route controller 185 may invoke a rule honoring the request and connect the call to the interpreter 110. As another example, if the number of available agents 135 is below a selected threshold, the route controller 185 may connect the call to the interpreter 110.

In some embodiments, at least a selected number, denoted as a reserve limit, of agents 135 may be kept in an available state, when practical, to handle one or more of traffic peaks, high-priority calls, high account status calls, contingencies such as outages, call transfers from other agents 135 or from the interpreter 110, and other conditions where a human agent may be needed. In some embodiments, the reserve limit may be zero (i.e., holding no agents in reserve). In some embodiments, the reserve limit may be greater than zero. The reserve limit may be one or more of a selected fraction of the number of agents 135 logged into agent clients 137, a number specified by a contractual agreement, and a number determined in response to the estimated likelihood and severity of an event such as a traffic peak or unusually large number of high-priority or high account status calls.

The route controller 185 may respond to the number of available agents 135, compared to the reserve limit, in determining call treatment. For example, if the number of available agents 135 is less than the reserve limit, the route controller 185 may send a relatively greater number of calls to the interpreter 110 such as by applying a bias to the call treatment decision in favor of sending a call to the interpreter 110. If the number of available agents 135 is greater than the reserve limit, the route controller 185 may send a relatively greater number of calls to agents 135 such as by applying a bias to the call treatment decision in favor of sending a call to an agent 135.

In some embodiments, the route controller 185 may use one or more methods to determine call treatment. For example, when one or more of a DP 125 and an HP 130 initiate a call, the route controller 185 may compare the number of available agents 135 (e.g., agents 135 logged in but not currently on a call) to a selected threshold. In some embodiments, the threshold may be a reserve limit. In some embodiments, the threshold may be zero. If the number of available agents 135 is greater than the threshold, the route controller 185 may connect the call to an agent 135. If the number of available agents 135 is not greater than the threshold, the route controller 185 may connect the call to the interpreter 110. In some embodiments, connecting a call to an agent 135 or an interpreter 110 may include directing the network 180 to connect the call to an agent 135 or an interpreter 110, respectively.

In some embodiments, if the number of available agents 135 is not above the threshold, the route controller 185 may connect any new calls to the interpreter 110 until the number of available agents 135 is above the threshold. For example, the route controller 110 may compare the number of available agents 135 to the threshold on a selected schedule. The selected schedule may include making the comparison one or more of periodically, at random intervals, when a new call is received or initiated, when a call ends, and continuously. If a comparison determines that the number of agents 135 is above the threshold, the route controller 185 may select a call connected to the interpreter 110 and transfer the selected call to an available agent 135. The call may be selected based at least partly on one or more of the call duration at the time of selection, the call priority, the account status of one or more callers, the language, the account type, one or more call variables, and one or more call types. For example, one or more of the shortest call (i.e., the call most recently started), the longest call (i.e., the oldest call), an emergency (e.g., 911) call, a call determined to be presenting difficulty for the interpreter 110, a call where the interpreter 110 is delivering relatively low accuracy, and the call with highest priority may be selected.

In some embodiments, if the number of available agents 135 is above the threshold, the router controller 185 may transfer a call from the interpreter 110 to an available agent 135. Additionally or alternatively, one or more call variables may influence one or more of the decision to connect the call to the interpreter 110 and the decision to transfer the call to the agent 135. As an example, the route controller 185 may determine one or more call variables and use the one or more call variables to select automated interpreting (e.g., using the interpreter 110), human interpreting (e.g., using an agent 135), or a combination of both human and automated interpreting. In some embodiments, the one or more call variables may include one or more of the number of available agents 135, a selected threshold, and the reserve limit.

In some embodiments, the route controller 185 may transfer a call from an agent 135 to another agent 135 or to the interpreter 110. For example, if an agent 135 on a call is unable to continue to interpret the call, the agent 135 may use the agent client 137 to signal the route controller 185 that the agent 135 needs to disconnect from the call. The agent 135 may need to disconnect from the call because of one or more of the call may be too difficult for the agent 135, the agent 135 is not sufficiently experienced interpreting the topic of the call, the agent 135 is having technical difficulties, and personal reasons such as needing a break. The agent 135 may use the agent client 137 to provide a reason why the agent 135 needs to disconnect. The agent client 137 may enter the reason in a log. The route controller 185 may respond to the signal from the agent 135 by connecting the call to one or more of another agent 135 and the interpreter 110. The agent 135 may later signal the route controller 185 that the agent 135 is available. The route controller 185 may respond to the signal from the agent 135 by connecting the previous call or a new call to the agent 135.

In some embodiments, an agent 135 may be interpreting for a call and interpreting from the agent 135 may stop due to one or more causes such as one or more of the agent 135 stopping, the agent client 137 malfunctioning, the agent client 137 going offline, a power failure, and a network interruption, among other causes. If interpreting from the agent 135 stops, the route controller 185 may connect the call to the interpreter 110. The interpreter 110 may then interpret for the call. For example, the interpreter may recognize audio from the HP 130, use ASR to convert the audio to text, and present the text on the display of the client 127. Additionally or alternatively, the interpreter 110 may use ASR, ASLS, ASLR, and TTS to convert between sign language and speech. If the agent 135 resumes or gives an indication that the agent 135 is able to resume, the call may be connected to the agent 135 and may be disconnected from the interpreter 110. Additionally or alternatively, if interpreting from the agent 135 stops, the route controller 185 may connect the call to a different agent 135.

In some embodiments, the route controller 185 may, at the start of a call, connect the call to an agent client 137. The agent 135 associated with the agent client 137 may start interpreting the call. If the route controller 185 determines during the call that the interpreter 110 is able to meet selected quality standards for the call, the route controller 185 may disconnect the call from the agent client 137 and connect the call to the interpreter 110. The determination that the interpreter 110 is able to meet selected quality standards may be based on one or more call variables. Additionally or alternatively, the route controller 185 may, at the start of a call, connect the call to the interpreter 110 and an agent client 137. The agent 135 associated with the agent client 137 may start interpreting the call. The interpreter 110 may provide one or more confidence metrics to the route controller 185. If the route controller 185 determines that the one or more confidence metrics indicate that the interpreter 110 is able to meet selected quality standards, the route controller 185 may disconnect the agent client 137 from the call and connect the interpreter 110 to the call and the interpreter 110 may take over interpreting for the call.

In some embodiments, a portion of the call may be determined to be sensitive. In response to this determination, the route controller 185 may connect the call to the interpreter 110. For example, the HP 130 may be a call center agent. The HP 130 may request sensitive information, from a DP 125. At least part of the call may be interpreted by a first agent 135. Sensitive information may include information that is one or more of private, sensitive, personally identifiable, and designated as sensitive, personal, or private according to privacy laws or regulations such as HIPAA or GDPR. Once the sensitive portion of the call is complete, the route controller 185 may connect the call to the first agent 135 and may disconnect the interpreter 110. Additionally or alternatively, once the sensitive portion of the call is complete, the route controller 185 may connect the call to a second agent 135. One or more of the route controller 185, the agent client 137, the interpreter 110, and one or more other systems may detect sensitive information by determining that one or more of the callers has been asked for, is providing, or is about to provide sensitive information. The determination may be based on one or more of actions by the HP 130 such as pushing a button or clicking an icon, an indication by the agent 135 that the information is sensitive, entering a state in a call flow or script, such as in a call center system dialog, that includes collecting sensitive information, using one or more of an ASR and an ASLR to recognize one or more key words, signs, or phrases such as one or more of “My credit card number is,” “I'm ready for the card number,” “Can I have your date of birth?,” “My account number is,” “Birthdate, please,” “Can I have the last four digits of your social?,” a string of four digits, a string of digits longer than a specified number of digits, and other phrases or actions that may be associated with sensitive information. Additionally or alternatively, text from an ASR may be sent to a natural language processor (NLP). The NLP may analyze the text and determine whether the text contains sensitive information.

When at least some embodiments describe indicating or determining that a party is providing or is about to provide sensitive information, the language may be interpreted to mean that the method may include indicating or determining one or more of that a party is currently providing sensitive information, that a party is about to provide sensitive information, and that a party is either currently providing or is about to provide sensitive information.”

In some embodiments, if sensitive information is detected, the route controller 185 may connect the call to the interpreter 110. The interpreter 110 may use automated methods such as one or more of ASLR and ASLS to interpret the call. Since the sensitive portion of the call may be interpreted by the interpreter 110 and may not be interpreted by the agent 135, the agent 135 may not see or hear the sensitive information. Thus, the privacy of the DP 125 may be protected.

In some embodiments, the route controller 185 may detect sensitive information and connect the call to the interpreter 110, then connect the call to an agent 135 when one or more of a specified amount of time such as 15 seconds goes by, a specified number of speaker turns have been counted, the sensitive portion of the call is determined to be complete, the DP 125 provides a specified number of digits, the DP 125 signs something other than digits, the DP 125 signs something other than letters, the DP 125 signs something other than digits and letters, the HP 130 takes action such as pushing a button or clicking an icon that indicates the sensitive information has been collected, and the sensitive information provided by the DP 125 is determined to be complete. For example, the sensitive information provided by the DP 125 may be determined to be complete in response to the DP 125 providing what the HP 130 asked the DP 125 to provide.

In some embodiments, an ASR may transcribe one or more of audio from the HP 130 and audio from the agent 135 into text and send the text to the route controller 185. An NLP may classify the text as one or more of not sensitive, sensitive, or indicating that sensitive information is being provided or is about to be provided. The route controller 185 may use one or more of the text and the NLP classification to determine that sensitive information is being or is about to be provided. Additionally or alternatively, the route controller 185 may use one or more of the text and the NLP classification to determine that the portion of the call containing sensitive information is complete.

For example, the HP 130 may request an account number, which may include a specified number of digits, from a DP 125. The call may be interpreted by an agent 135. The route controller 185 may determine that the information is sensitive based on one or more of the NLP classifying text from the ASR, the classification indicating that sensitive information is being provided (or, alternatively, that sensitive information is about to be provided), the HP 130 pushing a button or clicking an icon to indicate that sensitive information has been requested, the interpreter 110 detecting that the HP 130 has asked for sensitive information such as an account number, the route controller 185 detecting that the DP 125 has begun signing a string of digits, and the route controller 185 detecting that signs from DP 125 indicate that the DP 125 is about to provide sensitive information. When the route controller 185 determines that the DP 125 is providing or is about to provide sensitive information, the route controller 185 may connect the call to the interpreter 110. The interpreter 110 may provide a spoken form to the HP client 132 for presentation to the HP 130. The interpreter 110 may convert video from the DP 125 to text. The route controller 185 may count the number of digits in the text. Once a specified number of digits are counted, the route controller 185 may connect the call to an agent 135. The specified number of digits may include one or more of 1, 4, 9, 10, and 11 among other specified numbers of digits.

The above description may include one or more methods for protecting privacy when the DP 125 provides sensitive information. Analogous methods may be used when the HP 130 provides sensitive information. For example, a first agent 135 may interpret a call. An ASR may transcribe audio from the HP to text. An NLP may classify the text as containing sensitive information or as indicating that the HP 130 is providing or is about to provide sensitive information. The route controller 185 may connect the call to the interpreter 110. After the route controller 185 determines that the sensitive information has been provided, the route controller 185 may connect the call to the first agent 135 or to another agent 135. In some embodiments, connecting a call to an agent 135 may include disconnecting the call from the interpreter 110. Additionally or alternatively, connecting a call to an interpreter 110 may include disconnecting the call from the agent 135.

In some embodiments, when a call is transferred from the agent 135 to the interpreter 110 or from the interpreter 110 to the agent 135, the route controller 185 may be configured to synchronize the interpreter 110 and the agent 135. Synchronizing the interpreter 110 and the agent 135 when transferring a call may reduce the risk that a portion of the call may be missed or repeated. For example, the interpreter 110 may be denoted as the first interpreter and the agent 135 may be denoted as the second interpreter. Additionally or alternatively, the interpreter 110 may be denoted as the second interpreter and the agent 135 may be denoted as the first interpreter. The output of the first interpreter may be a spoken form sent to the HP 130. Additionally or alternatively, the output of the first interpreter may be sign language video sent to the DP 125. In some embodiments, when a call is transferred from the first interpreter to the second interpreter, the call may initially be connected to the first interpreter and the second interpreter. The output from the first interpreter may be sent to one or more of the HP 130 and the DP 125. The output of the first interpreter and the second interpreter may be aligned in time so that both outputs are substantially synchronized. After both outputs are substantially synchronized, the first interpreter may be disconnected and the output of the second interpreter may be sent to one or more of the HP 130 and the DP 125.

Additionally or alternatively, when a call is to be transferred from the first interpreter to the second interpreter, the first interpreter may continue to interpret the call until there is a pause by the speaker or signer (whichever applies to the current situation). Additionally or alternatively, the first interpreter may continue to interpret the call until the end of a sentence is detected. Additionally or alternatively, the first interpreter may continue to interpret the call until there is a turn change. A turn change may include a point in time where the HP 130 stops speaking, and the DP 125 begins signing. Additionally or alternatively, a turn change may include a point in time where the DP 125 stops signing, and the HP 130 begins speaking. A turn change may be detected in response to one or more of (a) the HP 130 begins speaking, (b) the HP 130 stops speaking, (c) the DP 125 starts signing, (d) the DP 125 stops signing, (e) the agent 135 stops voicing and starts signing, (d) the agent 135 stops signing and starts voicing, (e) the HP 130 stops speaking and the DP 125 starts signing at substantially the same time, (f) the DP 125 stops signing and the HP 130 starts speaking at substantially the same time, and (g) a combination of one or more of (a)-(f). When one or more of a pause by the speaker or signer is detected, the end of a sentence is detected, and a turn change is detected, the first interpreter may be disconnected from the call and the second interpreter may be connected to the call. The route controller 185 may detect one or more of a pause, end of sentence, and turn change by analyzing one or more of audio from the HP 130, audio from the agent 135, audio from the transcriber 110, video from the transcriber 110, video from the agent 135, video from the DP 125, text from one or more of the DP 125, the HP 130, and the agent 135, an ASR transcribing audio from the HP 130, and an ASR transcribing audio from the agent 135.

Additionally or alternatively, when a call is to be transferred, a portion of one or more of an audio, text, and video signal from one or more of the DP 125, the HP 130, and the agent 135 may be recorded in a buffer. After the call is connected to the second interpreter, one or more of the audio, text and video signal may be presented to the second interpreter so that the second interpreter can read the text, listen to the audio, watch the video, or combinations thereof. This recorded information may enable the second interpreter to discern at what point the first interpreter stopped interpreting so that the second interpreter may start interpreting at substantially the same point.

In another example, the HP client 132 may include or may be associated with an IVR system. The DP 125 may communicate with an IVR system in at least one embodiment of the environment 100. An agent 135 may be interpreting. The IVR system may send a message to the route controller 185 indicating that the IVR system is about to collect sensitive information. As a result of the indication, the route controller 185 may connect the call to the interpreter 110. The interpreter 110 may interpret the sensitive information from the DP 125 and send it to the IVR system. The IVR system may send a message to the route controller 185 indicating that the sensitive information has been provided. In response to the indication, the route controller 185 may connect the call to an agent 135.

Additionally or alternatively, information from the HP 130 may be monitored for sensitive information. Methods for monitoring information from the HP 130 for sensitive information may be analogous to those described above for detecting sensitive information from the DP 125. If it is determined that the HP 130 is providing or is about to provide sensitive information, the route controller 185 may connect the call to the interpreter 110. After the sensitive information has been provided and interpreted, the route controller 185 may connect the call to an agent 135.

When the route controller 185 determines that a call is to be sent to an agent 135, the call distribution controller 175 may select an agent 135 from among multiple agents 135a, 135b, 135c, and so on, and connect the selected agent 135 to the call. The call distribution controller 175 may keep a record of one or more of which agents 135 are available to receive calls and which agents 135 are busy, such as being currently engaged in one or more calls. The record may include the language spoken by agents 135, geographical location of agents 135, and other agent 135 characteristics. The call distribution controller 175 may use the record in selecting an agent 135. For example, the call distribution controller 175 may identify an available agent 135 and direct the network 180 to connect the call to the available agent 135. In another example, the call distribution controller 175 may select an agent 135 that is geographically closer to one or more of the call participants than another agent 135. In another example, the call distribution controller 175 may determine that no available agents speak the preferred language of one or more of the DP 125 and the HP 130 and may accordingly connect the call to the interpreter 110 or temporarily place the call on hold.

In another example, the route controller 185 may determine that a call is high-priority because one or more of the DP 125 has an exceptional need such as a severe sensory impairment or dangerous medical condition, the DP 125 has a premium subscription, and the call is a 911 or other emergency call. In response to the determination that the call is high-priority, the call distribution controller 175 may select an available agent 135 and the route controller 185 may connect the call to the available agent 135. In another example, the route controller 185 may determine that a call is not high-priority and may route the call to an agent 135 if the number of available agents is greater than the reserve limit and to the interpreter 110 if the number of available agents is below the reserve limit. In another example, in response to the route controller 185 determining that a call is not high-priority, the route controller 185 may route the call to the interpreter 110 or temporarily place the call on hold.

In some embodiments, the call distribution controller 175 may select an agent 135 in response to one or more call variables. For example, if a call is one or more of high-status and high-priority, the call distribution controller 175 may select an agent 135 with relatively more experience than another available agent 135. In some embodiments, the call distribution controller 175 may combine one or more call variables to determine select an agent 135 using methods such as those described herein in relation to the route controller 185.

In some embodiments, at least some of the functions of the route controller 185 and the call distribution controller 175 may be combined into a single component or distributed among multiple devices and/or systems such as remote servers. In some embodiments, a system that includes at least some operations described herein with reference to one or more of the route controller 185 and the call distribution controller 175 may determine whether a call is handled by an agent 135 or the interpreter 110 and, if the call treatment calls for a human interpreter, may select an available agent 135 to handle the call.

In some embodiments, the DP client 127 may be configured to obtain video from the DP 125. The DP client 127 may be configured to provide video to the DP 125. The HP client 132 may be configured to obtain audio from the HP 130. The HP client 132 may be configured to provide audio to the HP 130. The audio and video thus obtained or provided may be part of a communication session, such as one or more of a telephone call, video call, or text message exchange. As used in this disclosure, the term audio may be used generically to refer to sounds that may include spoken words. Furthermore, the term “audio” may be used generically to include audio in any format, such as a digital format, an analog format, or a propagating wave format. Furthermore, in the digital format, the audio may be compressed using different types of compression schemes. Also, as used in this disclosure, the term video may be used generically to refer to a compilation of images, aka frames, that may be reproduced in a sequence to produce video. The video may include one or more of hands, arms, torso, head, mouth, facial expressions, body, and clothing for one or more signers. The video may include background. Video frames may be captured at a frame rate such as 7, 15, 24, 25, 29.97, 30, 50, 60, 100, 120, or 240 frames per second. In some embodiments, the video may be interlaced, non-interlaced, progressive scan, or de-interlaced.

In some embodiments, the DP client 127 may obtain video from the DP 125 and send the video to the interpreter 110. The video sent from the DP client 127 to the interpreter 110 may pass through the network 180. The video may contain sign language. The interpreter 110 may generate audio in response to the video. Additionally or alternatively, the interpreter 110 may generate text in response to the video. The audio may include speech. The audio may include non-speech sounds. The speech may include an interpretation of sign language from the video. The interpreter 110 may send the audio to the HP client 132. The audio from the interpreter 110 may pass through the network 180 to the HP client 132. The HP client 132 may use a speaker to play the audio for the HP 130. The audio may include a spoken language interpretation of the signs performed by the DP 125.

Additionally or alternatively, the HP client 132 may obtain audio from the HP 130 and send the audio to the interpreter 110. The audio sent from the HP client 132 to the interpreter 110 may pass through the network 180. The audio may include speech. The audio may include non-speech sounds. The interpreter 110 may generate video in response to the audio. The video may contain sign language. The interpreter 110 may send the video to the DP client 127. The video from the interpreter 110 to the DP client 127 may pass through the network 180. The DP client 127 may present the video on a display. The video may include a sign language interpretation of the audio produced by the HP 130. The interpreter 110 may be configured to multiprocess so that generating sign language in response to audio and generating audio in response to sign language may occur substantially simultaneously. The interpreter 110 may be configured to process multiple simultaneous conversations between multiple DPs 125 and HPs 130.

In some embodiments, the agents 135 may act as sign language interpreters to do one or more of (a) convert sign language to text, (b) convert sign language to voice, (c) convert voice to sign language, and (d) convert text to sign language. The DP client 127 may obtain video from the DP 125. The call distribution controller 175 may select an agent client 137. In these and other embodiments, selecting an agent client 137 may include selecting the associated agent 135. In these and other embodiments, selecting an agent 135 may include selecting the associated agent client 137. The DP client 127 may send the video from the DP 125 to the selected agent client 137. The agent client 137 may present the video to the associated agent 135. The agent client 137 may include a microphone. The associated agent 135 may speak into the microphone. The agent client 137 may capture audio from the microphone and send the audio to the HP client 132. The audio may include words and other sounds corresponding to and interpretation of sign language included in the video obtained by the DP client 127. The HP client 132 may use a speaker to play the audio to the HP 130.

Additionally or alternatively, the HP client 132 may obtain audio from the HP 130. The HP client 132 may send the audio to an agent client 137. The agent client 137 may play the audio over a speaker to an associated agent 135. The associated agent 137 may perform sign language. The agent client 137 may use a camera to obtain video from the associated agent 135. The video may include a sign language interpretation of the audio obtained by the HP client 132. The agent client 137 may send the video to the DP client 127. The DP client 127 may use a display to present the video to the DP 125. At least some of the signals described above, including one or more of text, audio, and video, that are sent between components of the environment 100 may be sent via the network 180.

In some embodiments, the agent client 137 and other components of FIG. 1 may evaluate the performance of the agent 135. In a first performance evaluation example, the agent 135 may interpret sign language video from the DP 125 into speech. The agent client 137 may send the speech from the agent 135 to an ASR. The ASR may convert the audio to a first text sample. The DP client 127 may send the sign language video from the DP 125 to the interpreter 110. The interpreter 110 may convert the sign language video into a second text sample. The agent client 137 may compare the first text sample to the second text sample. The comparison may include one or more of (a) aligning the first text sample with the second text sample, for example, using dynamic time warping or a Viterbi method, (b) determining an agreement rate such as the number of aligned word pairs in the first and second text sample that match each other divided by the total number of words in one or more of the first text sample, the second text sample, and the first and second text samples, (c) using the agreement rate to determine an error rate, and (d) determining an error rate of the agent 135 using the first text sample as a hypothesis and the second text sample as a reference. Additionally or alternatively, the first text sample may be used as a reference and the second text sample may be used as a hypothesis.

The comparison result may include one or more of the agreement rate and the error rate. The comparison result may be used as an indication of the performance of the agent 135 and provided to one or more of the agent 135, a manager of the agent 135, and a performance report. The comparison result may be compared to a threshold. If the comparison result is greater than the threshold, the agent client 137 may take corrective action. Additionally or alternatively, if the comparison result is less than the threshold, the agent client 137 may take corrective action. Corrective action may include one or more of notifying the agent 135, notifying the manager of the agent 135, logging the performance of the agent 135 in a report, disconnecting the agent 135 from the call, and conducting further testing to evaluate the performance of the agent 135. If the agent 135 is disconnected from the call as part of corrective action, a different agent 135 or an interpreter 110 may be connected to the call.

In a second performance evaluation example, the HP client 132 may send speech audio from the HP 130 to the agent client 137. The agent client 137 may play the speech audio to the agent 135. The agent 135 may interpret the audio into sign language. A camera on the agent client 137 may collect video from the agent 135. The agent client 137 may send video from the agent 135 to the DP client 127. The agent client 137 may send video from the agent 135 to the interpreter 110. The interpreter 110 may convert the sign language video to a first text sample. The HP client 132 may send speech audio from the HP 130 to an ASR. The ASR may convert the speech audio to a second text sample. The first and second text samples may be compared. The comparison may include determining one or more of an error rate and an agreement rate. The comparison result may be used as an indication of the performance of the agent 135 and provided to one or more of the agent 135, a manager of the agent 135, and a performance report. The comparison result may be compared to a threshold. If the comparison result exceeds the threshold, corrective action may be taken as described in the first performance evaluation example above. Additionally or alternatively, if the comparison result does not exceed the threshold, corrective action may be taken. In some embodiments, one or more of audio from the HP 130, text from the HP 130, audio from the agent 135, video from the agent 135, video from the interpreter 110, audio from the interpreter 110, and video from the DP 125, may be used to enable the communication session.

In the embodiments described in one or more of the first and second performance evaluation examples, the error rate of the agent 135 may be overestimated or underestimated. For example, errors committed by the ASR or the ASLR may cause one or more of the error rate of the agent 135 to be overestimated and the agreement rate to be underestimated. In some embodiments, the comparison may be configured to at least partly compensate for the estimation error. This compensation may include a bias. For example, the threshold may be adjusted up or down by a selected amount to account for the expected overestimation or underestimation. Additionally or alternatively, the comparison result may be adjusted up or down to compensate for the estimation error.

In a third performance evaluation example, the agent client 137 may analyze one or more of audio and video from the HP client 132 to determine whether the HP 130 is speaking. The agent client 137 may analyze video from the agent 135 to determine whether the agent 135 is signing. If the agent client 137 determines that the agent 135 is signing at substantially the same time as the HP 130 is speaking, the agent client 137 may increase a parameter representing the performance of the agent 135. If the agent client 137 determines that the agent 135 is not signing at substantially the same time as the HP 130 is speaking, the agent client 137 may decrease a parameter representing the performance of the agent 135. If the parameter representing the performance of the agent 135 falls below a predetermined level, the agent client 137 may take corrective action. For example, if the HP 130 speaks for a selected period of time, during which the agent 135 does not sign, the agent client 137 may take corrective action.

Additionally or alternatively, the agent client 137 may analyze one or more of audio and video from the agent 135 and video from the DP 125 to determine whether the agent 135 is voicing at substantially the same time as the DP 125 is signing. If the agent client 137 determines that the agent 135 is voicing at substantially the same time as the DP 125 is signing, the agent client 137 may increase a parameter representing the performance of the agent 135. If the agent client 137 determines that the agent 135 is not voicing at substantially the same time as the DP 125 is signing, the agent client 137 may decrease a parameter representing the performance of the agent 135. If the parameter representing the performance of the agent 135 falls below a predetermined level, the agent client 137 may take corrective action. For example, if the DP 125 signs for a selected period of time, during which the agent 135 does not voice, the agent client 137 may take corrective action. In some embodiments, one or more of the audio from HP 130, the video from the DP 125, the video from the agent 135, and the audio from the agent 135 may be part of the communication session.

Determining whether audio includes speaking may include using an energy detector to determine the energy level in a segment of audio. The energy level may be compared to a selected threshold, If the energy level exceeds the threshold, the agent client 137 may determine that the audio includes speaking. Determining whether a video includes speaking may include locating a mouth in the video and determining whether the mouth is in motion. If the mouth is determined to be in motion, the agent client 137 may determine that a person in the video is speaking. Determining whether video contains signing may include using a motion detector to determine the degree of motion in a segment of video. The degree of motion may be compared to a selected threshold, If the degree of motion exceeds the selected threshold, the agent client 137 may determine that the video includes signing.

Modifications, additions, or omissions may be made to the environment 100 and/or the components operating in the environment 100 without departing from the scope of the present disclosure. For example, in some embodiments, the environment 100 may include any number of other components that may not be explicitly illustrated or described. Further, depending on certain implementations, the environment 100 may not include one or more of the components illustrated and described. For example, in some embodiments, the interpreter 110 may convert sign language from the DP 125 to a spoken form of the language (e.g., one or more of audio and text) but may not convert the spoken form from the HP 130 to sign language. As another example, the interpreter 110 may convert the spoken form from the HP 130 to sign language but may not convert sign language from the DP 125 to a spoken form. As another example, the agent 135 may interpret sign language from the DP 125 to the spoken form but may not convert the spoken form from the HP 130 to sign language. As another example, the agent 135 may interpret the spoken form from HP 130 to sign language but may not convert sign language from the DP 125 to the spoken form. As another example, the DP client 127 may be combined with the HP client 132 into a single device. For example, a computing device such as one or more of a tablet, computer, watch, glasses, and smartphone may use a camera, speaker, microphone, and display, respectively, to obtain video from the DP 125, play audio to the HP 130, obtain audio from the HP 130, and present one or more of video and text to the DP 125. As another example, sensitive information may be detected by one or more of the interpreter 110, the HP client 132, the DP client 127, the call distribution controller 175, the route controller 185, the agent client 137, the ASLR, the ASLS, the NLP system, one or more other components, and a combination thereof.

FIG. 2 illustrates an example environment 200 for sign language communication. The environment 200 may be arranged in accordance with at least one embodiment described in the present disclosure. The environment 200 may include an interpreter 210, DP client 227, HP client 232, call distribution controller 275, route controller 285, network 280, agent client 237, DP 225, HP 230, agent 235, consensus engine 299, and ASLR model builder 295. The interpreter 210 may include an ASLR 215, an ASLS 220, an ASR 216, and a TTSS 217. The DP client 227 may include a speaker 241, camera 242, microphone 243, display 244, touch screen 245, keyboard 246, mouse 247, and touchpad 248. The HP client 232 may include a speaker 261, camera 262, microphone 263, display 264, touch screen 265, keyboard 266, mouse 267, and touchpad 268. The agent client 237 may include a speaker 201, camera 202, microphone 203, display 204, touch screen 205, keyboard 206, mouse 207, touchpad 208, foot pedal 209, and editor 271. The DP client 227 and HP client 232 may each include a foot pedal and other input/output devices. In these and other embodiments, the foot pedal 209 may be configured as a foot switch.

In some embodiments, the network 280, DP client 227, HP client 232, agent client 237, interpreter 210, call distribution controller 275, and route controller 285 may be analogous to the network 180, DP client 127, HP client 132, agent client 137, interpreter 110, call distribution controller 175, and route controller 185, respectively, of FIG. 1.

In some embodiments, the network 280 may be configured to communicatively couple the interpreter 210 and the DP client 227. The network 280 may be configured to communicatively couple the interpreter 210 and the HP client 232. The network 280 may be configured to communicatively couple the interpreter 210 and the agent client 237. The network 280 may be configured to communicatively couple the call distribution controller 275 and the agent client 237.

In some embodiments, the environment 200 may include one or more of multiple interpreters 210, multiple agent clients 237, and combinations thereof. The environment 200 may include an agent 235 associated with the agent client 237. In these and other embodiments, the call distribution controller 275 and the route controller 285 may connect one or more of one or more interpreters 210, one or more agent clients 237, and combinations thereof to each call. For example, when a call begins, the call distribution controller 275 may select an available agent 235 and agent client 237 to handle the call. Additionally or alternatively, the call distribution controller 275 may select an available interpreter 210 to handle the call.

In some embodiments, the route controller 285 may connect the call to an agent client 237. The agent client 237 may play audio from the HP 230 to the agent 235. The agent client 237 may collect video from the agent 235 and send the video to the ASLR 215. The ASLR 215 may use the video to generate text and send the text to the ASLS 220. The ASLS 220 may generate video in response to the text from the ASLR 215. The ASLS 220 may send the video to one or more of the agent client 237 and the DP client 227. The video may include video of a first avatar copying what the agent 235 signs. The first avatar may be configured to look like the agent 235.

When the route controller 285 connects the call to the interpreter 210, the interpreter 210 may generate sign language video, performed by a second avatar, corresponding to what the HP 230 says. The interpreter 210 may send the video to the DP client 227. The first avatar may be configured to look like the second avatar. Additionally or alternatively, the first and second avatars may be the same avatar. By using an avatar to mimic the agent 235 when the agent 235 is connected to the call and using the same avatar to interpret when the interpreter 210 is connected to the call, the DP 225 may see the same avatar during automated and human interpreting and may experience a more seamless transition when the route controller 285 switches the call between the agent client 237 and the interpreter 210.

In some embodiments, the interpreter 210 may switch to a different avatar when the speaker changes. For example, the audio signal from one or more HP clients 232 may be sent to a diarizer (e.g., a speaker identification system). The diarizer may detect which person is speaking and send the speaker identity to the interpreter 210. The diarizer may determine which person is speaking by analyzing the sound of the person's voice. Additionally or alternatively, the diarizer may determine which speaker is speaking at a given time by detecting which of multiple communication devices is carrying the speaker's audio at the given time. Additionally or alternatively, the diarizer may determine which speaker is speaking based on one or more messages from the HP client 232. The interpreter 210 may use a different avatar for each speaker. The avatar may be configured based on one or more images or videos of the corresponding speaker so that the avatar resembles the speaker. For example, if a video call is connecting multiple calling parties, each with a different communication device, the video call may be carried using a video calling system that uses a combination of one or more network servers, PC software clients, smartphone apps, and videophones. The video calling system may send messages to the interpreter 210 that includes information on one or more of which speaker is speaking and what the speaker looks like. The interpreter 210 may use the information from the video calling system to configure an avatar for each calling party.

Additionally or alternatively, the interpreter 210 may indicate that the speaker has changed by one or more of changing the avatar's facial expression, changing the avatar's physical appearance, orienting the avatar's shoulders in a different direction, translating the avatar's body position left or right, directing the avatar's gaze left, right, up, or down, pointing to a location to indicate a presumed position for the speaker, and directing the avatar's gaze towards a location to indicate a presumed position for the speaker.

In some embodiments, the interpreter 210 may determine the demeanor of the HP 230 by analyzing one or more of the video and the voice of the HP 230. The demeanor of the HP 230 may include one or more of mood, emphasis, and sentiment. The interpreter 210 may determine the demeanor of the HP 230 using one or more of a sentiment analyzer and an emotion detector. The demeanor of the HP 230 may be sent to the interpreter 210. The interpreter 210 may use the demeanor of the HP 230 to modify the performance of the avatar to correspond to the demeanor. For example, the interpreter may modify the performance of the avatar by one or more of changing the expression on the avatar's face, increasing or decreasing the range of motions of the avatar's hands and arms, altering the signing speed, inserting or changing the duration of pauses, and causing the avatar to lean forward, backward, or to the side.

In some embodiments, the interpreter 210 may determine the demeanor of the DP 225 by one or more of analyzing how the DP 225 performs signs, analyzing what the DP 225 signs, reading facial expressions, analyzing gestures such as hand gestures, measuring signing speed, measuring pauses, measuring range of motion for the arms and hands, and detecting when the signer leans forward, backward, or to the side. The interpreter 210 may modify the audio sent to the HP 230 to correspond with the sentiment of the HP 225. For example, the audio may be modified to one or more of get louder or softer, increase or decrease volume, increase or decrease pitch, increase or decrease speed, increase or decrease vocal intensity, and insert or adjust the duration of pauses.

In some embodiments, the route controller 285 may determine whether a call is to be handled by an interpreter 210 or an agent 235 based on one or more call variables. Call variables may include availability of agents 235, such as one or more of whether a specific agent 235 is available, whether an agent 235 with skill or certification related to the current call is available, and whether at least a select number of agents 235 are available. In some embodiments, if availability of agents 235 fails to meet one or more select criteria, the route controller 285 may connect a call to an interpreter 210. Call variables may include an indication of preference by one or more of the DP 225 and HP 230 for a human or automated interpreter. In response to an indication of preference for a human interpreter, the route controller 285 may connect a call to an agent 235. In response to an indication of preference for an automated interpreter, the route controller 285 may connect a call to the interpreter 210. The indication of preference may be collected for a current call. Additionally or alternatively, the indication of preference may be stored in a profile associated with one or more of the DP 225 and HP 230 and use across multiple calls. Call variables may include one or more indications of how difficult it is likely to be to interpret the call. If a call is determined to be difficult to interpret, the route controller 285 may connect the call to an agent 235. If a call is determined not to be difficult to interpret, the route controller 285 may connect the call to the interpreter 210. Additional call variables are described above with reference to FIG. 1.

One or more of the call distribution controller 275 and route controller 285 may access one or more of a server, log, computer file, customer record, and database that may include information on one or more call variables. For a given call, one or more of the call distribution controller 275 and route controller 285 may use call variable information to determine call treatment and may select an agent 235. In some embodiments, one or more of call treatment determination and agent 235 selection may occur at the start of a call. Additionally or alternatively, one or more of call treatment determination and agent 235 selection may occur during a call. For example, if an agent 235 or interpreter 210 resource handling a current call becomes unavailable due to one or more of the agent 235 taking a break, equipment or software failure, loss of network 280 connection, system overload due to a traffic increase, and other circumstances, one or more of the call distribution controller 275 and route controller 285 may transfer the call to another interpreter 210 resource or agent 235. For example, if an agent 235 becomes unavailable, such as because of one or more of the agent 235 logs off, the agent 235 uses the agent client 237 to request a break, an equipment failure, and a software failure, the call distribution controller 275 may detect that the agent 235 is no longer available, identify an available agent 235, and transfer the call to the identified available agent 235.

If the route controller 285 determines that a call is to be handled by an agent 235, the call distribution controller 275 may determine agent 235 selection, such as which agent 235 to attach to the call. Agent 235 selection may be based on one or more of the agent 235 availability, the agent 235 skill such as language skill, scores from the agent 235 testing, geographical location of the agent 235, and whether the agent 235 is deaf or hearing. Agent 235 selection may be based at least partly on a call type.

The call type may be at least partly determined using a role of one or more of the calling parties. The role may be that of one or more of a business representative, friend, family member, automated communication system such as an IVR system, a call center agent, a sales agent, a government entity such as the Social Security Administration, and a collection agency. The call type may be determined using the presumed purpose of the call such as a business call, residential call, sales call, or call to a given type of business or agency such as a doctor's office, online or telephone shopping, hospital, bank, financial services company, church, law office, retail store, or customer service center. The call type may be determined using a communication device identifier such as a phone number, IP address, email address, handle, among other communication device identifiers. For example, one or more of the call distribution controller 275 and route controller 285 may use a communication device identifier to index a lookup table of records that may include call types, obtain a record from the lookup table, and use the record to determine one or more of call treatment and selection of an agent 235. The call type may be at least partly determined using a classification of one or more communication devices used for the call. The classification may include one or more of videophone, smartphone, mobile phone, landline phone, tablet, PC, wearable device such as glasses or a watch, device model, manufacturer, and release number.

In some embodiments, the call type may be determined using the call type determined during a previous call that included one or more of the current call participants. The call type may be determined by analysis of call content such as a transcript of at least part of the call. For example, if a call contains a relatively large number of medicals terms, the call type may be determined to be a medical call. If a first call to a given communication device is determined to be a first call type, then that first call type may be used to determine the second call type of a second call that includes the same communication device. For example, the first call type may be used at the beginning of a second call as the second call type. The call type may change over the course of a call as additional information becomes available.

The call type may be at least partly determined using a lookup table. The table may include the call type associated with one or more communication devices. The call type may be determined by matching one or more voices on the call with one or more voiceprints and associating the one or more voiceprints with a given call type. The call type may be determined by matching one or more faces on a video call with one or more faceprints and associating the one or more faceprints with a given call type. The call type may be determined based on at least one personal characteristic of at least one caller. Personal characteristics may include one or more of voice technique, signing technique, accent, age, language, speaking or signing mannerisms, type and degree of disability, and word or sign choices.

The call type may include a preference collected from the DP 225 for a hearing interpreter or a deaf interpreter. The DP 225 may indicate a preference for a hearing interpreter or a deaf interpreter for multiple calls, such as by creating an entry in one or more of the DP client 227 memory, an account profile of the DP 225, and a database. Additionally or alternatively, the DP 225 may indicate a preference for a hearing interpreter or a deaf interpreter for one or more of a single call, one or more calls, and subsequent calls (or until the DP 225 indicates a new preference).

The call type may include one or more of the call type attributes listed herein. The call type may be determined using one or more of the methods described herein for determining call type. The call type may include multiple information elements and may be determined using one or more of the methods described herein for determining call type. For example, a call type may include multiple attributes such as one or more device identifiers, call content, a record from a lookup table, the model of one or more communication devices used for the call, and one or more characteristics of one or more callers. Additional call types are described above with reference to FIG. 1.

In some embodiments one or more of the call participants may indicate a preference for at least one agent type. A system such as the call distribution controller 275 may collect the agent type preference for one or more callers. The call distribution controller 275 may use the agent type preference for a current call. Additionally or alternatively, the call distribution controller 275 may save the agent type preference to be used for one or more future calls. A call participant may use one or more of a website, smartphone, smartphone app, personal computer application, browser, paper form, digital form, phone call, HP client 232, and DP client 227 to indicate an agent type preference.

Agent types may include one or more of hearing, hard of hearing, and deaf. Additionally or alternatively, agent types may include a human interpreter and an automated interpreter. Additionally or alternatively, agent types may include one or more of language, gender, age, vision status (e.g., sighted, impaired, blind), organizational affiliation, religion, geographical region, accent, and topic specialty. The agent type may include one or more specific agents 235. For example, the caller may prefer one or more agents 235 that the caller has used and liked in the past. Agent types may include one or more of skills and disabilities. For example, an agent 235 may be deaf or hard of hearing yet still be able to voice clearly.

In some embodiments, if a caller's preferred agent type is available for a given call, the call distribution controller 275 may connect the call to the preferred agent type. If the caller's preferred agent type is not available, the call distribution controller 275 may connect the call to a different agent type. Additionally or alternatively, if the caller's preferred agent type is not available, the call distribution controller 275 may connect the call to the interpreter 210. The preferred agent type not being available may include one or more of (a) the caller prefers a hearing interpreter and a hearing agent 235 is not available. (b) the caller prefers a hard of hearing interpreter and a hard of hearing agent 235 is not available. (c) the caller prefers a deaf interpreter and a deaf agent 235 is not available, (d) the caller prefers a human interpreter and an agent 235 is not available, and (e) the caller prefers an automated interpreter and an automated interpreter is not available.

In some embodiments, if a call participant such as the DP 225 indicates a preference for a hearing interpreter, the call distribution controller 275 may determine if a hearing agent 235 is available. If a hearing agent 235 is available, the call distribution controller 275 may connect the call to a hearing agent 235. If a hearing agent 235 is not available, the call distribution controller 275 may connect the call to a hard of hearing or deaf agent 235. Additionally or alternatively, if a call participant such as the DP 225 indicates a preference for a deaf interpreter, the call distribution controller 275 may determine if a deaf agent 235 is available. If a deaf agent 235 is available, the call distribution controller 275 may connect the call to a deaf agent 235. If a deaf agent 235 is not available, the call distribution controller 275 may connect the call to a hearing or hard of hearing agent 235. Additionally or alternatively, if a call participant such as the DP 225 indicates a preference for a hard of hearing interpreter, the call distribution controller 275 may determine if a hard of hearing agent 235 is available. If a hard of hearing agent 235 is available, the call distribution controller 275 may connect the call to a hard of hearing agent 235. If a hard of hearing agent 235 is not available, the call distribution controller 275 may connect the call to a deaf or hearing agent 235. In some embodiments, deaf agents 235 and hard of hearing agents 235 may be considered equivalent and interchangeable with respect to caller preference.

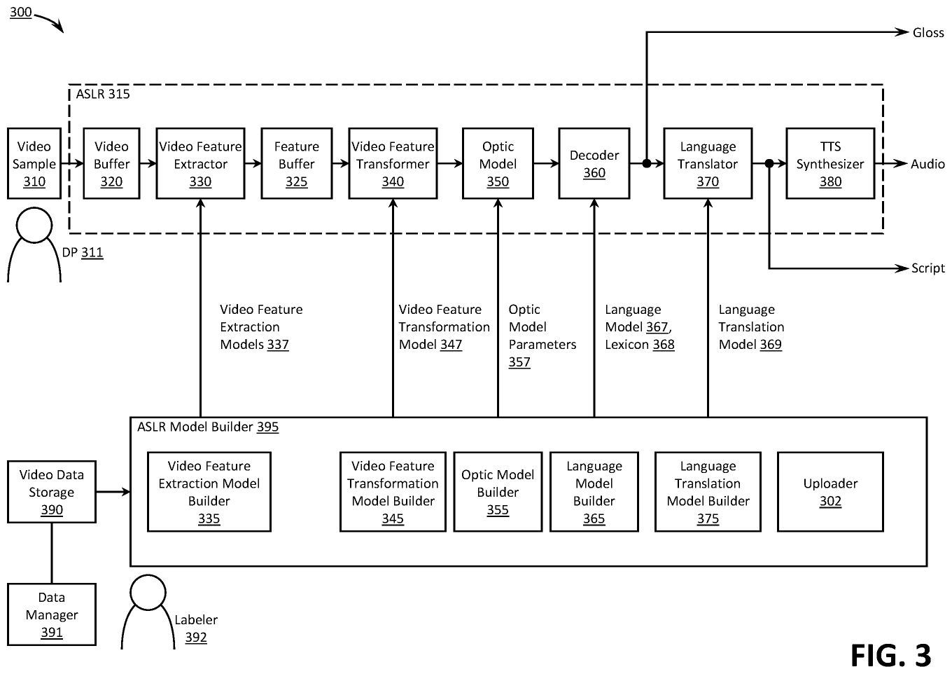

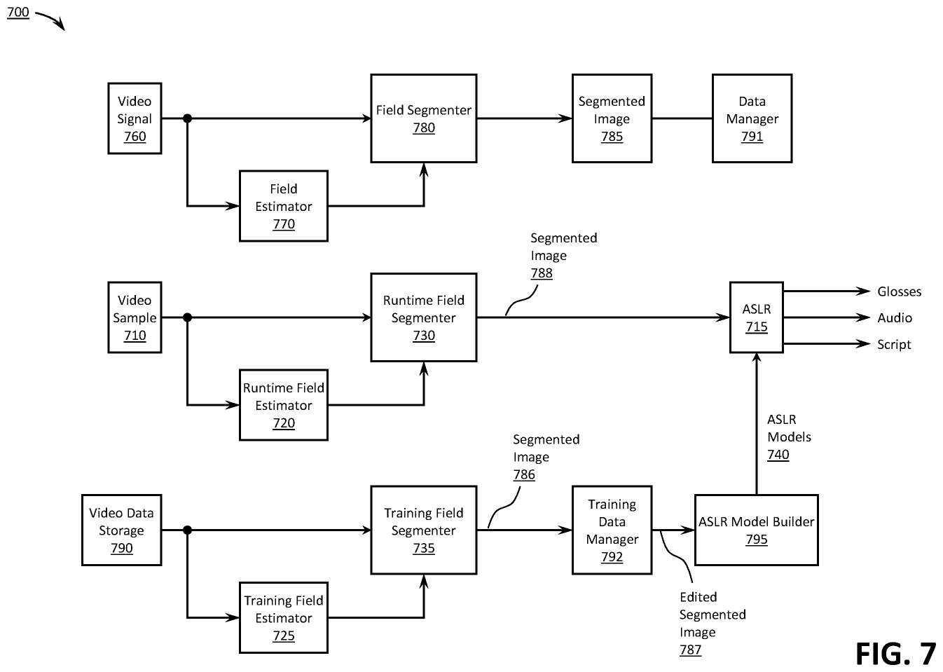

FIG. 2A, FIG. 2B, and FIG. 2C illustrate example environments 200A, 200B, and 200C for sign language communication. The components of FIG. 2A, FIG. 2B, and FIG. 2C may be analogous to the components with matching names and numbers illustrated in FIG. 2. The ASLR model builder 295 may be analogous to one or more of the ASLR model builder 395 of FIG. 3 and the ASLR model builder 795 of FIG. 7. The agent 235 may be hearing, hard of hearing, or deaf.

FIG. 2A illustrates an example environment 200A for sign language communication. The environment 200A may be arranged in accordance with at least one embodiment described in the present disclosure. In some embodiments, if a call participant such as the DP 225 indicates a preference for a deaf interpreter, the call distribution controller 275 may connect the call to a deaf agent 235. In some embodiments, the HP client 232 may collect one or more of audio, video, and text from the HP 230. The HP client 232 may send the audio to one or more of the agent 235 and the ASR 216. Additionally or alternatively, audio from the HP client 232 may be sent to the ASR 216 via the agent client 237. The ASR 216 may convert the audio to text. The agent client 237 may present the text from the ASR 216 on the display 204. In some embodiments, the agent client 237 may present to the agent 235 one or more of audio collected from the HP 230 by the HP client 232, video collected from the HP 230 by the HP client 232, text collected from the HP 230 by the HP client 232, and text generated by the ASR 216 using audio from the HP 230. Since some people regarded as deaf have some residual hearing, they may be aided by audio from the HP 230. The agent client 237 may play audio from the HP 230 using the speaker 201. The speaker 201 may include one or more of a speaker, an amplified speaker (e.g., a speaker configured to play at a louder volume than is typically used by a hearing person), a headset, headphones, earbuds, a hearing aid, and a wired or wireless connection to an assistive hearing device such as a hearing aid or loop.

The audio played by the speaker 201 may be synchronized with the text from the ASR 216 so that the audio and text are presented to the agent 235 substantially simultaneously. The audio played by the speaker 201 may be synchronized with the text from the ASR 216 by delaying or advancing one or more of the audio and the text. The amount of delay or advance may be determined by using the ASR 126 to determine the endpoints of words in the audio and displaying the text corresponding to the words in the audio at times that substantially match the word endpoints. For example, the audio may be delayed to give a speech recognizer time to identify the endpoints (e.g., one or more of the start and end times) of words in an audio stream. Endpoints may include indications of the starting time, ending time, or starting and ending time of individual words in the audio. If a speech recognizer determines that a first word occurs (e.g., starts or ends, depending on the implementation) at time t1 in the delayed audio stream, then the text of the first word may be displayed at the time t1 so that the word appears on the display 204 at substantially the same time as it is played by the speaker 201. By synchronizing the audio and text, the agent client 237 may enable the agent 235 to more easily comprehend what the HP 230 says.

In some embodiments, the HP client 232 may collect video from the HP 230 and send the video to the agent client 237. The agent client 237 may present the video on the display 204. In some embodiments, the display 204 may present the video in an enhanced view that makes one or more of the face and mouth relatively more visible, compared to the un-enhanced view as collected by the HP client 232. The agent client 237 may use image processing to generate the enhanced view. The image client 237 may determine one or more of the size and location of the face of the HP 230 in the video. The agent client 237 may determine a region of focus that includes the face of the HP 230. Additionally or alternatively, the image client 237 may determine one or more of the size and location of the mouth of the HP 230. The agent client 237 may use image processing to determine a region of focus that includes part of the face, such as an area including the mouth, of the HP 230. The agent client 237 may crop, resize, or crop and resize the video in response to the determined region of focus. Resizing the video may include magnifying or shrinking at least a portion of the video. For example, the display 204 may crop the video to substantially include the region of focus and substantially exclude video outside the region of focus. The agent client 237 may resize the region of focus. The agent client 237 may crop and resize the region of focus to fit a space of a determined size on the display 204. For example, the agent client 237 may identify a region of focus that includes one or more of the face and the mouth. The agent client 237 may crop and resize the region of focus and present the region of focus in a first location on the display 204. Additionally or alternatively, the agent client 237 may present text from the ASR 216 in a second location on the display 204. The agent client 237 may allow the agent 235 to modify how the region of focus may be determined. For example, the agent 235 may select the face or the mouth as a region of focus. As another example, the agent 235 may select the size and position of one or more of the first and second locations.

One or more operations of creating an enhanced view, including least one of image processing, determining a region of focus, cropping, resizing, selecting a first location, and selecting a second location, may be performed by the agent client 237. Additionally or alternatively, one or more of the operations of creating an enhanced view may be performed by other components such as the HP client 232, the display 204, and by components not illustrated in FIG. 2A.

In some embodiments, the video collected from the HP 230 and presented on the display 204 may be synchronized to one or more of the audio and text. If the agent 235 is able to see the HP 230's lips move, the video may further aid the agent 235 in comprehension.

The agent client 237 may enable the agent to adjust audio volume from the speaker 201 to be louder or quieter. The agent client 237 may enable the agent to turn audio from the speaker 201 on or off. The agent 235 may use the text from the ASR 216 to perform sign language. For example, the agent 235 may interpret the text from the ASR 216 into sign language. The camera 202 may collect video from the agent 235 and send the video to the DP client 227. The DP client 227 may use the display 244 to present the video to the DP 225

FIG. 2B illustrates an example environment 200B for sign language communication. The environment 200B may be arranged in accordance with at least one embodiment described in the present disclosure. In some embodiments, if a call participant such as the DP 225 indicates a preference for a deaf interpreter, the call distribution controller 275 may connect the call to a deaf agent 235. The camera 242 may collect a first video from the DP 225. The DP client 227 may send the first video to the agent client 237. The agent client 237 may present the first video on the display 204. The agent 235 may use the first video to perform sign language. For example, the agent 235 may repeat, rephrase, or interpret the signs the agent 235 sees the DP 225 perform. The agent client 237 may use the camera 202 to collect a second video from the agent 235 and send the second video to the ASLR 215. The ASLR 215 may convert the second video to an ASLR 215 output that may include one or more of a spoken form, text, script, gloss, and audio. The HP client 232 may present the ASLR 215 output to the HP 230. For example, the speaker 261 may play audio from the ASLR 215 to the HP 230. Additionally or alternatively, the display 264 may present text from the ASLR 215 to the HP 230.

In some embodiments, the ASLR 215 may be configured to adapt to the agent 235. For example, the ASLR 215 may adapt to the signing style of the agent 235. Adapting to the signing style of the agent 235 may include the ASLR 215 using video from the agent 235 to adjust ASLR model parameters. Each agent 235 may be associated with a profile that includes information related to the signing style of the agent 235. The ASLR 215 may use the profile of the agent 235 to convert video from the agent 235 to a spoken form. The ASLR 215 may save the adjusted model parameters in a location associated with the agent 235 or agent client 237. The ASLR 215 may use one or more of the identity (e.g., an agent number or login) of the agent 235 or identity of the agent client 237 to retrieve the adjusted model parameters, and may use the adjusted model parameters to convert video from the agent 235 to a spoken form. Further methods for adapting to a signing style are provided in the description with reference to FIG. 3.

Additionally or alternatively, the agent 235 may voice an interpretation of sign language in the first video. The agent client 237 may collect audio from the agent 235 and send the audio to the HP client 232. The HP client 232 may play the audio to the HP 230 using the speaker 261. Additionally or alternatively, the ASR 216 may convert audio from the agent 235 to text. The HP client 232 may display the text on the display 264. In some embodiments, the ASR 216 may be adapted to the speaking style of the agent 235. Each agent 235 may be associated with a profile that includes information related to the speaking style of the agent 235. The ASR 216 may use the profile of the agent 235 in converting audio from the agent 235 to text.

Additionally or alternatively, the agent 235 may input text of an interpretation of sign language in the first video using one or more of a keyboard, stenotype, Braille keyboard, touchscreen, and other computer input device. In some embodiments, the text input may be translated using a language translator from one or more of shorthand, stenotype chords, Braille, and other formats into a spoken form. The agent client 237 may send the spoken form to the HP client 232. The HP client 232 may present text to the HP 230 using the display 264. Additionally or alternatively, the agent client 237 may use a TTSS 217 to convert the text to audio and the HP client 232 may use the speaker 261 to play the audio to the HP 230.

FIG. 2C illustrates an example environment 200C for sign language communication. The environment 200C may be arranged in accordance with at least one embodiment described in the present disclosure. In some embodiments, the agent client 237 may enable the agent 235 to correct interpreting errors. The HP client 232 may receive a first spoken form from the HP 230. The spoken form may include one or more of a first audio, first text, and third video. The HP client 232 may send the first spoken form to the agent client 237. The agent client 237 may present the first spoken form to the agent 235. The agent client 237 may collect a fourth video from the agent 235 and send the fourth video to the ASLR 215. The ASLR 215 may interpret the fourth video and output a second spoken form. The second spoken form may include one or more of a third text and a second audio. The third text may include one or more of script and gloss. Additionally or alternatively, the ASLR 215 may send the third text to the ASLS 220. The ASLS 220 may use the third text to generate a fifth video. One or more of the third text, second audio, third video, and fifth video may be presented to the agent 235. In response to one or more of the first audio, second audio, first text, second text, third text, third video, and fifth video, the agent 235 may take action using the editor 271. The editor 271 may enable the agent 235 to take action such as one or more of providing feedback on one or more of the quality, accuracy, and speed of the fifth video, indicating one or more symbols that were incorrectly interpreted, indicating one or more symbols that were correctly interpreted, correcting the sign language video sent to the DP 225, and repeating one or more signs previously signed by the agent 235 to give the ASLR 215 another chance to interpret the one or more signs to a spoken form. The editor 271 may enable the agent 235 to perform one or more actions listed above, including editing one or more of text, gloss, and video. The editor 271 may enable the agent 235 to edit the fifth video to create a sixth video. The agent client 237 may send the sixth video to the DP client 227. The DP client 227 may present the sixth video to the DP 225. Additionally or alternatively, the DP client 227 may present the fifth video to the DP 225.

In some embodiments, the ASLR model builder 295 may use the output of the editor 271, including at least one of edited text, edited gloss, edited video, and one or more indications of which signs were correctly interpreted and which signs were incorrectly interpreted to build ASLR models. For example, if the agent 235 identifies one or more signs that are incorrectly interpreted, the one or more signs may not be used by the ASLR model builder 295. As another example, if the agent 235 identifies one or more signs that are correctly interpreted, the one or more signs may be used by the ASLR model builder 295 in one or more of adapting, tuning, and building one or more ASLR models. The ASLR models may be sent to the ASLR 215. The ASLR 215 may use the ASLR models to recognize sign language.

In some embodiments, as the DP 225 and HP 230 take turns in the conversation, the agent 235 may switch between signing to a DP 225 for an HP 230 and voicing to an HP 230 for a DP 225. For example, the agent 235 may use a first mode, such as using one or more methods described with respect to FIG. 2A and FIG. 2C, when the HP 230 is speaking. The agent 235 may use a second mode, such as using one or more methods described with respect to FIG. 2B, when the DP 225 is signing. The agent 235 may switch between modes manually, for example using one or more of a voice command, button press, mouse click, and foot pedal 209. Additionally or alternatively, the environment 200 may automatically switch between modes in response to activity by the callers or by the agent 235. For example, when the HP 230 speaks, a voice activity detector may use the audio from the HP 230 to determine that the HP 230 is speaking and may configure the environment 200 to a first mode, such as a mode described with reference to FIG. 2A. Additionally or alternatively, when the DP 225 signs, a motion detector may use the first video from the DP 225 to determine that the DP 225 is signing and may configure the environment 200 to a second mode, such as the mode described with reference to FIG. 2B.

Modifications, additions, or omissions may be made to the environments 200A, 200B, and 200C and/or the components operating in the environments 200A, 200B, and 200C without departing from the scope of the present disclosure. For example, in some embodiments, the environments 200A, 200B, and 200C may include any number of other components that may not be explicitly illustrated or described. As another example, the operations performed by components operating in the environments 200A, 200B, and 200C such as the DP client 227, agent client 237, HP client 232, ASR 216, ASLR 215, ASLS 220, and other components may be distributed among multiple devices and/or systems such as remote servers. As another example, some components shown in FIG. 2A, FIG. 2B, and FIG. 2C may be combined into fewer components. For example, the agent client 237 may perform operations described with reference to one or more of the ASR 216, ASLR 215, ASLS 220, and ASLR model builder 295. Further, depending on certain implementations, the environments 200A, 200B, and 200C may not include one or more of the components illustrated and described.

Returning to FIG. 2, in some embodiments, one or more of the arrangements described herein for enabling a deaf interpreter to interpret a call may be used to enable a hard of hearing interpreter to interpret a call. Additionally or alternatively, one or more of the arrangements described herein for enabling a deaf interpreter to interpret a call may be used for a hearing interpreter. For example, the agent client 237 may display the text, converted from HP 230 audio using the ASR 216, on display 204. The hearing interpreter may use the text in case the hearing interpreter gets distracted, fails to understand, is unable to hear, or forgets what the HP 230 said.

In these and other embodiments, the HP client 232 may send one or more of text, audio, and video to the agent client 237. The HP client 232 may use the keyboard 266, to collect text from the HP 230. The HP client 232 may use the microphone 263 to collect audio from the HP 230. The HP client 232 may use the camera 262 to collect video from the HP 230. The HP client 232 may send one or more of the text, audio, and video to the agent client 237. The agent client 237 may present the audio to the agent 235 using the speaker 201. The agent client 237 may present the video using the display 204. The agent client 237 may present the text using the display 204. The agent 235 may watch and listen to the HP 230 on the display 204, including watching the mouth of the HP 230 as an aid to intelligibility.

In some embodiments, the environment 200 may include multiple interpreters 210. Each of the multiple interpreters 210 may use a different mode. The mode may be selected in response to a specified set of call variables. In these and other embodiments described herein, a set of call variables may include one element or more than one element. Additionally or alternatively, the mode of an interpreter 210 may be configured by selecting or adjusting one or more of settings, parameters, models, and other modifications to the interpreter 210. In some embodiments, one or more of the call distribution controller 275 and the route controller 285 may select an interpreter 210 based on one or more call variables. Additionally or alternatively, one or more of the call distribution controller 275 and the route controller 285 may modify the behavior of the interpreter 210 based on one or more call variables such as call type. For example, the behavior of the interpreter 210 may be modified by instructing the interpreter 210 to use a different language model.

The DP 225 may be associated with (e.g., may use) the DP client 227. The HP 230 may be associated with (e.g., may use) the HP client 232. The agent 235 may be associated with (e.g., may use) the agent client 237. Equipment (e.g., cameras, microphones, displays, speakers) associated with the DP 225, HP 230, and agent 235 may be communicatively coupled to one or more computers or other processing units that convert, manage, and transport signals to and from the equipment to a network or to other blocks illustrated in FIG. 2.

In some embodiments, the network 280 may be omitted, divided into multiple networks, replaced with other networks, or combined with networks not illustrated. For example, some components in FIG. 2 may be in proximity to each other and may be connected to each other using cables or wires.

In some embodiments, the camera 242 may be configured to collect video from the DP 225. The keyboard 246 may be configured to collect text from the DP 225. The microphone 243 may be configured to collect audio from the DP 225. The camera 262 may be configured to collect video from the HP 230. The keyboard 266 may be configured to collect text from the HP 230. The microphone 263 may be configured to collect audio from the HP 230. The camera 202 may be configured to collect video from the agent 235. The keyboard 206 may be configured to collect text from the agent 235. The microphone 203 may be configured to collect audio from the agent 235.

The display 244, display 264, and display 204 may be configured to present one or more of video and text from the DP 225; video and text from the HP 230; video and text from the agent 235; video from the ASLS 220; text generated using the ASR 216 transcribing the voice of one or more of the HP 230, the DP 225, and the agent 235; and one or more of audio and text from the ASLR 215. The speaker 241, speaker 261, and speaker 201 may be configured to present audio from one or more of the DP 225, HP 230, ASLS 220, and agent 235. The display 204 may be configured to present gloss generated by the ASLR 215 based on video received from the DP client 227.

In some embodiments, the editor 271 may enable the agent 235 to correct errors made by the ASR 216. For example, the ASR 216 may transcribe audio from the HP 230 into text. The editor 271 may provide one or more of audio from the HP 230 and text from the ASR 216 to the agent 235. The editor 271 may enable the agent 235 to correct errors in the text from the ASR 216 output. The editor 271 may enable the agent 235 to make corrections via one or more of speech (i.e., revoicing audio into an ASR), keyboard, mouse, touchscreen, touchpad, camera, and other computer I/O devices. Correcting errors may include one or more of deleting text, inserting text, and modifying text. The editor 271 may use the camera 202 to collect video from the agent 235. The editor 271 may use the ASLR 215 to convert the video from the agent 235 into text. The editor 271 may use text from the ASLR 215 based on video from the agent 235 to replace at least part of the text generated by the ASR 216. The corrected text may be sent to the DP client 227 where it may be presented to the DP 225. Additionally or alternatively, the corrected text may be sent to the ASLS 220. Video generated by the ASLS 220 may be sent to the DP client 227 where it may be presented to the DP 225.

In some embodiments, the editor 271 may enable the agent 235 to correct errors made by the ASLR 215. The ASLR 215 may convert video from the DP 225 into to a first text. The first text may include one or more of gloss and script. Additionally or alternatively, the TTSS 217 may convert the first text to audio. The audio may include speech. The agent client 237 may present to the agent 237 one or more of video from the DP 225, the first text from the ASLR 215, and speech from the TTSS 217. The editor 271 may enable the agent 235 to edit the first text generated by the ASLR 215. The editor 271 may enable the agent 235 to make edits via one or more of speech (i.e., revoicing audio into an ASR), keyboard, mouse, touchscreen, touchpad, camera and other computer I/O devices. Additionally or alternatively, the editor 271 may enable the agent 235 to make corrections using sign language. The editor 271 may use a camera to collect video from the agent 235 and convert the video into text and editing commands using an ASLR. The editing commands may include sequences of one or more words or signs for instructing the editor for one or more of pausing the video, resuming the video, rewinding the video, forwarding the video, deleting a sign, inserting a sign, and replacing a sign. Additionally or alternatively, the editor 271 may use a camera to collect video from the agent 235. The editor may use the ASLR 215 to convert the video to a second text and may replace at least part of the first text with the second text.

As described above with reference to FIG. 2C, the ASLR model builder 295 may use the actions of the editor 271 to build ASLR models.

Correcting errors may include one or more of deleting words or other symbols, inserting symbols, and modifying symbols. The editor 271 may send corrected text to the HP client 232. Additionally or alternatively, the corrected text may be sent to the TTSS 217, where it may be converted to audio. The audio may be sent to the HP client 232 to be played for the HP 230.

In some embodiments, video from a DP 225 may be routed to an interpreter 210 and to an agent client 237. The output from the interpreter 210 and agent client 237 may be routed to a consensus engine 299. The consensus engine 299 may combine the output from the interpreter 210 and agent client 237 into one interpretation and send the interpretation to the HP client 232. The consensus engine 299 may determine whether the interpretation from the interpreter 210 or the agent client 237 is more reliable and select the more reliable interpretation to send to the HP client 232. For example, if, at a given time, the interpreter 210 is generating one or more of text and audio and the agent client 237 is not generating audio, the consensus engine 299 may select the interpretation from the interpreter 210 to send to the HP client 232. As another example, if the interpreter 210 and the agent client 237 are generating one or more of text and audio, the consensus engine 299 may compare the confidence score from the interpreter 210 to a selected threshold. If the confidence score from the interpreter 210 is below a selected threshold for one or more words, the consensus engine 299 may select the interpretation for the one or more words from the agent client 237 to send to the HP client 232. If the confidence score from the interpreter 210 is above a selected threshold for one or more words, the consensus engine 299 may select the interpretation for the one or more words from the interpreter 210 to send to the HP client 232.

If the ASLR 215 is unable to interpret a phrase or has low confidence that its interpretation of the phrase is correct, the ASLR 215 may not output the interpretation. Additionally or alternatively, the ASLR 215 may output a message (e.g., “unintelligible” or “garbled”) that indicates that the phrase could not reliably be interpreted.

In some embodiments, if the ASR 216 is unable to recognize a phrase or has low confidence that the ASR transcript of the phrase is correct, the ASR 216 may not output a transcript. Additionally or alternatively, the ASR 216 may output a message that indicates that the phrase could not reliably be recognized. Additionally or alternatively, if the ASR 216 is unable to recognize a phrase or has low confidence that the ASR transcript of the phrase is correct, the ASR 216 may send a message to the ASLS 220 indicating that a phrase was not understood. The ASLS 220 may generate one or more signs or gestures to advise the DP 225 that the message was not understood. For example, the ASLS 220 may generate video where the character performing sign language shrugs its shoulders, says in sign language that it missed part of what the HP 230 said such as by signing that it didn't understand, displays a confused look, otherwise indicates that part of the message was unclear, or a combination thereof. Additionally or alternatively, the display 244 may display a text message indicating that at least part of the message was unclear.

In some embodiments, a first call treatment may include using the interpreter 210 for one or more of interpreting a spoken form to sign language and reverse interpreting sign language to a corresponding spoken form.

Converting sign language to a spoken form may include using the ASLR 215. The camera 242 may be configured to obtain video from the DP 225. The camera 242 may send the video to the interpreter 210. The interpreter 210 may use the ASLR 215 to convert the video to text. The interpreter 210 may send the text to one or more of the display 264 and display 204. Additionally or alternatively, the TTSS 217 may convert the text into speech. The speaker 261 may play the speech to the HP 230. Additionally or alternatively, the display 264 may show one or more of text and video from one or more of the DP 225 and the agent 235. Additionally or alternatively, the speaker 261 may play audio from one or more of the DP 225, the ASLR 215 via the TTSS 217, and the agent 235. The HP 230 may turn the audio from one or more of the DP 225, ASLR 215 via the TTSS 217, and the agent 235 on or off using the HP client 232.

Converting speech audio from the HP 230 to sign language video may include using the ASLS 220. The microphone 263 may be configured to collect audio from the HP 230. The microphone 263 may send the audio to the ASR 216. The ASR 216 may convert the audio to text. The ASR 216 may send the text to the interpreter 210. The interpreter 210 may use the ASLS 220 to convert the text to a video signal. The video signal may include sign language. The interpreter 210 may send the video signal to the display 244 where it may be presented to the DP 225. Additionally or alternatively, the HP client 232 may collect text from the HP 230. The HP client 232 may send the text to the display 244. The display 244 may present the text to the DP 225. Additionally or alternatively, the HP client 232 may send the text to the ASLS 220. The ASLS 220 may use the text to generate video and send the video to the DP client 227. The DP client 227 may use the display 244 to present one or more of the text from the HP 230 and the video from the ASLS 220.

In some embodiments, text from the ASR 216, transcribed from audio collected from the HP client 232, may be simplified and presented on the display 244. Additionally or alternatively, the simplified text may be sent to the ASLS 220, converted to sign language video, and presented on the display 244. Simplifying text from the ASR 216 may enable a DP 225 with limited reading skills or limited familiarity with the language spoken by the HP 230 to understand the DP 230. Methods for simplifying text from the ASR 216 may include language translation that converts text from the ASR 216 to a simplified form. Simplifying text may include modifying the text to be more easily understood while preserving at least part of the original meaning. Simplifying text may include one or more of deleting words, replacing words with alternate words, rephrasing word sequences, correcting grammar, and breaking long sentences into multiple shorter sentences. Deleting words may include removing one or more of filler words (e.g., “um,” “ah”), repeated words, phrases that contain substantially the same information as other phrases, and words that contain relatively little information. Additionally or alternatively, simplifying text from the ASR 216 may include translating the text into a different language. For example, English text from the ASR 216 may be translated to Spanish text. The text may be simplified before being translated to a different language. Additionally or alternatively, the text may be simplified after being translated to a different language.

In some embodiments, the display 244 may show video from one or more of the HP 230, agent 235, and the ASLS 220. Additionally or alternatively, the speaker 241 may play audio from one or more of the microphone 263 and the microphone 203. The DP 225 may turn the audio from one or more of the HP 230 and the agent 235 on or off using the DP client 227.

The ASLS 220 may generate a video of an avatar. The avatar may perform sign language. The avatar may include a mouth that forms words. The mouth may include facial features such as one or more of lips, teeth, tongue, cheeks, eyes, eyebrows, and jaw, among other facial features. In some embodiments, the ASR 216 may convert audio from the HP 230 to text and send the text to a mouth generator. The mouth generator may use the text to determine a sequence of mouth formations. The avatar may use the mouth formations to mouth words spoken by the HP 230. Additionally or alternatively, the HP client 232 may send audio from the HP 230 to the DP client 227. The DP client 227 may play audio from the HP 230. The DP client 227 may display mouth formations from the mouth generator. The audio from the HP 230 and mouth formations from the mouth generator may be synchronized so that they occur at substantially the same time.

Additionally or alternatively, the HP client 232 may send audio from the HP 230 to the mouth generator. The mouth generator may use the audio from the HP client 232 to determine a sequence of mouth formations that match speech from the HP 230. Additionally or alternatively, the HP client 232 may send text from the ASR 216 to one or more of a language translator and the ASLS 220. The language translator may convert the text to gloss. The ASLS 220 may convert one or more of the text and the gloss to video. The video may include an avatar performing sign language. The language translator may send one or more of the gloss and the text from the ASR 216 to at least one mouth generator. The mouth generator may use one or more of the gloss and the text to determine a sequence of mouth formations. The mouth formations may match one or more of the gloss and the text. Additionally or alternatively, the mouth formations may match text derived from one or more of the gloss, the text from the ASR 216, an interpretation of text from the ASR 216 that includes information from the ASR 216 not included in the sign language, and a combination thereof. The avatar may use the sequence of mouth formations to mouth words. The sequence of mouth formations may be substantially synchronized to sign language performed by the avatar. The mouth generator may use a neural network to convert one or more of text, gloss, and audio to a sequence of mouth formations.

In some embodiments, the interpreter 210 may use one or more of text from the ASR 216 and audio from the HP 230 to determine affect from the HP 230. Affect may include one or more of sentiment, emotion, mood, feeling, and emphasis. The ASLS 220 may use the affect to modify video sent to the DP client 227. The video may be modified to convey the affect determined from the HP 230. Modification to the video may include one or more of changing the facial expression, expressing affect via body language, widening or narrowing the eyes, titling the head, raising or lowering the eyebrows, leaning forward, backward or to the side, increasing or decreasing the signing rate, emphasizing selected signs by one or more of increasing or decreasing one or more of the velocity, range of motion, smoothness, and force of the selected signs, forming a smile, forming a frown, tightening the mouth, protruding the tongue forward, protruding the tongue to the side, protruding the tongue downward, turning the head, and using one or more of the body, head, face, arms, and hands to express emotions such as one or more of anger, anxiety, awe, boredom, calmness, confusion, curiosity, disgust, entrancement, excitement, fear, horror, interest, joy, pain, relief, sadness, satisfaction, sexual desire, and surprise. For example, if the interpreter 210 determines that a given spoken or typed word from the HP 230 is emphasized, the interpreter 210 may emphasize the corresponding sign when it is performed in video by the ASLS 220. As another example, if the interpreter 210 detects a given emotion in the text or audio from the HP 230, the interpreter 210 may modify the sign language video to convey the given emotion, such as by expressing the emotion using one or more of facial expressions, body language, and dynamics of the sign language performance.

The ASLS 220 may receive script from the HP client 232. Additionally or alternatively, the ASLS 220 may receive script from the ASR 216. In some embodiments, the ASLS 220 may convert script to sign language using one or more of the following steps: (1) The ASLS 220 may convert script to gloss. The gloss may include text in a syntax consistent with sign language. The ASLS 220 may use language translation to convert script to gloss. The language translation may use language translation models. The language translation models may be trained using one or more parallel corpora that include one or more bodies of script and of gloss that convey similar meanings. For example, a script-to-gloss language translation model may be built from a body of text containing a given set of information in a written language and a body of text containing substantially the same information in gloss. The written language and gloss may be associated the same root language. For example, written American English and ASL are associated with American English. A gloss-to-script translation model may be similarly trained using parallel corpora, with an example embodiment described herein with reference to the language translation model builder 375 and language translator 370 of FIG. 3. (2) The gloss may be used to index a sign language dictionary and retrieve video clips. The sign language dictionary may include video clips of signs. (3) The retrieved video clips may be concatenated to form a performance of sign language.

In some embodiments, one or more of the display 244, display 264, and display 204 may present text. The text may be displayed in tinted bars across a portion of the display. The tinted bars may scroll or otherwise change over time. The tinted bars may include a background of one color and text of a different color. Each color may be semitransparent. The presentation may be similar to that used by closed captioning for TV and movies. Additionally or alternatively, the text may be shown on a separate display or on a separate portion of the display, such as in a separate frame or window.

In some embodiments, a second call treatment may include using the one or more agents 235 for interpreting between the spoken form and sign language. In these and other embodiments, at least some methods described above with respect to the first call treatment may be used, substituting an agent 235 for the interpreter 210, ASLR 215, and ASLS 220.

In some embodiments, the call treatment may include using an automated interpreter such as interpreter 201 to interpret one side of a conversation. For example, the interpreter 210 may interpret sign language from the DP 225 into a spoken form and an agent 235 may interpret the spoken form from the HP 230 into sign language. Additionally or alternatively, the interpreter 210 may interpret a spoken form from the HP 230 into sign language and an agent 235 may interpret sign language from the DP 225 into the spoken form. Additionally or alternatively, one side of the conversation may be interpreted, and the other side of the conversation may not be interpreted. For example, the sign language to spoken form side of the conversation may be interpreted and the spoken form to sign language side of the conversation may not be interpreted. Additionally or alternatively, the sign language to spoken form side of the conversation may not be interpreted and the spoken form to sign language side of the conversation may be interpreted. This last example may be used for interpreting presentations to an audience.

In some embodiments, call treatment for each side of a conversation may be determined to be substantially the same, e.g., both sides may use an agent 235 or both sides may use the interpreter 210. Additionally or alternatively, call treatment for each side of a conversation may be determined independently. For example, the side of the conversation receiving video from the DP 225 may be processed by the interpreter 210, an agent 235, or may not be interpreted. Similarly, the conversion of speech, text, or speech and text from the HP 230 to sign language may use the interpreter 210, an agent 235, or may not be interpreted. Examples of such asymmetric call treatment may include interpreting for broadcast media such as TV or videos, IVR systems, or interpreting for everts such as church meetings, concerts, conference presentations, news conferences, or other scenarios where the DP 225 may watch the proceedings and is unlikely to contribute to the discussion. In these and other examples, an ASLS 220 may provide interpreting for one side of the conversation without an ASLR 215 or agent 235. Additionally or alternatively, an ASLR 215 may provide interpreting for one side of the conversation without an ASLS 220 or agent 235.

In some embodiments, the display 244 may sign back what the interpreter 210 understands so that the DP 225 can determine whether the interpretation is correct. The DP client 227 may collect a first sign language video from the DP 225. The ASLR 215 may convert the first sign language video to associated text. The ASLS 220 may convert the associated text to a second sign language video. The display 244 may present the second sign language video to the DP 225. The DP 225 may use the DP client 227 to turn the second sign language video on or off.

The DP 225 may judge the second sign language video and determine a rating that reflects accuracy. The DP client 227 may collect the rating from the DP 225. The rating may be used for one or more of generating a report, providing feedback to the agent 235, and providing feedback to the manager of the agent 235. Additionally or alternatively, the ASLR model builder 395 described with respect to FIG. 3, may use the rating to build one or more ASLR models. For example, if the rating indicates that the accuracy is above a selected threshold, the ASLR model builder 395 may use the first sign language video and the associated text to train one or more ASLR models. If the rating indicates that the accuracy is not above a selected threshold, the ASLR model builder 395 may not use the first sign language video and the associated text to train one or more ASLR models.

Additionally or alternatively, the route controller 285 may use the rating as a call variable in making a call treatment decision. For example, if the rating indicates that the accuracy is above a selected threshold, the route controller 285 may connect the call to the interpreter 210 (or, if the call is already connected to the interpreter 210, leave the call connected to the interpreter 210). Additionally or alternatively, if the rating indicates that the accuracy is not above a selected threshold, the route controller 285 may connect the call to an agent 235 (or, if the call is already connected to an agent 235, leave the call connected to the agent 235).

In some embodiments, the DP client 227 may sign back what the agent 235 voices. The DP client 227 may collect a first sign language video from the DP 225. The agent 235 may reverse interpret by voicing what the agent 235 sees in the first sign language video. The agent client 237 may collect audio from the agent 235 and send the audio to the ASR 216. The ASR 216 may convert the audio to text and send the text to the ASLS 220. The ASLS 220 may convert the associated text to a third sign language video. The display 244 may present the third sign language video to the DP 225. Additionally or alternatively, the display 244 may present the text from the ASR 216. The DP 225 may judge one or more of the third sign language video and the text from the ASR 216 and provide a rating. The rating may be used for one or more of generating a report, making a call treatment decision, providing feedback to the agent 235, providing feedback to the manager of the agent 235, and providing input to the ASLR model builder 395 of FIG. 3.

In some embodiments, the ASLR 215 may determine a confidence value indicating how likely the ASLR 215 interpretation is to be correct. If the confidence value is below a selected threshold, the ASLR 215 may instruct the ASLS 220 to ask the DP 225 to repeat what the DP 225 previously signed. Additionally or alternatively, if the confidence value is below a selected threshold, the ASLR 215 may instruct the ASLS 220 to generate a video signing what the ASLR 215 recognized and send the video to the DP 225. The video may include one or more of sign language and text asking the DP 225 to indicate whether the interpretation is correct. The DP may respond by one or more of pushing a button, clicking an icon on the display 244, providing a verbal answer, typing an answer, and providing an answer in sign language. If the DP 225 indicates that the interpretation is correct, the ASLR 215 may send the interpretation to the HP client 232. If the DP 225 indicates that the interpretation is incorrect, the ASLS 220 may generate video asking the DP 225 to repeat what the DP 225 previously signed.

Additionally or alternatively, the ASLR 215 may use text, displayed on the DP client 227, to give the DP 225 a view into the correctness of the interpretation. If the DP 225 indicates that the interpretation is incorrect, the DP client may ask, such as by using one or more of text or sign language video presented on display 244, the DP 225 to repeat.

In some embodiments, in response to the ASLR 215 determining that the confidence value is below a selected threshold, the ASLR 215 may delay sending a spoken form to the HP client 232 until either the DP 225 has indicated the interpretation is correct or until the DP 225 has provided a new video that the ASLR 215 recognizes with confidence above the selected threshold.

In some embodiments, one or more components of FIG. 2 may be used to evaluate the accuracy of the agent 235. The HP client 232 may collect audio from the HP 230 and send the audio to the ASR 216. The ASR 216 may use the audio to generate a first text transcript. The HP client 232 may send audio to the agent client 237. The agent client 237 may play the audio to the agent 235. The agent client 237 may collect video from the agent 235 and send the video to the ASLR 215. The ASLR 215 may convert the video to a second text transcript. The first text transcript may be compared to the second text transcript to determine a disagreement rate. The disagreement rate may be determined using tools such as sclite that determine an error rate, where the first text transcript may be considered the reference and the second text transcript may be considered the hypothesis or vice-versa. The disagreement rate (or an agreement rate, determined as 100% minus the disagreement rate) may be used as an indication of the agent 235 accuracy.

Some methods of sign language communication may include one or more of the following steps:
1. A call treatment may be determined in response to least one of the call type and one or more call variables.
2. If the call treatment indicates use of a human interpreter, an agent 235 may be connected to the call. Additionally or alternatively, if the call treatment indicates use of an automated interpreter, the interpreter 210 may be connected to the call.
3. The microphone 263 may collect a first audio from the HP 230.
4. In response to the first audio, the ASR 216 may generate a first text. Additionally or alternatively, the HP client 232 may collect a first text from the HP 230.
5. One or more of the first audio and first text may be sent to an interpreter (e.g., the agent 235 or interpreter 210, depending on the call treatment determination).
6. In response to one or more of the first audio and first text, the interpreter may generate a first video.
7. The display 244 may present the first video. Additionally or alternatively, the display 244 may present the first text.
8. The camera 242 may collect a second video from the DP 225.
9. The second video may be sent to an interpreter (e.g., the agent 235 or interpreter 210, depending on the call treatment determination).
10. In response to the second video, the interpreter may generate one or more of a second audio and a second text.
11. The speaker 261 may play the second audio. Additionally or alternatively, the display 265 may present the second text.

In some embodiments, some of the above steps may be modified. Additionally or alternatively, some of the above steps may be omitted. Additionally or alternatively, some of the above steps may be implemented in differing order. Additionally or alternatively, one or more steps may be added.

Some methods of sign language communication may include one or more of the following steps:
1. The microphone 263 may collect audio from the HP 230.
2. The ASR 216 may convert the audio to text.
3. The ASR 216 may generate timestamps to mark one or more endpoints of one or more spoken words in the audio.
4. The agent client 237 may use an audio buffer to delay the audio by a baseline delay amount before sending it to the speaker 201. The baseline delay amount may be determined based on the average time it takes for the ASR 216 to return a result. In some embodiments, the baseline delay amount may be substantially equal to the average ASR 216 processing delay plus a selected constant. For example, if the ASR 216 outputs a word an average of one second after the word has been spoken in the audio input to the ASR 216, and a constant time of ½ second is selected to account for variability, the baseline delay amount may be the sum of the average ASR 216 processing delay plus the selected constant, or 1.5 seconds.
5. In some embodiments, if the delayed audio of a word is played by the speaker 201 before the ASR 216 has output the text of the word, the baseline delay amount may be increased. Additionally or alternatively, if the delayed audio of a word is played by the speaker 201 after the ASR 216 has output the text of the word, the baseline delay amount may be decreased. By iteratively increasing or decreasing the baseline delay amount, a baseline delay amount may be determined that is relatively short and sufficiently long that most words may be recognized by the ASR 216 by the time they are played by the speaker 201. In some embodiments, the text from the ASR 216 may be delayed to synchronize the text with the audio. Additionally or alternatively, the text and audio may both be delayed.
6. The agent client 237 may use the ASR 216 timestamps to determine when a word is spoken in the delayed audio played by the speaker 201. The agent client 237 may use one or more timestamps to determine how much to delay the audio or text for a word to be presented on the display 204 at substantially the same time as the word is played in the delayed audio. In some embodiments, the text may be presented on the display 204 substantially at the start of the word. Additionally or alternatively, the text for a given word may be presented on the display 204 substantially at the end of the word. Additionally or alternatively, the text for a given word may be presented on the display 204 at a time determined using one or more endpoints of the word.
7. In response to one or more of the text presented on the display 204 and the delayed audio, the agent 235 may perform sign language. Additionally or alternatively, the agent 235 may use video of the HP 230 to perform sign language. The video of the HP 230 may be enhanced. Enhancing the video may include one or more of locating the face, locating the mouth, cropping the video, and magnifying the video.
8. The camera 202 may collect video from the agent 235 and may send the video to the display 244.
9. The display 244 may show the sign language video to the DP 225.

In some embodiments, some of the above steps may be modified. Additionally or alternatively, some of the above steps may be omitted. Additionally or alternatively, some of the above steps may be implemented in differing order. Additionally or alternatively, one or more steps may be added.

Modifications, additions, or omissions may be made to the environment 200 and/or the components operating in the environment 200 without departing from the scope of the present disclosure. For example, in some embodiments, the environment 200 may include any number of other components that may not be explicitly illustrated or described. Further, depending on certain implementations, the environment 200 may not include one or more of the components illustrated and described. For example, the DP client 227 may not contain the speaker 225 or microphone 243. As another example, the HP client 261 may not contain the camera 262 or display 264. As another example, the operations performed by components operating in the environment 200 such as the interpreter 210, DP client 227, HP client 230, agent client 237, and other components may be distributed among multiple devices and/or systems such as remote servers. As another example, some components shown in FIG. 2 may be combined into fewer components. For example, the ASLR 215 may perform at least some operations of the TTSS 217 and may convert sign language video into an audio signal that may include speech.

As another example, one or more of the components of the environment 200 such as the interpreter 210, DP client 227, HP client 232, call distribution controller 275, route controller 285, and agent client 237 may not communicate via the network 280. In these and other embodiments, the components of the environment 200 may communicate via one or more other networks, via cables or wires, via wireless connections, or via other communication paths. As another example, the environment 200 may not include the network 280. As another example, the environment 200 may not include the route controller 285 or the agent client 237.

As another example, the camera 202 and display 204 may be configured so that the agent 235 is able to look substantially in the direction of the camera 202 and simultaneously see the display 204. For example, the camera 202 and display 204 may be configured as a teleprompter.

As another example, the DP client 227 may include a mobile communication device such as a smartphone, tablet, smart watch, or smart glasses. For example, the DP client 227 may include an application running on a mobile communication device. As another example, the DP client 227 may be communicatively coupled to a mobile communication device such as a smartphone. For example, the DP client 227 may be communicatively coupled to a mobile communication device via a wireless connection such as Bluetooth. The mobile communication device may be communicatively coupled to the network 280. The mobile communication device may provide communication between the DP client 227 and at least some other components described with reference to FIG. 2. The mobile communication device may perform at least some of the operations described with reference to the DP client 227.

As another example, the ASLS 220 may perform at least some operations described with reference to the ASR 216. By including at least some operations of the ASR 216, the ASLS 220 may convert audio to sign language.

FIG. 3 illustrates an example environment 300 for sign language communication. The environment 300 may be arranged in accordance with at least one embodiment described in the present disclosure. The environment 300 may include a video sample 310, ASLR 315, video data storage 390, data manager 391, labeler 392, and ASLR model builder 395. The ASLR 315 may include a DP 311, video buffer 320, video feature extractor 330, feature buffer 325, video feature transformer 340, optic model 350, decoder 360, language translator 370, and TTS synthesizer 380. The ASLR model builder 395 may include a video feature extraction model builder 335, video feature transformation model builder 345, optic model builder 355, language model builder 365, language translation model builder 375, and uploader 302. In some embodiments, the ASLR 315 may be analogous to the ASLR 215 of FIG. 2.

In some embodiments, the ASLR model builder 395 may use data from video data storage 390 to build models. The models may be used by the ASLR 315. Models may include one or more of parameter values, multiplier weights, neural network weights, estimation and classification option settings, data objects, software structures, lists, dictionaries, lexicons, databases, tables, n-gram tables, hashing tables, Boolean values, and numerical values. In these and other descriptions herein, parameters may include hyperparameters. Hyperparameters may include one or more of training rates, a specified number of iterations, a specified number of branches in a decision tree, a neural network topology or recipe, and one or more configuration values such as one or more of numbers of neural net layers and types of neural network layers.

The video feature extraction model builder 335 may use data from the video data storage 390 to build one or more video feature extraction models 337 for the video feature extractor 330. The video feature transformation model builder 345 may use data from the video data storage 390 to build one or more video feature transformation models 347 for the video feature transformer 340. The optic model builder 355 may use data from the video data storage 390 to determine one or more optic model parameters 357 for the optic model 350. The language model builder 365 may use data from the video data storage 390 to build one or more language models 367 for the decoder 360. Additionally or alternatively, the language model builder 365 may build one or more language models 367 and a lexicon 368 for the decoder 360 using data from one or more of the video data storage 390, one or more dictionaries, and other data sources. Additionally or alternatively, the ASLR model builder 395 may build one or more of the video feature extraction model 337, the video feature transformation model 347, the optic model parameters 357, and the language model 367 using data from one or more of the video data storage 390, the video sample 310, one or more dictionaries, and other information sources. The video sample may be associated with the DP 311 and may be obtained from the DP 311 using a DP client such as DP client 227 of FIG. 2.

In some embodiments, the language model builder 365 may use data from one or more of the video sample 310 and video from the video data storage 390 to build a language model 367. The ASLR 315 may transcribe one or more of the video sample 310 and video from the video data storage 390 into one or more text transcripts. The one or more text transcripts may include one or more of text, gloss, and script. The language model builder 365 may use the one or more text transcripts to create a language model 367. For example, the language model builder 365 may train an RNNLM based on the one or more text transcripts. Additionally or alternatively, the language model builder 365 may count the number of occurrences of each of multiple n-grams appearing in the one or more text transcripts. Examples of n-grams may include “the,” “traffic,” and “red” (unigrams, n=1): “to the,” “hi there,” and “call me” (bigrams, n=2): “to the store,” “hi it's David,” and “see you later” (trigrams, n=3): “hi there it's David,” “good to see you,” and “give me a call” (4-grams, n=4), and so on. Each n-gram may be associated with a counter. When model training begins, the counters may be set to zero. Each time a given n-gram is found in the text transcript, the counter for the given n-gram may be incremented. The language model builder 365 may use one or more n-grams and their associated counters to build a language model 367.

The lexicon 368 may include a list of words that may be included in the output of the decoder 360. The decoder 360 may use the lexicon 368 to eliminate non-existent symbols. For example, the decoder 360 may limit its search for a hypothesis to words included in the lexicon 368. The language translation model builder 375 may use data from the video data storage 390 to build one or more language translation models 369 for the language translator 370.

In some embodiments, the lexicon 368 may be created by the ASLR model builder 395. The lexicon 368 may include one or more lexicons. The lexicon 368 may be used across multiple calls. Additionally or alternatively, a first lexicon 368 may be used for a first set of one or more calls and not for a second set of one or more calls. Additionally or alternatively, a second lexicon 368 may be used for a second set of one or more calls. The lexicon 368 may be modified by adding call material. Call material may include information derived from call content. Call material may include one or more of a list of one or more words, a list of one or more phrases, and a text corpus. The list of words may include terms that are associated with one or more calls such as one or more of names of people on the call, terms relevant to the topic of the call, terms relevant to one or more calling parties, and terms relevant to one or more of an occupation, a hobby, an interest, names of friends, names of family members, and names of colleagues of one or more calling parties. The list of words may include one or more of acronyms, product names, brands, company names, terms relevant to business topics, and terms considered to be words that may be used on the call. The text corpus may include one or more of papers, books, abstracts, letters, email, presentations, text extracted from a web site, where the web site may be associated with one or more call participants, marketing, sales, and product material associated with one or more call participants, transcripts (which may be in one or more of script, gloss, and text) of previous calls including one or more call participants for a current call, and other documents determined to be relevant to the call.

The uploader 302 may be a tool for creating one or more of the language model 367 and lexicon 368. Creating one or more of the language model 367 and lexicon 368 may include one or more of building, enhancing, modifying, editing, and uploading one or more of the language model 367 and lexicon 368. The uploader 302 may enable one or more of a person not on the call, one or more calling parties, and an automated system to create one or more of the language model 367 and lexicon 368. For example, one or more of an automated system and a person may use the uploader 302 to upload a list of words to the ASLR 315. As another example the uploader 302 may upload call material to the ASLR 315. Additionally or alternatively, the uploader 302 may upload call material to one or more of the ASLR model builder 395, language model builder 365, and language translation model 375. One or more of the ASLR model builder 395, language model builder 365, and language translation model 375 may use the call material to build, modify, or build and modify one or more models for the ASLR 315. For example, the language model builder 365 may build a first model not using the call material. The language model builder 365 may use the call material to build a second language model. The language model builder 365 may use the first and second language models to build a third language model. The language model builder 365 may use interpolation to build the third language model. The language model builder 365 may send the third language model to the ASLR 315. Additionally or alternatively, the language model builder 365 may send the first and second language models to the ASLR 315. The ASLR 315 may use the first and second language models to convert the video sample 310 to one or more of gloss, script, text, and audio. For example, the ASLR 315 may use the first language model as a static language model. The ASLR 315 may use the second language model as a dynamic language model. As one example, the ASLR 315 may use the first language model for multiple calls and the second language model for one call.

In some situations, a word or phrase may be interpreted multiple ways using a variety of signs or sign combinations. In each context, such as for a given call, there may be a preferred interpretation. Additionally or alternatively, one or more signs may be interpreted multiple ways using a variety of words or phrases, yet in each context, such as for a given call, there may be a preferred interpretation. One or more of the lexicon 368 and call material may include information on how a given set of symbols may be interpreted using the preferred interpretation. For example, the lexicon 368 may include one or more of a video of a person performing the preferred interpretation, a gloss description of the preferred interpretation, a script of the preferred interpretation, a set of instructions for performing the preferred interpretation, the name of a base sign and one or more modifiers used to perform the preferred interpretation, a list of one or more of positions and movements for one or more parts of the body (e.g., which may include hands and arms) for performing the preferred interpretation, a skeleton representation for the preferred interpretation, one or more spoken forms that may be interpreted using the preferred interpretation, and the context surrounding a spoken form that may indicate when the preferred interpretation is to be used. Additionally or alternatively, one or more of the lexicon 368 and call material may include a spoken form of the preferred interpretation and one or more signs or sign sequences that may be converted to the preferred interpretation.

In some embodiments, information on how the preferred interpretation may be performed may be used by the ASLS 220 of FIG. 2 to perform sign language using the preferred interpretation for one or more words in a spoken form. The ASLS 220 may perform sign language in the preferred form. Additionally or alternatively, one or more of the ASLR 315, the optic model 350, the decoder 360, and the language translator 370 may use one or more of the lexicon 368, language model 367, and call material to convert video to one or more of gloss, text, script, and audio.

In some embodiments, the ASLR 315 may determine the signing style used by a signer. The signing style may include one or more of the signer's accent, signing skill level, geographical region, language, dialect, and whether the signer uses one or both hands. The signer's dialect may include one or more of a form of sign language typically used by people born deaf, a form of sign language used to covey literal translation from the corresponding spoken language, a form of sign language used to help children learn the corresponding spoken language, and combinations thereof. For example, in the U.S., signing dialects may include American Sign Language (ASL), Signed Exact English (SEE), Pidgin Signed English (PSE), finger spelling, and Cued Speech. In some embodiments, the ASLR 315 may convert video from the signer using one or more of multiple model sets corresponding to the user's signing style. The ASLR 315 may determine the signing style based on the one or more model sets, such as model sets for one or more of multiple dialects, multiple geographical regions, multiple languages, two-handed signing, and one-handed signing, that yield one or more of the highest confidence score, the best fit to one or more ASLR models, and a combination thereof. Additionally or alternatively, the user may provide his/her signing style such as by entering the information on one or more of the DP 225, a website, and on a call to a person with access to a system that saves the user's signing style.

In some embodiments, the ASLR 315 may adapt to the signer's signing style by modifying ASLR model parameters. For example, the ASLR 315 may use reinforcement learning to modify one or more ASLR model parameters. Model parameters may include parameters included in one or more of the video feature extraction models 337, the video feature transformation model 347, the optic model parameters 357, the language model 367, the lexicon 368, and the language translation model 369.

For example, the ASLR 315 may adapt to a DP's signing style using one or more of the following steps: (a) The ASLR 315 may convert a first video from the DP on a first call to a spoken form. (b) The ASLR 315 may use one or more of the first video and the spoken form to adjust one or more model parameters. The ASLR 315 may adjust one or more model parameters so that an objective function increases. Additionally or alternatively, the ASLR 315 may adjust one or more model parameters so that an objective function decreases. The objective function may be determined using the spoken form as one or more of one or more labels and one or more targets. Adjusting one or more model parameters so that an objective function increases or decreases may include changing one or more of a cost function, loss function, and error signal. The objective function may include one or more of an ASLR confidence score, a matching function (described below), and a fitting statistic (described below). (c) The ASLR 315 may use the one or more adjusted model parameters to convert the first video from a DP 311 to a spoken form. (d) The ASLR 315 may save the one or more adjusted model parameters in a location that is associated with one or more of the identity of the DP 311 and the identity of the DP client (not shown, may be analogous to DP client 227 of FIG. 2). (e) The DP 311 may provide a second video. The second video may be part of a second call. (f) The ASLR 315 may retrieve the one or more adjusted model parameters by referencing one or more of the identity of the DP 311 and the identity of the DP client. (g) The ASLR 315 may use the retrieved one or more adjusted model parameters to convert the second video from the DP 311 to a spoken form. In some embodiments, one or more of the above steps (a)-(g) may be modified, added to, omitted, reordered, combined with other steps, or performed at least partly by one or more other components such as the ASLR model builder 395.

In some embodiments, the DP client may enable the DP 311 to input information regarding the signing style of the DP 311. For example, the information may include one or more of a list of one or more signs, a list of one or more signs with glosses that describe how the signs are performed, and a list of one or more signs with video showing how the signs are performed. The information may include one or more of the DP 311's language, accent, sign language style, preferences, and geographical region. The DP client may provide the information to one or more of the ASLR model builder 395 and the ASLR 315. The information may be used to convert sign language from the DP 311 to a spoken form.

Additionally or alternatively, ASLR 315 may use the signer's signing style to select one or more of the video feature extractor 330, video feature transformer 340, optic model 350, language model 367, and language translation model 370. For example, the ASLR 315 may determine whether the signer is using one or both hands. The determination may use one or more of image analysis, an indication of whether signer is using a device such as a smart phone that is typically held in one hand, and a measure of the screen size of the signer's device. If the ASLR 315 determines that the signer is using one hand, the ASLR 315 may use a first set of one or more models. If the ASLR 315 determines that the signer is using two hands, the ASLR 315 may use a second set of one or more models. Additionally or alternatively, the ASLR 315 may use the signer's signing style to modify one or more of a set of ASLR models. The ASLR models to be modified may include one or more of the video feature extraction model 337, video feature transformation model 347, optic model parameters 357, language model 367, lexicon 368, and language translation model 369. Additionally or alternatively, the ASLR 315 may adapt to the signer's signing style.

One or more of the video sample 310 and the video data storage 390 may include one or more of audio, video, or audio and video of one or more people performing sign language; audio, video, or audio and video of one or more people speaking; audio, video, or audio and video from sign language interpreters; and text transcripts of one or more audios, scripts, and glosses. Data for one or more of the video sample 310 and the video data storage 390 may be collected from video sources such as one or more of YouTube; SignMail (like voicemail, but using video for sign language); interpreter windows in one or more of TV broadcasts, interpreted video games, movies, public events, video sources on the Internet, and books in sign language; websites where volunteers provide sign language video; video calls with one or more calling parties; and interpreted calls between one or more DPs and one or more HPs. In some embodiments, the video may include one or more people performing sign language and wearing one or more wearable sensors such as one or more of gloves, rings, wrist bands, VR goggles, and clothing configured with sensors. The gloves may include sensors such as stress sensors, accelerometers, and sensors that detect the angle of deflection for joints. The sensors may include magnets attached to one or more of the signer's body, clothing, or accessories. The position of the magnets may be determined by magnetic sensors positioned near the signer such as one or more of wire coils, magnets, or Hall effect devices. The gloves may include one or more of reflectors, black, white, or colored dots attached to one or more points in the surface, visible LEDs, ultraviolet LEDs, and fiber optics that illuminate points on the gloves that can be viewed by one or more cameras to determine the position and configuration of the gloves. Input from the sensors may be used by the ASLR model builder 395 to train ASLR models. Use of ultraviolet LEDs or reflectors may enable the ASLR model builder 395 to train on one or more signals from one or more cameras that see ultraviolet and train on one or more videos captured by one or more cameras that do not see ultraviolet. Additionally or alternatively, the gloves may include infrared LEDs or reflectors. Infrared may be used using methods similar to those for ultraviolet such as helping determine the position and shape of the hands without inserting visibly illuminated dots into at least some of the training video.

The data manager 391 may do one or more of modifying, labeling, augmenting, manipulating, organizing, sorting, translating, transcribing, and otherwise processing data in the video data storage 390. The data manager 391 may extract glosses from sign language video. The data manager 391 may generate glosses automatically, for example using ASLR, or using human labelers such as the labeler 392. Text transcripts, scripts, or glosses generated using the human labeler 392 may be used as training transcripts, scripts, or glosses, respectively. The data manager 391 may include a client with a user interface, usable by the labeler 392, that enables the labeler 392 to assist the data manager 391 in processing data in the video data storage 390. For example, with input from the labeler 392, the data manager 391 may do one or more of transcribing audio into text, correcting text transcripts of audio or sign language video, transcribing sign language video into glosses, correcting glosses of sign language video, translating glosses into script, translating scripts into glosses, correcting script corresponding to gloss translations, tagging data as good or bad, tagging data to be used by the ASLR model builder 395 for training, creating, converting, correcting, tagging, and labeling data in video data storage 390, and combinations thereof.

As another example, the data manager 391 may enable a first labeler 392 to watch sign language video on a display and speak into a microphone. The audio may include the first labeler 392 reverse interpreting the video into one or more of gloss, script, and text. The microphone may collect audio from the first labeler 392 and send the audio to a speech recognizer. The speech recognizer may transcribe audio from the first labeler 392 and generate ASR output text. The ASR may be configured to recognize one or more keywords spoken by the labeler 293 to guide the data editing process. At least some of the keywords may indicate one or more of that the video cannot be easily or accurately reverse interpreted and that the first labeler 392 may have made a mistake. The keywords may be used to generate tags indicating one or more segments in the sign language video or in the ASR output text that are to be presented to a second labeler 392 for review.

An ASLR such as ASLR 315 may align the ASR output text with the sign language video. The alignment may be used to temporally link signs in the video to words spoken by the first labeler 392. The data manager 391 may mark the sign language video with one or more of labels indicating which signs are performed and timestamps indicating when in the sign language video the signs are performed. The labels and timestamps may be determined at least partly using one or more of audio from the first labeler 392 and the ASR output text. Additionally or alternatively, the data manager may present one or more of the sign language video, audio from the first labeler 392, labels, ASR output text, and timestamps to a second labeler 392. The second labeler 392 may correct one or more of the labels, ASR output text, and timestamps. The labels and timestamps may be used by the ALR model builder 395 to build ASLR models. In some embodiments, the first labeler 392 and second labeler 392 may be the same person.

In some embodiments, the labeler 392 may use one or more of a keyboard, mouse, touchscreen, touchpad, digital pen, microphone, and other computer inputs to provide, edit, or provide and edit one or more of labels and timestamps. The data manager 391 may be configured for use by a deaf, blind, or hard of hearing labeler 392.

In some embodiments, the output of the decoder 360 may be used to provide machine-generated glosses. The data in video data storage 390 may be synchronized so that various forms of a performance of one or more of the same symbol or sequence of symbols, for example, one or more of a segment of audio, a segment of text, a segment of video, and one or more glosses may be aligned in time with each other. For example, a record or associated set of records in the video data storage 390 may include one or more of video of a signer signing, timestamps and labels associated with the video, a gloss form of what the signer signed, audio of a person voicing what the signer signed, and a text transcript of what the person said, at least two of which may be aligned in time. For example, one or more ASLR 315 models may be trained using the video of a signer signing and a text transcript of what an interpreter said when interpreting the signer.

In another example, a record or associated set of records in the video data storage 390 may include one or more of audio of a person speaking, a text transcript of what the person said, a video of an avatar or human signer signing what the person said, and a gloss form of what the human signer signed. At least two of the records may be aligned in time. Records in the video data storage 390 may include timestamps so that the time of occurrence of symbols and sequences of symbols in various forms (e.g., spoken words, signs, glosses, words in scripts, text, and other language forms) may be identified. For example, timestamps may be included in a text transcript of an audio file where one or more of the start and end time of each word is tagged. For example, a transcript may read “[0.23] I [0.79] got [1.52] lost,” where the numbers indicate the start time in seconds of each word. In another example, timestamps may be included in a sequence of one or more glosses where one or more of the start and end time of each sign is tagged. Data in the video data storage 390 may be stored in a recorded form. Additionally or alternatively, the video data storage 390 may include live data, such as data extracted from a production service. The live data may be used instead of or in addition to the recorded data. Live data may exist for a finite period of time, such as for the duration of a call, used during the finite period of time for training models, and then deleted.

In some embodiments, data that is not allowed to be recorded such as one or more of live data, data where there is not consent to record, and data that cannot legally be recorded, may be stored in volatile memory such as RAM. If a failure such as a hardware failure, software failure, or power failure interrupts the operation of the environment 300, the failure may cause the live data to be deleted. Additionally or alternatively, data that is allowed to be recorded such as data where there is consent to record or data that can be legally recorded may be stored in non-volatile memory such as in one or more of a hard drive, solid state drive, and flash memory.

In some embodiments, the ASLR model builder 395 may use glosses generated by the decoder 360 to train models. In some embodiments, the ASLR model builder 395 may perform, for example, one or more of the following steps:
1. Data may be loaded into the video data storage 390. The data may include one or more of video samples 310, glosses, endpoints, audio, and script.
2. The ASLR model builder 395 may use data from the video data storage 390 to build ASLR models. The ASLR models may include one or more of video feature extraction models 337, video feature transformation models 347 optic model parameters 357, language models 367, lexicons 368, and language translation models 369. Additionally or alternatively, the ASLR model builder 395 may use recorded data. Additionally or alternatively, the ASLR model builder 395 may use both live data and recorded data.
3. The ASLR 315 may interpret one or more video samples 310 into glosses. Additionally or alternatively, the ASLR 315 may interpret one or more video samples 310 into script. The ASLR 315 may determine one or more endpoints of signs in the video samples 310.
4. The ASLR model builder 395 may use the video samples 310, glosses, and endpoints to build first ASLR models. Additionally or alternatively, the ASLR model builder 395 may update existing ASLR models. Additionally or alternatively, the ASLR model builder 395 may use video samples 310, glosses, and endpoints from step #3 above and data from the video data storage 390 to build second ASLR models. The types of ASLR models built by the ASLR model builder 395 may include those listed in step #2 above.
5. The above steps 2-4 may be repeated over multiple iterations and multiple video samples 310 to train ASLR models. The number of iterations may be 1, 2, 3, 4, 5, 10, 20, 50, or 100, for example.

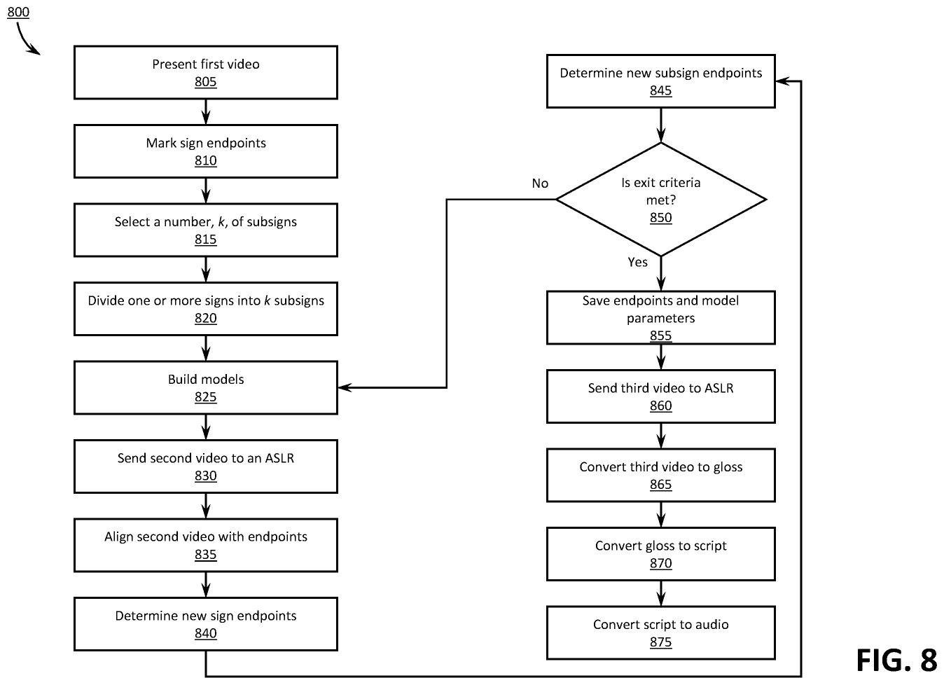

In some embodiments, the endpoints may indicate a least one of where each sign begins and where each sign ends. Additionally or alternatively, the endpoints may indicate starts and ends of subsigns. Additionally or alternatively, the endpoints may indicate starts and ends of model states. In some embodiments, the endpoints may represent the beginning, ending, or the beginning and ending boundaries of one or more of signs, glosses, subsigns, and states such as states in one or more of an optic model, language model, and translation model. The endpoints may be determined using an editor that includes an interface that enables a labeler 392 to watch video and label endpoints by hand. Additionally or alternatively, a labeler 392 or the ASLR 315 may determine endpoints for signs and automated methods may use the sign endpoints to determine one or more of subsign and state endpoints. Further explanation regarding use of an editor that enables a human labeler such as labeler 392 to label endpoints, combined with automated methods to label endpoints, is described with reference to FIG. 8.

Data in the video data storage 390 may be enhanced or expanded by processing existing data to create new data. The new data may be used for model training. For example, audio samples may be transcribed by human or machine or both to create corresponding text samples. Video samples of sign language may be labeled by human or machine or both to create corresponding glosses or text transcripts that correspond to a spoken language. Text may be converted to audio using TTS. The volume and variety of data may be increased through use of data augmentation, where one or more of existing audio, video, or text may modified to create additional audio, video, or text data, respectively. The additional data may be denoted as synthetic data. Data may be augmented using one or more of multiple methods. For example, audio data may be distorted, shifted in frequency, sped up or slowed down, filtered, or combinations thereof. Video data may be distorted, resampled to create images of varying sizes, rotated, sped up or slowed down, cropped, trimmed by removing frames at the start, end, or inside a clip, or combinations thereof. Video data may be altered by projecting the likeness of a second person onto the video of a first person. Video data may be altered by reducing the video of a first person to set of locations of body parts (such as a skeleton view), then projecting the likeness of one or more people (real people or synthetic, such as deep fakes) onto the set of locations. Video data may be processed to vary sharpness, color, saturation, contrast, brightness, gamma correction, resolution, or combinations thereof. Text data may be supplemented using text sources such as one or more of text corpora, books, news articles, encyclopedias, email, transcribed audio, and data scraped from the Internet. Synthetic video data may be created, for example, by sending text to the ASLS 220 of FIG. 2 and using the output of the ASLS 220 as synthetic video. One or more of additional script, gloss, and audio data may be synthesized, for example, by sending video to the ASLR 315 and using the output of the ASLR 315 as script, gloss, and audio, respectively. The ASLR model builder 395 may generate models using data created through data augmentation methods such as those described herein.

A video sample 310 may include video of sign language and may include a sequence of images. The video may be sent to the video buffer 320. In some embodiments, the video buffer 320 may store one or more video frames and provide one or more stored frames to a video feature extractor 330.

The video feature extractor 330 may extract features for one or more video frames. One of the video frames may be designated as a current frame. The video feature extractor 330 may determine a set of one or more features corresponding to the current frame using one or more of the frames provided by the video buffer 320. The stored frames provided to the video feature extractor 330 by the video buffer 320 may include one or more of zero or more frames previous to the current frame, the current frame, and zero or more frames subsequent to the current frame. The features may include information about the signer's performance. The features may include one or more of hand shape, hand orientation, hand position, hand motion, body position, body motion, facial expression, mouth shape, and other aspects of the signer's body position and motion. Additionally or alternatively, the features may be parameters determined using operations on one or more images. For example, video features may include one or more of a discrete cosine transform, a discrete sine transform, an FFT, a wavelet transform, an embedding, an autoencoder, a neural network, an edge detection method, a vector quantization encoder, a bottleneck neural network, a discrete wavelet transform, and an MFCC transform.

In some embodiments, the video sample 310 may include audio. The video features may include features extracted from the audio signal accompanying the video sample 310. The ASLR 315 may use features extracted from the audio signal to detect sounds produced by the signer such as one or more of puffing, blowing, clapping, slapping, speech, vocal utterances, striking the signer's body, striking objects such as a table, stomping feet, inhaling, and manipulation of objects. In some embodiments, acoustic features may be combined with video features as input to the optic model 350.

Additionally or alternatively, the video feature extractor 330 may include scene analysis, where an image is analyzed to determine the identity of elements in the image. The scene analysis may determine one or more of the position, size, orientation, motion, and configuration (e.g., shape, angle of joints) of one or more elements in the image. The scene analysis may determine one or more of the position, orientation, and motion of one or more elements with respect to other elements. For example, the scene analysis may determine that the hands are moving away from each other or that the right middle finger is touching the chin. The results from the scene analysis may be expressed in one or more of written language expressions such as “arms are folded” or “the head is bowed;” mathematical terms such as one or more of two-dimensional coordinates, three-dimensional coordinates, embeddings, acceleration values, angles, rotational speed, direction, speed, and velocity vectors; and data structures such as JSON objects, XML-formatted text, lists, vectors, tensors, and name-value pairs. The output of the video feature extractor 330 may include the results from the scene analysis.

The feature buffer 325 may save a set of features for a set of one or more frames. The feature buffer 325 may provide features for one or more frames to the optic model 350.

In some embodiments the video buffer 320 may store one or more frames of video. In some embodiments the video buffer 320 may convert video into an intermediate form and store the intermediate form. The intermediate form may be used by the video feature extractor 330 to determine features. For example, the video feature extractor 330 may extract a spectral representation such as a discrete cosine transform (DCT) from one or more images from the video buffer 320. The video buffer 320 may store the spectral representation and send the spectral representation to the video feature extractor 330. The video feature extractor 330 may extract features from the intermediate form (such as a spectral representation).

As another example of feature extraction, the video feature extractor 330 may compare at least part of one or more input video frames from the video sample 310 to one or more entries in library. The video feature extractor 330 may determine a score for each input video frame and library entry comparison. Each score may represent how closely the input video frame matches the library entry. The entries may include images or parts of images. The comparison may include one or more of determining an average absolute difference, determining a total absolute difference, determining a cross-correlation value, determining a correlation coefficient, determining an average difference squared, determining a total difference squared, shifting one or both of the images being compared to align features in the images, presenting both images or parts of images to a neural network where the neural network output indicates a degree of match, and adjusting one or both images using one or more of contrast adjustment, brightness adjustment, color correction, edge detection, noise reduction, cropping, background suppression, and gamma correction. Additionally or alternatively, at least part of the input video frame may be compared to each library entry using multiple comparison methods, each generating a score. The score for each comparison may be used as a feature. The features may be input to one or more of the video feature extractor 330, the video feature transformer 340, and the optic model 350. The optic model 350 may include a neural network where one or more neural network inputs are each fed by a score for each comparison.

The video feature extractor 330 may use one or more images as input to determine one or more features. The one or more images may be in sequence. In some embodiments, the video feature extractor 330 may determine a set of features from each frame individually. The video feature extractor 330 may combine features from one or more frames into a feature vector. In some embodiments the output of the video feature extractor 330 may be sent to one or more of the video feature transformer 340 and the optic model 350. Additionally or alternatively, the video feature extractor 330 may send features to a feature buffer 325. The feature buffer 325 may save features for a number of buffered frames and send features for the buffered frames to one or more of the video feature transformer 340 and the optic model 350. The number of buffered frames may be 1, 2, 3, 4, 5, or a number greater than five. For example, if a given frame is frame n and the number of buffered frames is 3, then a set of features for the given frame may include features from frame n, frame n−1 (which may be the previous frame), and frame n−2. In this example, the feature buffer 325 may send features from frame n, frame n−1, and frame n−2 to one or more of the video feature transformer 340 and the optic model 350.

In some embodiments, processing such as frame buffering, feature buffering, feature extraction, and modeling may introduce delay. For example, the ASLR 315 may determine symbols such as signs or glosses corresponding to a given frame based on information from video that occurs after the given frame and, as a result, there may be a time delay before the symbols are determined. In some embodiments, the video sample 310 may include a video signal and an audio signal. The ASLR 315 may convert the video signal to a spoken form. The spoken form and the audio signal may be presented to an HP. There may be a time delay between the time the video signal is sent to the ASLR 315 and the spoken form is presented to the HP. To compensate for ASLR 315 processing delay, the audio signal may be delayed so that the spoken form and audio signal may be presented to the HP at substantially the same time. The audio signal may be delayed by an amount of time substantially equal to the time from the point where the video signal is sent to the ASLR 315 and the point where the spoken form is presented to the HP.

In some embodiments, the video feature extractor 330 may provide features for one frame to the optic model 350 and the optic model 350 may have internal memory elements that remember features, or information derived from the features, across multiple frames. For example, an optic model may include a neural network. The neural network may include memory using one or more of RNNs, LSTMs, GRUs, delays, transformers, stochastic transformers, and attention-based transformers.

The video feature extraction methods described herein are exemplary. Other feature extraction methods, including edge detection, wavelets, deep neural networks, bottleneck encoders, and autoencoders, may be used. A feature set may be derived from entities such as images of hands, arms, and other objects, clipped out of images. A function such as an autocorrelation function or sum-of-squared differences function may search a video frame to determine whether a portion of the video frame matches an entity, the location of the portion of the video frame, and how closely the portion of the video frame matches the feature set. A feature set may include a location and degree of match for each clipped image. Additionally or alternatively, the video feature extractor 330 may provide video samples directly as features. For example, the video feature extractor 330 may pass video through to the video feature extractor 330 output substantially unaltered. As another example, determining features from the video samples may include providing the video samples as features.

The video feature extractor 330 may send features to the video feature transformer 340. The features may be sent directly, via a feature buffer 325, or a combination thereof. The video feature transformer 340 may convert an input feature set from the video feature extractor 330 to an output feature set with one or more of fewer features and improved properties. Examples of improved properties include making the output features more orthogonal, making the output features more resistant to noise and distortion, making the output features less dependent on characteristics of the person signing, and transforming features into a form that gives the ASLR 215 a relatively lower error rate.

In some of embodiments, one or more of the video feature extractor 330 and the video feature transformer 340 may clean the image. The image cleaning may occur prior to feature extraction. Additionally or alternatively, the video feature extractor 330 may perform image cleaning as part of feature extraction. Additionally or alternatively, image cleaning may happen after feature extraction and before feature transformation. Additionally or alternatively, the video feature transformer 340 may perform image cleaning as part of feature transformation. Additionally or alternatively, the image cleaning may happen after feature transformation. Image cleaning may include one or more of noise reduction, despeckling, lighting correction, brightness adjustment, contrast adjustment, sharpness adjustment, color balancing, gamma correction, cropping, median filtering, histogram equalization, deblurring, mask filtering, resampling, stretching or compressing along one dimension, processing with a neural network, image enhancement, and super resolution enhancement, among other image cleaning processes.

An example embodiment of a video feature transformer 340 may include a function that multiples an input feature vector x by a matrix A to yield an output feature vector y=Ax. In this example, x may include m elements, y may include n elements, and A may be a n×m matrix. In some embodiments, n may be less than m so that the video feature transformer 340 may compress m input features into a smaller number n of output features. The video feature transformer 340 may convert the input feature to an embedding. The video feature transformation model builder 345 may determine one or more values of elements in matrix A using data from the video data storage 390. The video feature transformation model builder 345 may use iterative methods such as one or more of gradient descent, an expectation-maximization (EM) algorithm, back propagation, neural network pretraining, among other iterative methods. Other examples of the video feature transformer 340 may include one or more of neural networks, Gaussian mixture models (GMM), maximum likelihood linear regression (MLLR), constrained MLLR (CMLLR), and feature-space MLLR (fMLLR). The video feature transformer 340 may include linear, nonlinear, or linear and nonlinear transformations. The video feature transformation model builder 345 may include parameters adapted to minimize the ASLR 315 error rate.

In some embodiments, the video feature transformation model builder 345 may determine one or more video feature transformation models 347. Each video feature transformation model 347 may be used for a specified situation. For example, a first video feature transformation model 347 may be used for a first set of one or more signers. A second video feature transformation model 347 may be used for a second set of one or more signers. In this manner, the video feature transformer 340 may be adapted to one or more of individual signers or groups of signers.

In some embodiments, the video feature transformation model 347 may include a matrix. The video feature transformer 340 may multiply an input feature vector by the matrix. The matrix may include part of a neural network such as a weighted set of connections between layers. A first matrix may be used for a first set of one or more signers. A second matrix may be used for a second set of one or more signers. Each video feature transformation model 347 may be configured to maximize ASLR accuracy for one or more signers. Multiple video feature transformation models 347 may be determined. A signer may be identified by one or more of a username, login, faceprint, signing style, account number, and device ID such as an email address or telephone number. The signer's identity may be used to index one or more of a database, list, file, directory structure, table or another arrangement of video feature transformation models 347 to select a video feature transformation model 347. The video feature transformer 340 may use the selected video feature transformation model 347. For example, the video feature transformer 340 may use the selected video feature transformation model 347 to transform the output of the video feature extractor 330 to a set of transformed features. The video feature transformer 340 may provide the transformed features as input to the optic model 350.

In some embodiments, the ASLR 315 may adapt to a first set of one or more signers by detecting and remembering made-up signs. The ASLR 315 may determine that a sign performed during a first call is made up by determining that the DP 225 signs a key phrase. The key phrase may be one or more signs that indicate that a sign is made up. Examples of key phrases may include signs for one or more of “my name,” a person's name, “name sign,” a proper noun, and a series of letters. The key phrase may suggest that the next sign may be a made-up sign. Additionally or alternatively, the ASLR 315 may determine that a given sign performed during a first call is made up by determining that the ASLR 315 does not recognize the given sign. Additionally or alternatively, the ASLR 315 may determine that a given sign performed during a first call is made up by determining that the given sign is followed by a spelled word. Additionally or alternatively, the ASLR 315 may determine that a given sign performed during a first call is made up by determining that the ASLR 315 does not recognize the given sign or that the given sign is preceded by a key phrase.

If the ASLR 315 determines that an unrecognized sign is a made-up sign, it may determine that a spelled word preceding or following the unrecognized sign is associated with the made-up sign. The ASLR 315 may subsequently substitute the spelled word for its associated made-up sign if the made-up sign is performed again by one or more of the first signers or other signers on the first call. For example, if the signer spells a word, then performs an unrecognized sign, the ASLR 315 may associated the unrecognized sign with the spelled word. If the ASLR 315 subsequently determines that the unrecognized sign is performed again, the ASLR 315 may interpret the unrecognized sign as the spelled word and may send the spelled word to one or more of the language translator 370, TTS synthesizer 380, or HP. Additionally or alternatively, the ASLR 315 may similarly associate a sequence of two or more spelled words with an unrecognized sign.

Additionally or alternatively, the ASLR 315 may adapt to a first set of one or more signers by modifying one or more parameters such as model parameters used by the ASLR 315. When the first call ends, the ASLR 315 may save one or more of the made-up signs and modified parameters. When a second call begins with one or more of the first set of one or more signers and signers from the first call, the ASLR 315 may retrieve one or more of the made-up signs and modified parameters and use one or more of the made-up signs and modified parameters to interpret video from one or more of the signers on the second call.

In some embodiments, the ASLR 315 may adapt to a signing style used on the first call. For example, the ASLR 315 may use a first language model to interpret the first call. For example, one or more of an ASR such as ASR 216 of FIG. 2 and ASLR 315 may use content from the first call to build a language model. Call content may include one or more of text, gloss, and script generated in response to information from the first call. For example, the ASLR 315 may count n-grams from the call content. The n-gram counters may be used to build an n-gram-based language model. Additionally or alternatively, the ASLR 315 may use call content from the first call to train a neural network-based language model such as an RNNLM. Additionally or alternatively, the ASLR 315 may build a second language model. The second language model may include one or more of the first language model, the n-gram-based language model, the neural network-based language model, and one or more other language models. For example, the second language model may be generated by interpolating one or more of the first language model, the n-gram-based second language model, the neural network-based language model, and one or more other language models. In some embodiments, the ASLR 315 may use the second language model to interpret sign language for the second call. The ASLR 315 may save the second language model. Additionally or alternatively, ASLR 315 may use the second language model to interpret sign language for a third call. In some embodiments, if a third call includes one or more callers from the first call, the ASLR 315 may retrieve the second language model and use the second language model to interpret sign language for the third call.

In some embodiments, the ASLR 315 may adapt to a signing style used on the first call by resolving ambiguities where a sign may have multiple interpretations. For example, if a given sign can be interpreted more than one way, the ASLR 315 may use call content to select an interpretation. For example, the ASLR 315 may determine the topic of conversation. Based on the topic of conversation, the ASLR 315 may select which interpretation to use for the given sign. For example, if a sign that may be interpreted as “brown” or “beer” is performed and the ASLR 315 determines that the topic is drinking, beverages, or the restaurant business, the ASLR 315 may select “beer” as the interpretation.

As another example of using call content to resolve ambiguities, a signer on a first call may spell a word and perform a first sign that has multiple interpretations. If one or more of the multiple interpretations of the first sign includes the spelled word, the ASLR 315 may use the spelled word to interpret the first sign. The ASLR 315 may associate the spelled word with the first sign and remember the association when interpreting future performances of the first sign. For example, if the first sign is performed a second time on one or more of the first call and a second call with one or more participants from the first call, the ASLR 315 may remember the association and use the spelled word to interpret the first sign. In the above description, model training and adaptation may be described as occurring in the ASLR 315; however, in these and other embodiments, model training and adaptation may occur in one or more of an ASR, ASLR, ASLR model builder, DP client, HP client, smartphone, wearable device, server, and other systems and components.

In some embodiments the video feature extractor 330 may convert one or more video frames into a first spectral signal. For example, the video feature extractor 330 may extract a first spectral signal from a video sample 310 using a spectral transform such as a discrete Fourier transform (DFT), fast Fourier transform (FFT), or DCT. The spectral transform may be two-dimensional when extracting features from an image frame. The spectral transform may be three-dimensional when extracting features from multiple image frames.

In some embodiments, the video feature transformer 340 may transform the first spectral signal to a second spectral signal. The video feature transformer 340 may sample the second spectral signal to generate a third spectral signal. For example, the video feature transformer 340 may convert the first spectral signal to a magnitude spectrum. The video feature transformer 340 may sample the magnitude spectrum to retain a subset of the magnitude spectrum signal. For example, samples above a predetermined frequency may be discarded. As another example, the video feature transformer 340 may convert one or more video frames to a spectral signal with a Fourier transform, then to a magnitude spectrum, then to a log magnitude spectrum, then to an inverse Fourier transform of the log magnitude spectrum. The video feature transformer 340 may sample the inverse Fourier transform of the log magnitude spectrum, for example by retaining the first m coefficients, where m is an integer smaller than the number of samples in the magnitude spectrum. One or more of the first, second, or third signal may be used as features for the video frame and as output of the video feature transformer 340.

In some embodiments, the video feature extractor 330 may convert an image into a skeletal representation. The skeletal representation may include a set of one or more lines or points representing one or more of the positions and orientations of one or more bones in the signer's body. Additionally or alternatively, the skeletal representation may include a set of one or more lines representing the positions and orientations of segments of the signer's body. One or more segments may each be represented by a line. Additionally or alternatively, the skeletal representation may include a set of one or more points representing the positions of points, such as joints, on the signer's body. Since the location and orientation of a rigid body part may be approximated by the location of each end of the rigid body part, the set of points may be considered to be substantially equivalent to a set of positions and orientations.

The skeletal representation may include a set of vectors. Each vector may represent a segment of the signer's body. Segments of the signer's body may include one or more bones on one or more fingers and thumbs and may be connected at one or more of the knuckles, the signer's hands between the wrist and fingers, the forearms from the wrists to the elbows, the upper arms between elbows and shoulders, a segment from the left shoulder to the right shoulder, a segment from the base of the neck to the left shoulder, a segment from the base of the neck to the right shoulder, the neck, the head, a segment from the right hip to the left hip, the top part of each leg from the hip to the knee, the bottom part of each leg from the knee to the ankle, and the feet. In some embodiments, the neck and head may be represented by one segment.

Each hand, excluding the fingers, may be represented by a single skeletal segment. Additionally or alternatively, each hand may be represented by one or more skeletal segments, each extending from the wrist to the base of a finger. Segments of the signer's torso may include a segment representing the torso from the hips to the base of the neck. Additionally or alternatively, segments of the signer's torso may include two segments, one from the left hip to the base of the neck and one from the right hip to the base of the neck. Additionally or alternatively, segments of the signer's torso may include a segment running from the base of the neck to a point approximately equidistant between the hips and segments from the point approximately equidistant between the hips to each hip.

In some embodiments, the skeleton may include segments representing both hands and arms. Additionally or alternatively, the skeleton may include segments representing one hand and one arm. Arrangements in addition to those described herein for dividing the human body into segments may be used without departing from the scope of the present disclosure.

The location and orientation of each segment may be represented by a vector. Each vector may include a position, length, rotation, and orientation. The position may include a coordinate indicating a position in three-dimensional space. The orientation may include a direction in three-dimensional space. The rotation may include an angle. Additionally or alternatively, each vector may include a set of coordinates at each end of a rigid segment of the signer's body. In some embodiments, coordinates may specify a point in three-dimensional space. Additionally or alternatively, coordinates may specify a point in the two-dimensional image.

The video feature extractor 330 may send the skeletal representation to the optic model 350. Additionally or alternatively, the video feature extractor 330 may send the skeletal representation to the video feature transformer 340. The video feature transformer 340 may convert the skeletal representation to a transformed representation. For example, the video feature transformer 340 may use a neural network to convert the skeletal representation to an embedding. As another example, the video feature transformer 340 may convert location and orientation information for a segment into a substantially equivalent mathematical form. For example, the video feature transformer 340 may convert a vector defining the position, length, rotation, and orientation of a rigid skeletal segment to a vector defining the position of each end of the rigid segment and a rotation value. Additionally or alternatively, the video feature transformer 340 may convert a vector defining the position of each end of a rigid skeletal segment and a rotation value to a vector defining the position, length, rotation, and orientation of the rigid skeletal segment.

In some embodiments, the video feature transformer 340 may convert a sequence of skeletal representations, corresponding to a sequence of images, into a transformed representation of the sequence of skeletal representations. For example, the video feature transformer 340 may convert a sequence of locations for a segment into a form that includes the starting location and ending location for the segment. As another example, a sequence of locations for a segment may be converted to a form that includes the starting location and ending location and the shape of a path of one or more points (such as two ends of a segment) on the segment during a sequence of multiple images. For example, a sequence of locations for a segment may be converted to a motion vector that includes the coordinates of each end of the segment in the first image and in the last image and the direction and radius of curvature for an approximate path taken by each end of the segment. The path may be a best-fit path. Other path shapes such as linear, hyperbolic, parabolic, trigonometric, transcendental, and exponential curves, splines, arcs, and other linear and nonlinear functions may be used as approximate paths. The motion vector may provide a representation of one or more of the location, orientation, rotation, and movement of the segment. The motion vector may include a smaller number of values, compared to number of values used to specify one or more of the locations, orientations, rotations, and movement of both ends of the segment in the sequence of multiple images.

In some embodiments, the video feature extractor 330 may convert the video image to an intermediate form. The intermediate form may be a first of two or more transformations performed by one or more of the video feature extractor 330 and the video feature transformer 340. For example, the video feature extractor 330 may use line detection or edge detection to convert the image to a set of lines or edges. As another example, the video feature extractor 330 may use one or more of a spectral transform, matrix multiply, matrix decomposition, matrix factorization, neural network, and principal components decomposition to convert the image to an intermediate form. The intermediate form may be represented by a vector or matrix. The intermediate form may be affected relatively less by factors unrelated to the content of the sign, compared to factors related to the content of the sign. Unrelated factors may include one or more of lighting, clothing, noise, image quality, identity of the signer, and camera angle. The video feature extractor 330 may send the intermediate form to the video feature transformer 340. The video feature transformer 340 may convert the intermediate form to a secondary form and send the secondary form to the optic model 350. The secondary form may include a skeletal representation. One or more of the video feature extractor 330 and the video feature transformer 340 may create a final feature set. The final feature set may include the secondary form. In some embodiments, the final feature set may be represented by the symbol θ.

Additional methods for one or more of extracting features from video and transforming features may be used without departing from the scope of the present disclosure.

The final feature set may be sent to one or more of the optic model 350 and decoder 360. One or more of the optic model 350 and the decoder 360 may convert the final feature set into a sequence of glosses. The optic model 350 may fit the final feature set to one or more models of multiple glosses. The optic model 350 may determine how well the final feature set matches each of one or more of the glosses. In determining how well a final feature set matches a gloss, the optic model 350 may take into account physical properties of the human body such mass, volume, weight, muscle strength, maximum acceleration, and range and direction of motion for joints. For example, in modeling a body part such as a hand moving through the air, the optic model builder 355 and optic model 350 may use limits or statistics of how fast the body part is likely to accelerate and move. The optic model builder 355 may constrain optic model parameters 357 to model movements that are possible or likely taking into account human physical limitations such as strength and how joints are and are not able to bend and twist. The optic model builder 355 may constrain optic model parameters 357 to not model at least some movements that are not possible or are unlikely, given typical forces, geometry, construction, and limitations.

The optic model builder 355 may build optic model parameters 357 that are derived, at least in part, from typical dimensions of the human body. The optic model 350 may adapt to one or more particular signers. For example, the ASLR 315 may determine one or more of strength, speed, acceleration, dimensions, appearance, signing style, skill level, and other characters of a signer. The optic model 350 may adapt to one or more of the optic model parameters 357 and video features to model one or more of greater or lesser strength, speed, acceleration, dimensions, and skill level for a particular one or more signers. As another example, the optic model 350 may adapt to signers who are determined to be relatively taller, shorter, heavier, darker, lighter, faster, stronger, or weaker, or who have different signing styles, compared to typical signers.

The decoder 360 may use a language model, such as the language model 367, to convert the output of the optic model 350 to a sequence of glosses. The use of a language model by the decoder 360 may be analogous to how ASR decoders use language models in recognizing speech.

In some embodiments, one or more components of FIG. 3, including the video buffer 320, video feature extractor 330, feature buffer 325, video feature transformer 340, optic model 350, and decoder 360 may be omitted. In these and other embodiments, when one or more components are omitted, signals such as images, features, probabilities, symbols, and text may skip to the next non-omitted component. For example, video signals may skip one or more of the video buffer 320, video feature extractor 330, feature buffer 325, and video feature transformer 340, and be applied to the optic model 350. In another example, the video sample 310 may be applied directly to the decoder 360. In some embodiments, the video sample 310 may be input to an “end-to-end” deep neural network, where at least a substantial portion of the ASLR process is performed with one or more neural networks. The one or more neural networks may output a sequence of symbols such as one or more of glosses, scripts, a spoken form, and an audio signal.

The optic model 350 may model one or more visual components of sign language. The optic model 350 may contain information describing what sign language looks like. The optic model 350 may include parameters such as one or more of arrays, matrices, neural network weights, hyperparameters, and hidden Markov model (HMM) parameters, among other parameters. The optic model parameters 357 and other parameters included in the optic model 350 may be determined by the optic model builder 355 and sent to the optic model 350.

In some embodiments, the optic model 350 may evaluate one or more matching functions in response to values input to the optic model 350. A matching function may include one or more matching functions. The matching function may include a function of one or more inputs to the optic model 350. The output of the optic model 350 may include one or more values determined for the matching function. The matching function may indicate how closely one or more inputs to the optic model 350 correspond to a given symbol. The matching function may include a probability density function. The matching function may include a statistic such one or more of probability, joint probability, conditional probability, likelihood, joint likelihood, conditional likelihood, log probability, log likelihood, likelihood ratio, log likelihood ratio, cross entropy, entropy, softmax activation functions, functions of statistics such as log-likelihood and negative log-likelihood, distance, Manhattan distance, Euclidian distance, cosine distance, and combinations thereof, among other statistics. The matching function may include one or more statistical modeling methods such as one or more of HMMs, multivariate mixture distributions, Gaussian mixture distributions, discriminative training, neural networks, and deep neural networks, among other statistical modeling methods. The matching function may be a scalar. Additionally or alternatively, the matching function may be a vector. Other statistics and functions may be used by the optic model 350 without departing from the scope of the present disclosure. The optic model 350 may output values corresponding to one or more matching functions corresponding to each of a number of symbols in each of one or more contexts, given the input features.

In some embodiments, one or more of a set of one or more features, one or more matching functions, and one or more symbols may include values internal to one or more neural networks. For example, a first set of one or more parts of a neural network may perform at least some of the operations of the video feature extractor 330. Additionally or alternatively, a second set of one or more parts of the neural network may perform at least some of the operations of the optic model 350. Additionally or alternatively, a third set of one or more parts of the neural network may perform at least some of the operations of the decoder 360. Additionally or alternatively, a fourth set of one or more parts of the neural network may perform at least some of the operations of the language translator 370. Additionally or alternatively, operations performed by the neural network may be distributed among multiple neural networks. For example, one or more of the first, second, third, and fourth sets of one or more parts of the neural network may be distributed among multiple neural networks.

A scalar matching function may be emitted by an output of the optic model 350. Additionally or alternatively, a matching function vector may be emitted using one or more outputs of the optic model 350. For example, if a matching function vector has n elements, the optic model 350 may include n outputs, one for each element. Additionally or alternatively, the optic model 350 may output a multiplicity of matching functions, where each function may be a scalar or a vector.

The input to the optic model 350 may include one or more of images, features, transformed features, and final features derived from one or more images from the video sample 310. The optic model 350 input may receive as input one or more of the video sample 310 and information derived from the video sample 310 such as features extracted from a video sample 310. One or more optic model 350 outputs may provide one or more indications of which signs are being performed. The optic model 350 output may correspond to one or more matching functions of one or more of signs, glosses, words, subsigns, and states. Additionally or alternatively, the optic model 350 may do the reverse, i.e., the optic model 350 may determine a matching function of a video sequence or set of features extracted from a video and sent to the optic model 350, given a hypothesized symbol such as one or more of a sign, gloss, word, subsign, and state.

The optic model 350 may determine one or more functions of its inputs, each function corresponding to one or more outputs. For example, the optic model 350 input may include the values of one or more features and the optic model 350 output may include a matching function, such as one or more of a probability, distance, and likelihood, for each of one or more symbols or states, given the input values. In some embodiments, the input may be a set of features for one or more frames. The one or more matching functions may give an indication of whether the optic model 350 input corresponds to a given symbol. The given symbol may represent one or more of a sign, gloss, subsign, word, and state. For example, the optic model 350 may include a model for m symbols. The optic model 350 may include m outputs, where each output may be associated with a different symbol. Each of the m outputs may indicate the probability (or one or more other matching functions) that the optic model 350 input corresponds to the symbol associated with the output.

The one or more matching functions may be context-dependent, meaning that the one or more matching functions may respond to the current symbol being performed at a given time, such as in a given frame or sequence of frames, and to the symbols before, after, or before and after the current symbol. For example, suppose models for symbols A, B, and C are included in the optic model 350. The probability P(B|A, C, θ) may be the probability that sign B is being signed, given that the previous symbol was A and the next symbol is C and given one or more features θ are provided as input to the optic model 350. In some embodiments, probabilities may take the form of P(sign|context, θ) or the probability of a sign given the context and input features. Additionally or alternatively, the matching function may be in the form of a joint statistic such as P(sign, context, θ) or joint probability of a sign, context and input features. The optic model 350 output may be provided to the decoder 360.

A person performing sign language may vary how a given sign is performed depending on the context, i.e., one or more signs before, after, or before and after the given sign. The optic model 350 may be configured to take into account variation of how a given sign is performed in various contexts by determining a matching function for the given sign in each of multiple contexts. For example, the optic model 350 may determine a first matching function for a given sign in a first context and a second matching function for the given sign in a second context. The first context may include a first set of one or more signs previous to the given sign. Additionally or alternatively, the second context may include a second set of one or more signs previous to the given sign. In some embodiments, the first matching function and second matching function may be the same function. A matching function may provide different values for different contexts. For example, the optic model 350 may use a matching function to associate a first set of inputs with a given sign in a first context and a second set of inputs with the given sign in a second context. A set of inputs may include one or more inputs. The optic model 350 may determine additional matching functions for additional contexts, e.g., a third, fourth, fifth, and so on. For example, the optic model 350 may use a first matching function for the sign “like” in the phrase “I like bananas” and a second matching function for the sign “like” in the phrase “old men like old cars.”

As another example, the optic model 350 may output an encoded matching function. For example, the optic model 350 may include models for m symbols and may include n outputs. To generate an encoded matching function, the optic model 350 may use a transformation such as one or more of principal components analysis, a neural network, a discriminant function, a matrix multiply, a matrix decomposition, and an embedding. The transformation may map m symbols to n outputs. In some embodiments, n may be less than m. Additionally or alternatively, n may be greater than m. Additionally or alternatively, n may be equal to m.

In the description herein, where the optic model 350 may be described with reference to a matching function associated with a sign, an analogous description may apply to a portion of a sign. For example, a sign that spans multiple frames may include multiple portions of a sign. The optic model 350 may output a matching function for a portion of a sign. The portion of a sign may include one or more of a gloss, sign, subsign, action, gesture, state, one or more images, and one or more frames. For example, the ASL sign for “father” may include splaying the fingers of one hand and touching the thumb to the forehead. The optic model 350 may output a first matching function for (a) a motion where the hand is raised toward the forehead, a second matching function for (b) the point where the thumb first touches the forehead, and a third matching function for (c) the interval where the hand is substantially motionless, the thumb touching the forehead. In the present disclosure, where a matching function associated with a sign is described, the description may additionally or alternatively apply where a matching function is associated with a portion of a sign.

A few examples below, denoted as scenarios, may serve to illustrate some embodiments of the optic model 350. Other embodiments are possible without departing from the scope of the present disclosure.

In a first scenario, the optic model 350 may output one or more matching functions for a target sign. A target sign may refer to the sign corresponding to a matching function of the optic model 350. A target sign may correspond to the sign or portion of a sign being performed in the current frame. The optic model 350 may include an output for a target sign such as “father” in each of multiple contexts. The contexts may include one or more of pauses, signs, subsigns, parts of signs, glosses, states, frames, and other gestures occurring before, after, or before and after the target sign. There may be an optic model 350 output for the target sign (such as “father”) for each of multiple contexts such as “my father left,” “your father tall,” and “Gary's father blind.”

Configuring the optic model 350 with multiple contexts for multiple signs may result in a relatively large number of outputs. One or more of several methods may be used to reduce the number of outputs.

One method to reduce the number of optic model 350 outputs may be to configure an optic model 350 output to exclude some contexts or to include a subset of contexts. The optic model 350 output may include contexts that are likely to occur in typical sign language. If the sequence “juice father Saturn” rarely occurs, then this unlikely context may be not represented by an optic model 350 output. If the sequence “his father works” is relatively likely, then this context (preceded by “his” and followed by “works”) may be represented by an optic model 350 output. The optic model builder 355 or another configuration tool may determine which contexts to include in the optic model 350 output based on frequency of occurrence. For example, the optic model builder 355 or another configuration tool may select a frequency of occurrence threshold and determine how often a given context occurs within a training corpus. The training corpus may include one or more of script, gloss, and sign language videos. If a context occurs in the training corpus more often than the threshold, then it may be included as an optic model 350 output, otherwise it may not be included. Additionally or alternatively, a number N of optic model 350 outputs may be determined and a subset of K contexts in the training corpus may be selected to be used as optic model 350 outputs up to the number N. The subset of contexts may be determined to be the K most common contexts.

Another method to reduce the number of optic model 350 outputs may be to configure one or more of the optic model 350 outputs to provide one or more matching functions for sign or state categories. For example, signs or states may be clustered into groups. Each group may correspond to an output on the optic model 350. Each output on the optic model 350 may correspond to a matching function of the optic model 350 inputs. The optic model 350 may output a matching function for each of one or more groups in response to input features. The value of the matching function for a group may be used as the value of the matching function for signs or states that belong to the group. Examples of groups may include one or more of surnames, first names, times of the day, dates, and colors. For example, the value of the matching function for the “color” category may be used as the value of the matching function for the sign “blue,” In some embodiments, groups may be determined using automated methods such as one or more of machine learning, clustering, and k-means clustering. Additionally or alternatively, the optic model 350 may output matching functions associated with word embeddings.

Another method to reduce the number of optic model 350 outputs may be to determine one or more contexts such as groups of signs before the target word and one or more groups of signs after the target word. Automated grouping methods such as clustering or embedding may be used to define the groups. Additionally or alternatively, groups may be defined by hand, considering the similarity of possible previous and subsequent words. The effect of the previous and subsequent sign on how a target word is signed may be used as a criterion for how groups may be defined. For example, the way a target word is performed may be influenced by the direction (e.g., to/from below, to/from above, to/from the left, to/from the right) a hand moves into or out of the target sign position. For example, the ASL sign “father” may tend to appear one way if the preceding sign is “my,” since the hand may move to the “father” position from below and another way if the preceding sign is “his,” since the hand may move to the “father” position from the right. In some embodiments, the optic model 350 may include an output for each target word in each context, where the context may be a classification or a group of signs, such as signs where the hand is below the position of the target sign. For example, the four sequences, “my father,” “our father,” “please father,” and “praise father” may be grouped into a first context, since the signs for “my,” “our,” “please,” and “praise,” may end in a position below the “father” sign so, in these four contexts, the hand may approach the “father” position from below. In this example, the optic model 350 may include one output that provides the value of a matching function for the first context that applies to the four sequences.

In a second scenario, the optic model 350 may output target state matching functions. Signs may be divided into a sequence of one or more states, each representing a portion of the sign, and configure the optic model 350 to include outputs corresponding to states. For example, the sign “father” may be divided into three states, (1) with the hand moving towards the forehead from the previous sign, (2) with the thumb touching the forehead with fingers separated and pointing up, and (3) with the hand moving into position for the next sign. In this example, the first state may appear differently, depending on the previous sign (e.g., “my” in the example “my father left”) and the third state may appear differently, depending on the next sign (e.g., “left” in the example “my father left”).

The example of dividing a sign into three states is illustrative and the number of states per sign model may be one, two, three, four, five, or a number greater than five. The number of states may be different for different signs and may depend on the complexity of the sign. For example, in ASL, a relatively complex sign such as “heaven” may be divided into more states than a simple sign like “my.” The optic model builder 355 may determine the number of states for each sign. The number of states for each sign may vary at least partly depending on one or more of the context and complexity of the sign.

In some embodiments, the optic model builder 355 may use one or more criteria for determining the number of states per sign. For example, the number of states per sign may be constant across multiple signs. Additionally or alternatively, the number of states may be determined from the duration of the sign in time or in frames. Additionally or alternatively, the number of states may be determined based on the number of motions included in the performance of the sign. A motion may include a movement where a hand or other body part moves from one position to another in a single line or arc. A motion may be delimited by a reversal or sharp change in direction or a pause. The number of states may be proportional to the number of motions. For example, a predetermined number such as one, two, or three states may be used to model each distinct motion in the sign. Additionally or alternatively, the number of states may be manually determined by a human labeler or may be automatically determined based on image analysis. Additionally or alternatively, the number of states for a given sign may be determined from a measure of the amount of motion in a video clip containing the given sign.

The optic model builder 355 may determine one or more state endpoints, such as the starting point and ending point of each state, using one or more of a variety of methods. One method may include dividing a video of a sign into substantially equal parts. Additionally or alternatively, image analysis may be used to determine the degree of motion between frames and select state endpoints that correspond to relatively less motion. Additionally or alternatively, image analysis may be used to determine the degree of motion between frames and select state endpoints that correspond to relatively greater motion. Additionally or alternatively, image analysis may be used to determine velocity of one or more body parts and select state endpoints that correspond to a change in direction. Additionally or alternatively, image analysis may be used to determine the degree of motion between frames and select state endpoints that correspond to a pause. A pause may be defined as a sequence of frames that include relatively little motion. Additionally or alternatively, a software tool may enable a human labeler to view the sign video and mark state endpoints.

Additionally or alternatively, a series of iterative steps may use endpoints in a first video as a starting point, then revise endpoints based on a second video. For example, the optic model builder 355 may determine optic model parameters 357 using an initial set of endpoints marked for a first video. The optic model builder 355 may send a second video to the ASLR 315. The ASLR 315 may recognize signs in the second video and determine endpoints. The ASLR 315 may use as a language model a predetermined transcript or sequence of glosses that match the sign or signs in the video being recognized. Using a predetermined transcript or sequence of glosses may be referred to as forced decision recognition and may be performed to locate endpoints in a video where one or more of the transcript and gloss are known in advance. These iterative steps may be repeated one or more times for a third video, fourth video, and so on. One or more of the first video, second video, third video, and so on, may each include multiple video clips. One or more of the first video, second video, third video, and so on may include one or more of the video sample 310 and the video data storage 290. In some embodiments, one or more of the first video, second video, third video, and so on may be similar or identical.

The optic model 350 may include an output for a target state in the context of one or more states before, after, or before and after the target state. The optic model 350 may model a sign as a sequence of states. Each state may include a matching function in a specified context. The optic model 350 may output a matching function for a target state corresponding to a current frame. In some embodiments, the matching function of a sign, given a set of input features, may be determined from one or more matching functions output by the optic model 350 for a sequence of corresponding states.

In some embodiments, the optic model 350 may model one or more states at the beginning of a sign in the context of one or more states at the end of the previous sign. Additionally or alternatively, the optic model 350 may model one or more states at the end of a sign in the context of one or more states at the beginning of the next sign. For convenience, we may denote the one or more states at the beginning of a sign as the “head” and the one or more states at the end of a sign as the “tail.” For example, a first sign may be divided into two states and the first sign may be followed by a second sign, which may also be divided into two states. The optic model builder 355 may build a model for the tail of the first sign in the context of the head of the second sign. Additionally or alternatively, the optic model builder 355 may build a model for the head of the second sign in the context of the tail of the first sign. Additionally or alternatively, the optic model builder 355 may build a model that includes the tail of the first sign followed by the head of the second sign.

In some embodiments, a sign may be divided into two or more states. For example, a first one or more states of a first sign may be denoted as the head. An interior one or more states of the first sign may be denoted as the body. A last one or more states of the first sign may be denoted as the tail. The optic model builder 355 may model the head of the first sign in the context of the tail of the previous sign. The optic model builder 355 may model the tail of the first sign in the context of the head of the next sign. The optic model builder 355 may model the body of the first sign as a stand-alone model or in the context of one or more of the first one or more states of the first sign and the last one or more states of the first sign. Additionally or alternatively, the optic model builder 355 may model the head of the first sign preceded by the tail of the previous sign. The optic model builder 355 may model the tail of the first sign followed by the head of the next sign. The optic model builder 355 may model the body of the first sign as a stand-alone model or together with one or more of the first one or more states of a first sign and the last one or more states of the first sign. Additionally or alternatively, the optic model builder 355 may build models for at least part of multiple signs, including two, three, four, or more than four signs.

One benefit of dividing sign into states and building models that cross sign boundaries may be that the number of contexts may be reduced. For example, an example context for the sign “father” may be “my father left.” Building a “father” model for each combination of previous signs (e.g., “my”) and following signs (e.g., “left”) may result in a relatively large number of models. By dividing “father” into two states, “father(head)” and “father(tail),” and building models for each state in the context of an adjacent sign, the number of models may be reduced. For example, the optic model builder 355 may build a first model for “my father(head)” and a second model for “father(tail) left,” Suppose, for example, there are 10,000 signs and that the optic model builder 355 does not use state tying or state clustering. With 10,000 each of combinations of previous sign and next sign contexts, there may potentially exist 10,000 squared (100,000,000) contexts for each sign. By splitting signs and building models for the head and tail separately, there may potentially exist 10,000 contexts for the start of a sign in the previous context and another 10,000 for the end of the sign in the next context for a total of 20,000 contexts for each sign. The signs and numbers cited in this example are as an aid in understanding, not as limitations. Other signs, numbers of contexts, and numbers of signs are anticipated. As described elsewhere herein, the number of models may be further reduced through one or more of state tying, state clustering, and limiting contexts to those likely to occur in typical sign language.

An example of building models that include parts of multiple signs may be illustrated with a first sign, “father,” a second sign, “ate,” a third sign, “left,” and the signed phrases, “father ate” and “father left.” The first part of the first sign “father” may be similar in both cases, but the last part of the first sign (“father”) may vary, depending on whether the following sign is the second sign (“ate”) or the third sign (“left”). The optic model builder 355 may build a first model for the second part of the first sign (“father”) and the first part of the second sign (“ate”) and a second model for the second part of the first sign (“father”) and the first part of the third sign (“left”).

Another example of building models that include parts of multiple signs may be illustrated with a first sign, “father,” a second sign, “ate,” a third sign, “mother,” a first signed phrase, “father ate,” and a second signed phrase, “mother ate,” In ASL, the signed phrases may end similarly, with the second sign (“ate”) sign ending near the mouth in both cases, but the beginning of the second sign (“ate”) may be performed differently, depending on the ending position of the preceding sign (“father” or “mother” in this example). To accommodate variation in the start of the second sign (“ate”), the optic model builder 355 may build a first optic model for the last part of the first sign (“father”) and the first part of the second sign (“ate”) and a second optic model for the last part of the third sign (“mother”) and the first part of the second sign (“ate”). The optic model 350 may use the first optic model when determining a matching function for “father ate” and the second optic model when determining a matching function for “mother ate.”

In some embodiments, one or more states in the first optic model may be sufficiently similar to one or more states in the second optic model that the similar states may be tied. Tied states may trained using data from different sequences of signs (the sequences “father ate” and “mother ate,” in the above example) and may share parameters with tied states in different models. In some embodiments, if a state in a first model is tied to a state in a second model, then the two may be combined into a single tied state. The tied state may be used in place of the two separate states and may be trained on data from the two separate states. Tying states may reduce one or more of the number of states, the size of models, and the amount of training data used to build the models.

As with the first scenario, where the optic model 350 may output one or more matching functions for each sign in multiple contexts, configuring the optic model 350 with multiple contexts for multiple states may result in a relatively large number of optic model 350 outputs. Methods described with respect to the first scenario for reducing the number of outputs may be adapted to the second scenario. For example, using methods described with respect to the first scenario, the optic model 350 output may be configured to include outputs for matching functions for contexts that are likely to occur and not include outputs for matching functions for contexts not likely to occur. As with the first scenario, the optic model 350 may replace the context of a target state with an embedding. As with the first scenario, states may be clustered into groups and groups of states may be modeled before, after, or before and after the target state.

The optic model builder 355 may build one or more pause models from inactive video. The inactive video may include one or more of a signer holding substantially still, a signer holding his/her hands in a neutral position such as in front of the body, and a signer with his/her hands in his/her lap. The pause optic model may correspond to a pause gloss and may be built into the language model 367 to model cases where the signer stops signing or pauses between signs. Additionally or alternatively, the optic model builder 355 may build one or more garbage optic models from video where a signer is performing one or more of a non-existent sign, an unknown sign, a made-up sign, and something other than sign language. For example, the signer may scratch his/her face, rest his/her arms in his/her lap, straighten hair or clothing, or perform some other activity other than signing. One or more glosses representing one or more garbage optic models may be built into the language model 367 to model cases where the signer does something other than perform a known sign. The pause and garbage optic models may be used by the ASLR 315 to identify one or more of pause and garbage when they appear in the video sample 310. To keep the ASLR 315 output uncluttered, one or more of pause and garbage appearing in the output of ASLR 315 may be removed by one or more of the ASLR 315 and a post-processing step. Additionally or alternatively, one or more pause models and one or more garbage models may be combined into one or more models. For example, the optic model builder 355 may build one or more non-signing models that cover pause, garbage, or pause and garbage.

In some embodiments, the ASLR 315 may use a pause model to detect a pause. The ASLR 315 may use a pause to determine one or more boundaries between signs.

In some embodiments, states may be tied to other contexts of the same target state from a given sign. Additionally or alternatively, states may be tied across different signs. States may be “tied” or grouped together based on similarity or common characteristics.

In some embodiments, one or more outputs from the optic model 350 may be sent to the decoder 360. The decoder 360 may use one or more outputs from one or more of the optic model 350, the language model 367, and the lexicon 368 to determine a sequence of symbols corresponding to the video sample 310. The symbols may include glosses and may form a gloss transcription of signs in the video sample 310. In some embodiments, the decoder 360 may determine a sequence of symbols. The sequence of symbols from the decoder 360 may be referred to as a hypothesis. Additionally or alternatively, the output of one or more of the language translator 370 and the TTS synthesizer may be referred to as a hypothesis. Determining a hypothesis may include selecting one or more sequences from multiple sequences of symbols. Selecting from multiple sequences of symbols may include selecting a hypothesis that provides a relatively high score or provides an optimal value for a fitting statistic, a process that may be referred to as optimizing the fitting statistic. The relatively high score or optimal value may be a score or value, respectively, corresponding to a sequence of symbols that is relatively likely to match one or more signs performed in the video sample 310. The fitting statistic may be an estimate of how well the hypothesis corresponds to content of the video sample 310. The decoder 360 may use models generated by the ASLR model builder 395 to determine a fitting statistic. The fitting statistic may include an error rate between a hypothesis and a reference transcript or gloss of the video sample 310. Additionally or alternatively, the fitting statistic may include one or more of a probability or likelihood of a hypothesis, given the video sample 310. Additionally or alternatively, a fitting statistic may include a statistic such one or more of probability, joint probability, conditional probability, likelihood, joint likelihood, conditional likelihood, log probability, log likelihood, likelihood ratio, log likelihood ratio, cross entropy, entropy, one or more softmax activation functions, functions of statistics such as log-likelihood and negative log-likelihood, distance, Manhattan distance, Euclidian distance, cosine distance, counts, and combinations thereof, among other statistics. Additionally or alternatively, the fitting statistic may be a function of the output from the optic model 350, given the video sample 310. Additionally or alternatively, the fitting statistic may be a function of one or more of the video sample 310 and outputs from the optic model 350, given a hypothesis. Optimizing a fitting statistic may include selecting a hypothesis that maximizes the value of the fitting statistic for correct decoder 360 outputs and minimizes the value of the fitting statistic for incorrect decoder 360 outputs. Additionally or alternatively, optimizing a fitting statistic may include selecting a hypothesis that minimizes the value of the fitting statistic for correct decoder 360 outputs and maximizes the value of the fitting statistic for incorrect decoder 360 outputs. The decoder 360 may optimize the fitting statistic given the decoder 360 inputs, which may include outputs from the optic model 350. Additionally or alternatively, the decoder 360 inputs may include one or more of the video sample 310, features, transformed features, and outputs from the optic model 350. The decoder 360 may use one or more of the language model 367 and the lexicon 368 to optimize the fitting statistic. In some embodiments, the language model 367 may include a statistical language model.

The decoder 360 may convert the optic model 350 outputs into symbols by selecting a sequence of one or more symbols from one or more possible sequences of one or more symbols, given the input to the decoder 360. The decoder 360 may use one or more language models 367 in selecting the symbols. The language model 367 may include a prior probability of a given sequence of symbols. In some embodiments, the decoder 360 may select one or more symbols to optimize one or more of a matching function, a fitting statistic, and another statistic. Additionally or alternatively, the decoder 360 may select one or more symbols to optimize one or more matching functions using one or more of the language model 367 and one or more outputs of the optic model 350. A matching function may include one or more of a matching function and a fitting statistic. In some embodiments, a matching function may include a combination of a statistic determined by the optic model 350 and a statistic derived from the language model 367. For example, a matching function may include a weighted sum of a statistic determined by the optic model 350 and a statistic derived from the language model 367. For example, for a given sequence of symbols, if the optic model 350 output statistic, given the optic model 350 input, is α and the language model 367 statistic of the given sequence of symbols is λ, then the matching function may be match=α+ψ*λ, where ψ is the language model weight. Additionally or alternatively, the matching function may be match=β*α+γ*λ, where β is the optic model weight and ψ is the language model weight. The values of β and ψ may be constants, selected to maximize accuracy against a test set of video files with known gloss or script transcripts. The selection of weights such as β and ψ may be determined by the ASLR model builder 395. Additionally or alternatively, the decoder 360 may use other matching functions such as match=log(α)+ψ*log(λ), match=β*log(α)+log(λ), match=β*log(α)+ψ*log(λ), and match=exp(β*log(α)+γ*log(λ)), among other matching functions, in selecting one or more sequences of symbols. The decoder 360 may use a dynamic programming method such as a Viterbi or Dijkstra algorithm to search for the best (e.g., relatively lowest cost or most likely) solution to determine a sequence of one or more glosses given one or more of the video sample 310, optic model parameters 357, and language models 367.

In some embodiments, the decoder 360 may use a language model to determine a sequence of one or more symbols. Additionally or alternatively, the decoder 360 may determine multiple sequences of symbols. The decoder 360 may use a language model to select one or more of the multiple sequences of symbols. For example, the decoder 360 may represent multiple sequences of symbols using one or more of a lattice, n-best list, or word confusion network. The decoder 360 may use a language model to select one or more of the multiple sequences of symbols. Selecting the sequence of symbols may be denoted as a post-processing step. Selecting the sequence of symbols may include selecting a sequence of symbols that maximizes a matching function. Additionally or alternatively, selecting the sequence of symbols may include selecting a sequence of symbols that minimizes a matching function. In some embodiments, the sequence of symbols may include one or more glosses.

The decoder 360 may use a beam search to reduce the search space and reduce the computational load. For example, for one or more paths through the search space, the decoder 360 may compare a fitting statistic to a threshold. If the fitting statistic for a given path fails to meet the threshold test, the path may be terminated.

The language model 367 may include statistics of word sequences in the spoken form of a given language. Additionally or alternatively, the language model 367 may include statistics of symbol sequences in the signed form of the language. The output of the decoder 360 may include a sequence of one or more glosses. In some embodiments, the language translator 370 may be used to convert glosses to scripts using methods analogous to those used to translate from one spoken language to another (such as English to Spanish). The language translator 370 may be trained by presenting a pair of parallel texts, one in gloss (corresponding to the signed form) and one in script (text corresponding to the spoken form), to the language translation model builder 375. The language translation model builder 375 may use the parallel texts to build a language translation model 367 and send it to the language translator 370.

In some embodiments, the decoder 360 may use a search method to determine a hypothesis that optimizes or approximately optimizes one or more fitting statistics, given the language model 367 and the output of the optic model 350. In some embodiments, the search method may test one or more sequences of symbols, evaluate a fitting statistic for each, and select a hypothesis that optimizes the fitting statistic. The decoder 360 may output the selected hypothesis. In some embodiments, the decoder 360 may select a hypothesis that optimizes or approximately optimizes a fitting statistic by using linear programming or another search method. The search method may include one or more of the Viterbi algorithm, Dijkstra's algorithm, the Needleman-Wunsch algorithm, and the Wagner-Fischer algorithm, among other search methods. The search method may include means for selecting a sequence of symbols, given the output of the optic model 350. The search method may include obtaining a maximum value for the fitting statistic. Additionally or alternatively, the search method may include obtaining a minimum value for the fitting statistic. The decoder 360 may select a sequence of symbols by selecting a path through a matrix or connected graph that optimizes a fitting statistic. Each node in the matrix or connected graph may represent a gloss. Additionally or alternatively, each arc in the matrix or connected graph may represent a gloss. The decoder 360 may select multiple sequences of symbols by selecting multiple paths through the matrix or connected graph. The decoder 360 may rank-order the multiple paths, in order of a fitting statistic score for each of the multiple paths, to form an n-best list of n sequences of symbols.

Prior to completing its search, the decoder 360 may use a beam search to increase the search speed or reduce the computational load of the search by reducing the number of active paths in the search space. The decoder 360 may evaluate multiple partial paths through a matrix or connected graph and determine a fitting statistic for each of the multiple partial paths. A partial path may be a path, associated with a sequence of symbols, that not yet complete and may represent a portion of a final path. A partial path may be converted to a final path after additional input is provided to the decoder 360 and further computation is performed. Based on the value of a fitting statistic for each partial path, the decoder 360 may continue to search the partial path or the decoder 360 may discontinue searching the partial path. For example, if a fitting statistic for a given path meets a specified threshold, the path may be preserved. If the fitting statistic for a given path does not meet a specified threshold, the path may be discontinued. By thus pruning the search space, the decoder 360 may reduce the number of active paths in the search. Reducing the number of active paths in the search may reduce the computational load.

In some embodiments, fully optimizing a fitting statistic may be inconvenient under constraints such as time, CPU power, memory, model limitations, and the number of alternatives covered in a search, among other constraints. In the present disclosure, reference to optimizing a fitting statistic may include one or more of determining an approximate optimum, evaluating a function that approximates the optimum and is computationally simpler than determining the optimum, and determining a value that is relatively close to optimum among a limited range or set of options. Using a beam search to reduce the number of active paths may be an example of determining an approximate optimum path.

With reference to outputs of the optic model 350, criteria used by the decoder 360, and in other contexts described herein, the present disclosure may use probability as an example of a statistic; however, other matching functions and fitting statistics may be used in place of probability without departing from the scope of the present disclosure.

In some embodiments, the decoder 360 may output a sequence of symbols (hypothesis) in response to one or more of the optic model 350 output and the video sample 310. Additionally or alternatively, the decoder 360 may output two or more sequences of symbols. One or more of the sequences of symbols may correspond to a hypothesis regarding the content of the video sample 310. The decoder 360 may output n sequences of symbols, sorted in order of how well each sequence optimizes a fitting statistic. This sorted set of n sequences of symbols may be denoted as an n-best list.

In some embodiments, the decoder 360 may use the language model 367 to improve accuracy, compared to an ASLR 315 embodiment without a language model. The decoder 360 may use the language model 367 to rule out unlikely symbol combinations, select symbol sequences, bias the search towards likely symbol combinations, or combinations thereof. The decoder 360 may use the language model 367 to select a hypothesis in light of typical sign usage. The language model 367 may include statistics related to how often sequences of signs are commonly used. The language model 367 may include parameters that indicate the likelihood or frequency of each sign or sequence of multiple signs. Additionally or alternatively, the language model 367 may include parameters for one or more statistics of each sequence of one or more symbols.

In some embodiments, the language model 367 may associate statistics with sequences of one or more symbols. For each sequence, the language model 367 may include one or more of a frequency, number of counts (e.g., how many occurrences have been observed), percentage (e.g., what percentage of the total number of occurrences), likelihood, probability, matching function, fitting statistic, statistic, and a measure of how often the sequence of one or more symbols has occurred previously or is predicted to occur. Symbols may include any of various tokens of spoken, signed, or written language such as one or more of signs, glosses, actions, gestures, words, scripts, phrases, spaces, and punctuation marks, among other tokens. The sequence of one or more symbols may include one or more of a phrase that reflects a sign language grammar (such as grammar used in ASL), a phrase that reflects grammar used in a written or spoken language, one or more symbols that conform to a formal or informal grammar, and a sequence of one or more symbols that reflects the order in which the symbols are typically used. A symbol may be one or more of a sign, gloss, gesture, word, and phrase. For example, in the present disclosure, the term “symbol” may refer to a sign. Additionally or alternatively, the term “symbol” may refer to a word. In some embodiments, the language model 367 may use symbols or embeddings of symbols as input and may provide an output that is a function, such as a statistic, of the input. For example, the language model 367 may indicate a statistic such as probability, likelihood, or phrase counts for one or more sequences of glosses. In this example, an entry in the language model 367. P(“I WENT STORE”)=0.000025, where “I,” “WENT,” and “STORE” may represent glosses, may indicate the probability (0.000025) of the signs for “I,” “WENT,” and “STORE” occurring in sequence. In another example, an entry in the language model 367, count (“I WENT STORE”)=47, may indicate that the gloss sequence, “I WENT STORE,” occurred 47 times in a training corpus.

A statistic that the language model 367 may associate with each sequence of symbols may take various forms. As an example, for a sequence of three signs, represented in order of occurrence by symbols S1, S2, and S3, the language model 367 may include a value for one or more of
P(S1, S2, S3)=a joint probability of S1, S2, and S3;
P(S3|S1, S2)=a conditional probability of S3 given S1 and S2;
L(S1, S2, S3)=a joint likelihood function of S1, S2, and S3;
f(S1, S2, S3)=a joint probability density function of S1, S2, and S3;
count (S1, S2, S3)=the number of occurrences of the sequence S1, S2, and S3 in a given corpus; and
frequency (S1, S2, S3)=the number of times the sequence S1, S2, and S3 occurs in a given corpus, divided by a normalizing factor such as the total number of occurrences of all sequences of symbols in the given corpus. Percent (S1, S2, S3) may be defined similarly, multiplying the frequency by 100%.

The above examples are illustrative and are not meant to represent a complete list of language model 367 statistic forms. Also, the examples are shown illustratively with three symbols S1, S2, and S3; however, the language model may include probabilities or other statistics for other numbers of symbols such as 1, 2, 3, 4, 5, 6, 7, 8, 9, 10, or numbers greater than 10. Other numbers of signs, other types of symbols, other statistical functions, and other forms of language models are anticipated within the scope of the present disclosure. Additionally or alternatively, the language model 367 may be implemented using a neural network. The neural network inputs may correspond to symbols, embeddings of symbols (e.g., transformed representations of symbols, which may be expressed in the form of a vector or array), one-hot encoded symbols, other forms of input derived from a sequence of one or more symbols, or combinations thereof. The output of the neural network may represent, estimate, or approximate a function of the input such as a probability or another statistic. Additionally or alternatively, the language model 367 may be implemented using a neural net transformer with attention. Additionally or alternatively, the language model 367 may be implemented using one or more of a diffusion model and a large language model (LLM).

In another example, the language model 367 may be implemented using n-grams, where an n-gram may be a sequence of n symbols. An n-gram may include a counter. N-gram based language models may be implemented and used in the decoder 360 using methods developed for speech recognition decoders. In some embodiments, the decoder 360 may use a first n-gram based language model to create a set of proposed hypotheses and a second language model to select from the set of proposed hypotheses. The proposed hypotheses may be in the form of one or more of an n-best list, a word confusion network, a lattice (e.g., a connected graph showing possible symbol combinations that may include statistics), and a symbol graph (where a symbol may be a word, gloss, or sign). The second language model may include a neural network such as an RNNLM (Recurrent Neural Network Language Model). The second language model may search through the set of proposed hypotheses to reorder the results or rescore the ASLR 315 output to select a different result. The second language model may include more parameters than the first language model.

In some embodiments, the decoder 360 may determine a sequence of one or more glosses. The ASLR model builder 395 may use the sequence of one or more glosses to build models. For example, the ASLR model builder 395 may use the sequence of one or more glosses to count n-grams and use the n-gram counts to build a language model. Additionally or alternatively, the ASLR model builder 395 may use the sequence of one or more glosses to modify existing models. The ASLR model builder 395 may send the models to the ASLR 315.

In some embodiments, the decoder 360 may send a sequence of glosses to the language translator 370. Additionally or alternatively, the decoder 360 may determine a text string that may be a script or a transcription of the video sample 310 contents into the text form of a spoken language.

The video data storage 390 may include one or more parallel corpora. The parallel corpora may include one or more bodies of text in script, representing grammar, vocabulary, and usage of words or signs in a spoken language. For at least some bodies of text in script, the video data storage 390 may include corresponding bodies of text in gloss, where the text in script and corresponding text in gloss convey similar concepts. The text in script and corresponding text in gloss may be translations of each other or may be parallel translations from another language form.

The video data storage 390 may contain one or more first text files in script, each in a format, syntax, and other language conventions consistent with the spoken form of a language. For each of at least some of the first text files in script, the video data storage 390 may contain one or more second text files in gloss, containing concepts comparible to those of the corresponding first text files in script. In some embodiments, at least some first text files may be used to generate gloss files using one or more of human translators and machine translation. Additionally or alternatively, at least some gloss files may be used to generate script files using one or more of human translators and machine translation. Additionally or alternatively, at least some gloss files and corresponding script files may be generated using one or more of human translators, human transcribers, machine transcription, ASR, ASLR, and machine translation. For example, video samples 310 containing sign language performances may be transcribed by one or more of humans and automated systems such as ASLR and ASR into one or more of gloss and script. As another example, audio recordings may be transcribed by one or more of humans and automated systems such as ASR into text and interpreted into gloss using one or more of humans and automated systems. Transcription using humans may include using one or more of software tools and hardware tools.

In these and other embodiments, one or more of human transcription, translation, interpreting, reverse interpreting, and other types of manual language conversion may be facilitated by one or more tools such as the agent client 137 of FIG. 1. The tools may be included in the data manager 391. The tools may present (e.g., play or display) language in a first form (e.g., one or more of audio, text, sign language video, script and gloss) to a human agent such as the labeler 392 or the agent 135 of FIG. 1. The tools may include input means such as one or more of a keyboard, mouse, touch screen, voice input, and voice input combined with ASR, to enable the human agent to input or edit language in a second form (e.g., one or more of audio, text, sign language video, script and gloss) into the tools. The tools may run in real-time, such as during a conversation where the language in the first form may be part of a live conversation. Additionally or alternatively, the tools may run offline. Where the tools run offline, language in the first form may be saved as a recording and retrieved and played (e.g., as an audio signal over a speaker or as a video signal shown on a display) for the human agent. Language in the first form may be saved in or retrieved from the video data storage 390 by the data manager 391. Tools in the data manager 391 may collect language in the second form from the human agent and save the language in the second form to the video data storage 390. In some embodiments, the first form may be gloss and the second form may be script. Additionally or alternatively, the first form may be script and the second form may be gloss. The first and second form may serve as parallel corpora for training a language translation model 369.

In some embodiments, the language translation model builder 375 may use parallel corpora, such as those described herein, to build a language translation model 369. The language translation model 369 and language translator 370 may include one or more of language translation rules, dictionaries, lookup tables, neural networks, neural machine translation, encoder-decoders, encoder-decoders with attention, statistical machine translation, and transformers such as one or more of neural net transformers, stochastic transformers, LLMs, and neural net transformers with attention. The language translator 370 may use methods developed for translation between spoken or written languages by treating gloss as a source language and script as a target language or vice versa. The language translator 370 may use a language translation model 369 to determine a script in response to glosses from the decoder 360.

In some embodiments, the language translator 370 may modify recognized signs that follow ASL conventions such as conventions omitting articles like “the,” leaving off verb endings (e.g., “ing”) that indicate tense, and rearranging symbol order (e.g. English: “the red house” vs. ASL: “house red”). The language translator 370 may use rules, neural net translators, tables, or other translation methods to convert between languages. The language translator 370 may, for example, add articles like “the,” add word endings like “ing,” rearrange word order, and substitute terms to convert sign language grammar into a script grammar more consistent with standard written language.

In some embodiments, the language translator 370 may use a translation dictionary. The translation dictionary may include one or more entries. An entry may include one or more signs represented in gloss matched with one or more words in one or more of script or text. The script or text may represent a spoken form. The entry may include one or more signs in sign language and the matching word or phrase in the corresponding written form of a spoken language. The one or more signs expressed in gloss may include phrases, idioms, expressions, and pantomimes. For example, an entry may include the gloss for a sign and the matching word in the corresponding written language. As another example, an entry may include the gloss of the ASL idiom “FINISH TOUCH” matched with the written form “went to” in English. Additionally or alternatively, an entry may include a pantomime of a concept, action, or part of a story and the corresponding spoken form may include the meaning in script. A pantomime may include one or more of signs, gestures, made-up signs, actions that mimic an event or concept, signs adapted to convey concepts not originally part of the sign definitions, and multiple signs combined in a manner that forms one or more new meanings.

In some embodiments, the language translator 370 may convert text from a form consistent with a given sign language to a form consistent with the associated spoken language. For example, the language translator 370 may convert gloss to script. Additionally or alternatively, the language translator 370 may convert ASL represented in gloss text to written American English.

Additionally or alternatively, the language translator 370 may convert gloss in a first language to script in a second language. In some embodiments, the first language may not be associated with the second language. For example, the language translator 370 may convert gloss in ASL to written Spanish. In some embodiments, the language translator 370 may convert gloss in one language to script in a different language (e.g., ASL to written Spanish) in one step, performing gloss-to-script conversion and language translation in one step. Additionally or alternatively, the language translator 370 may convert gloss to script in a first step and language translation in a second step. In the second step, the language translator 370 may convert script in a first language to script in a second language. For example, the language translator 370 may convert Spanish sign language gloss to written Spanish in a first step and may translate written Spanish to written French in a second step. Translation between gloss and script and language translation between different languages (e.g., English and Spanish) may be performed using one or more of rules, neural networks, neural networks with transformers, examples, regular expressions, LLMs, and other language translation methods.

The language translator 370 may send script to the TTS synthesizer 380. The TTS synthesizer 380 may generate audio and send it to a speaker such as speaker 261 of FIG. 2 to be played to the HP 230. Additionally or alternatively, the language translator 370 may send the script to the display 264 of FIG. 2 to be shown to the HP 230.

In some embodiments, using methods described herein with reference to the language translator 370, the ASLS 220 of FIG. 2 may convert script associated with a first spoken language to gloss associated with a second sign language. For example, the language translator 370 may convert script in a first spoken language to script in a second spoken language and from script in a second spoken language to gloss associated with the second spoken language. Additionally or alternatively, the language translator 370 may convert script in a first spoken language to gloss associated with a second spoken language in one step. The ASLS 220 may use the gloss in the second spoken language to create a video showing sign language corresponding to the second spoken language.

In the description herein with reference to the language translator 370 and the ASLS 220, language translation between spoken languages (e.g., between American English and Spanish) may be performed by converting script in a first language to script in a second language. Additionally or alternatively, one or more of the language translator 370 and ASLS 220 may perform language translation between different signed languages (e.g., ASL and Spanish Sign Language). For example, the language translator 370 may use language translation to convert gloss in a first sign language to gloss in a second sign language. In some embodiments, the ASLR 315 may convert a first sign language video to gloss corresponding to a first spoken language. The language translator 370 may convert gloss corresponding to the first spoken language to gloss corresponding to a second spoken language. The ASLS 220 may convert gloss corresponding to the second spoken language to sign language video associated with the second spoken language.

In some embodiments, the text output, including one or more of gloss and script, from the ASLR 315 may be presented on a display visible to the DP such as the DP 225 of FIG. 2. The DP may have access to a client such as the DP client 227 of FIG. 2. The client may enable the DP to take action. The action may include one or more of a request that one or more calls be interpreted by a human interpreter, a request that one or more calls be interpreted by a machine interpreter, an indication that the text output from the ASLR 315 was correct, an indication that the text output from the ASLR 315 was incorrect, providing feedback on the quality of a human interpreter, providing feedback on the quality of a machine interpreter, and correcting one or more errors in the text output from the ASLR 315. If the DP corrects one or more errors in the text output from the ASLR 315, the corrections may be applied to one or more of text displayed on the HP's display and audio presented to the HP. Actions by the DP, including one or more of error corrections, feedback on quality, indications that the text output is correct, and indications that the text output is incorrect may be sent to the ASLR model builder 395 and used by the ASLR model builder 395 to build ASLR models. For example, if the DP indicates that the text output is incorrect, the ASLR model builder 395 may not use the incorrectly interpreted portion of the call for training an ASLR model. As another example, if the DP indicates that the interpreting for a call was of poor quality, the ASLR model builder 395 may not use the call for training an ASLR model. Indications of quality of the human interpreter may be sent to one or more of the human interpreter, the human interpreter's manager, and report generation software.

Modifications, additions, or omissions may be made to the environment 300 and/or the components operating in the environment 300 without departing from the scope of the present disclosure. For example, in some embodiments, the environment 300 may include any number of other components that may not be explicitly illustrated or described. As another example, in some embodiments, some components in the environment 300 may be omitted. For example, one or more of the video buffer 320 and the feature buffer 325 may be omitted. In some embodiments, such as if the feature buffer 325 is omitted, the video feature extractor 330 may provide features to the video feature transformer 340. In some embodiments, such as if the video buffer 320 is omitted, the video sample 310 may be sent to the video feature extractor 330. In some embodiments, the optic model 350 may save multiple frames of features, performing at least some of the operation described with reference to one or more of the video buffer 320 and the video buffer 325. In some embodiments, the optic model 350 may be omitted and features may be sent from one or more of the video buffer 320, video feature extractor 330, and feature buffer 325 to the decoder 360. In some embodiments, the video feature transformer 340 may be omitted and the video feature extractor 330 may send video features (with or without buffering by the feature buffer 325) to the optic model 350. As another example, the operations performed by components operating in the environment 300 may be distributed among multiple devices and/or systems such as remote servers. As another example, some components shown in FIG. 3 may be combined into fewer components.

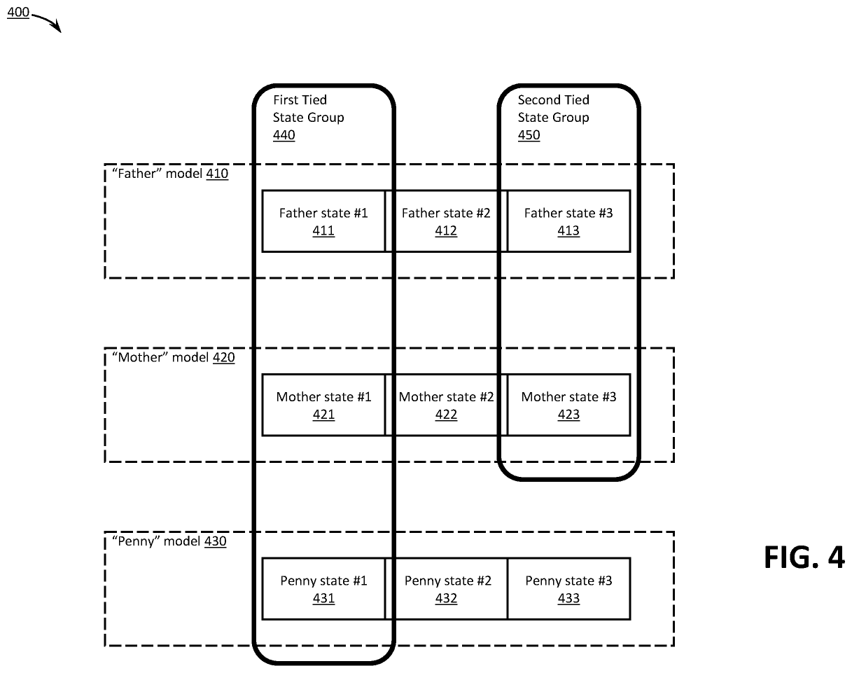

FIG. 4 illustrates an example environment 400 for state tying. The environment 400 may be arranged in accordance with at least one embodiment described in the present disclosure. The environment 400 may include one or more sign models, each composed of one or more states. States may be tied within sign models. States may be tied across models. As illustrated, the environment 400 may include multiple sign models, a “father” model 410, a “mother” model 420, a “penny” model 430, a first tied state group 440, and a second tied state group 450. The “father” model 410 may include a father state #1 411, father state #2 412, and father state #3 413. The “mother” model 420 may include a mother state #1 421, mother state #2 422, and mother state #3 423. The “penny” model 430 may include a penny state #1 431, penny state #2 432, and penny state #3 433.

An optic model builder, such as the optic model builder 355 of FIG. 3, may examine the context and content of states within sign models and determine which states may be tied. In determining which states may be tied, the optic model builder may use image comparisons to determine similarity such as visual similarity. The optic model builder may tie states that are visually similar according to an image similarity function. Additionally or alternatively, the optic model builder may tie states that share one or more of a similar description and a similar context. For example, states may be labeled manually by human labelers and tagged with descriptions of one or more of positions and motion of hands and other body parts such as “palm forward,” “hand below chin,” “fingers in ‘o’ position,” “arm horizontal,” and “right first on top of left fist,” Two states may be tied based on how well the descriptions the two states match each other.

In FIG. 4, the father state #1 411, mother state #1 421, and penny state #1 431 are illustrated as tied. The optic model builder may determine that these states may be tied based on similarity, for example that at least some states correspond to a similar motion such as the hand approaching the head. This group of states may be denoted as the first tied state group 440. A second tied state group 450 may include the father state #3 413 and mother state #3 423. It is to be understood that FIG. 4 is illustrative, showing three sign models with three states each as an aid to understanding. A practical system may include hundreds or thousands or more sign models and hundreds or thousands or more states and tied state groups. One or more tied state groups may be used as contexts for target states in the optic model 350 of FIG. 3.

Modifications, additions, or omissions may be made to the environment 400 and/or the components operating in the environment 400 without departing from the scope of the present disclosure. For example, in some embodiments, the environment 400 may include any number of other components that may not be explicitly illustrated or described. As another example, in some embodiments, some components in the environment 400 may be omitted.

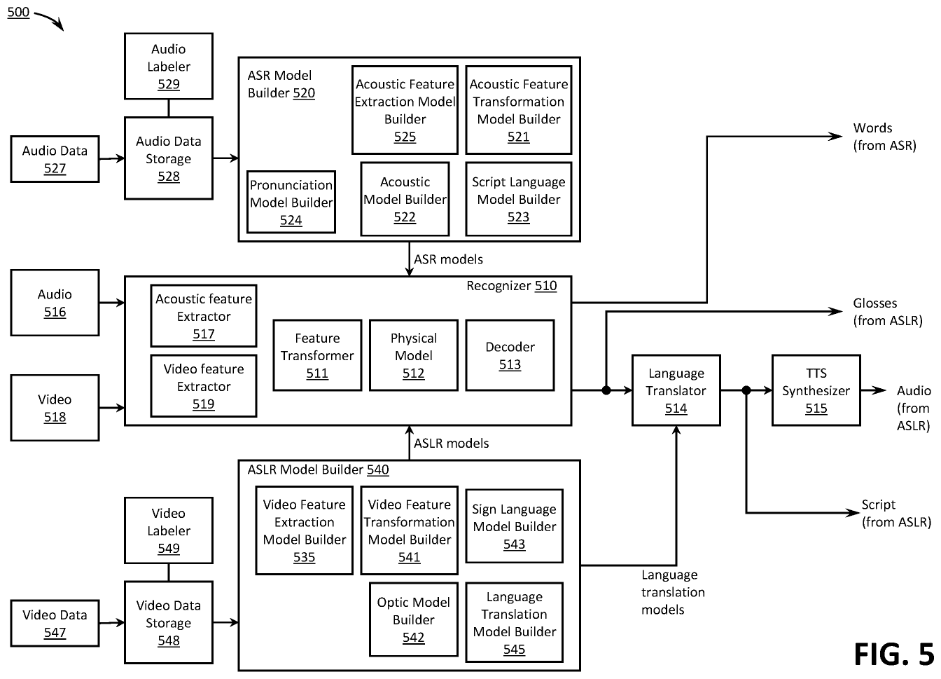

FIG. 5 illustrates an example environment 500 for sign language communication. The environment 500 may be arranged in accordance with at least one embodiment described in the present disclosure. The environment 500 may include audio data 527, an audio labeler 529, an audio data storage 528, an ASR model builder 520, video data 547, a video labeler 549, a video data storage 548, an ASLR model builder 540, audio 516, video 518, a recognizer 510, a language translator 514, and a TTS synthesizer 515. The ASR model builder 520 may include an acoustic feature extraction model builder 525, an acoustic feature transformation model builder 521, an acoustic model builder 522, a script language model builder 523, and a pronunciation model builder 524. The ASLR model builder 540 may include a video feature extraction model builder 535, a video feature transformation model builder 541, an optic model builder 542, a sign language model builder 543, and a language translation model builder 545. The recognizer 510 may include an acoustic feature extractor 517, a video feature extractor 519, a feature transformer 511, a physical model 512, and a decoder 513.

In some embodiments, the video 518, recognizer 510, video feature extractor 519, feature transformer 511, physical model 512, decoder 513, language translator 514, TTS synthesizer 515, video data storage 548, video labeler 549, ASLR model builder 540, video feature extraction model builder 535, video feature transformation model builder 541, optic model builder 542, sign language model builder 543, and language translation model builder 545 may be analogous to the video sample 310, ASLR 315, video feature extractor 330, video feature transformer 340, optic model 350, decoder 360, language translator 370, TTS synthesizer 380, video data storage 390, data manager 391, ASLR model builder 395, video feature extraction model builder 335, video feature transformation model builder 345, optic model builder 355, language model builder 365, and language translation model builder 375, respectively, of FIG. 3.

The environment 500 illustrates an arrangement where components from an automatic speech recognizer (ASR) and an automatic sign language recognizer (ASLR) may be shared. By sharing components, the arrangement may save development time, memory, and simplify the implementation. For example, components, which may include one or more of software and hardware, previously designed and built for ASR may be adapted to ASLR. In some embodiments, an arrangement may be developed for ASR and adapted for use with ASLR. The adaptation may include one or more of re-using, modifying, removing, and adding code.

In some embodiments, the recognizer 510 may perform ASR using models from ASR model builder 520. Additionally or alternatively, the recognizer 510 may perform ASLR using models from ASLR model builder 520. The recognizer 510 may perform ASR and ASLR at different times or simultaneously. For example, an instance of the recognizer 510 may be configured for ASR and another instance of the recognizer 510 may be configured for ASLR. The ASR and ASLR instances may share common data, common models, common software, common hardware, common software sources from which the current software is derived, or combinations thereof.

In some embodiments, the recognizer 510 may include components of an ASR. Some of the components of recognizer 510 may be developed and configured for performing ASR prior to developing some components and configuring one or more of the components of recognizer 510 for ASLR. One or more of the components of the recognizer 510 may be configured to perform one or more of the steps in performing ASLR. For example, the feature transformer 511, physical model 512, and decoder 513 may be used for ASR. Additionally or alternatively, the feature transformer 511, physical model 512, and decoder 513 may be adapted to be used for ASLR. In some embodiments, the adaptation may include re-using at least some components of the recognizer 510. The recognizer 510 may use models from the ASR model builder 520 to configure the recognizer 510 to run ASR. Additionally or alternatively, the recognizer 510 may use models from ASLR model builder 540 to configure the recognizer 510 to run ASLR.

In some embodiments, the recognizer 510 may be used as an ASR. The acoustic feature extractor 517 may extract acoustic features from the audio 516 and send acoustic features to the feature transformer 511. The feature transformer 511 may send acoustic features to the physical model 512. The physical model 512 may be configured as an acoustic model using parameters determined using the acoustic model builder 522. The physical model 512 may send its output to the decoder 513. The output of the physical model 512 may include statistics such as conditional probabilities or likelihoods of states. The decoder 513 may use one or more outputs from the physical model 512 and the script language model builder 523 to determine a sequence of one or more words.

In some embodiments, the ASR model builder 520 may configure models for ASR and send the models to the recognizer 510. The audio data 527 may be sent to the audio data storage 528. The data may include one or more of audio samples, transcripts of the audio samples, entity and demographic information (e.g., age, gender, language, accent) and role (e.g., call center agent, call center customer, person on a business or residential call) of speakers in the audio samples, and other information related to the audio samples.

The audio labeler 529 may include an automated system that transcribes audio samples into text. Additionally or alternatively, the audio labeler 529 may include a tool that includes a user interface that enables a human labeler to tag, transcribe, label, verify, edit, classify, or otherwise provide or manipulate information included in the audio data storage 528. For example, the tool may play audio to the human labeler and one or more of collect text, mouse clicks, touchpad or mouse gestures, audio, and other input from the human labeler. The text input may include a transcript of the audio. Additionally or alternatively, the tool may play audio and show a text transcript to a human labeler and provide an interface to enable the human labeler to edit the text transcript. The tool may enable the human labeler to correct errors, add missing text, delete incorrect text, add tags such as speaker identifiers, audio quality, gender, and non-speech sounds (e.g., noise, background speaker), and input other information.

The audio data storage 528 may send data to the ASR model builder 520. The ASR model builder 520 may use data from the audio data storage 528 to build ASR models. The ASR model builder 520 may send the ASR models to the recognizer 510. The acoustic feature extraction model builder 525 may build acoustic feature extraction models and send them to the acoustic feature extractor 517. The acoustic feature transformation model builder 521 may build acoustic feature transformation models and send them to the feature transformer 511. The acoustic model builder 522 may build one or more acoustic models and send them to the physical model 512. The script language model builder 523 may build one or more language models and send them to the decoder 513. The pronunciation model builder 524 may create pronunciation methods. The pronunciation methods may include one or more of a pronunciation dictionary, pronunciation rules, and pronunciation models. Additionally or alternatively, the pronunciation model builder 524 may modify previously existing pronunciation methods to create new pronunciation methods. The pronunciation model builder 524 may send one or more pronunciation methods to one or more of the physical model 512 and the decoder 513.

In some embodiments, the recognizer 510 may be configured as a speech recognizer. The ASR model builder 520 and the recognizer 510 may include methods for performing speech recognition and for training ASR models, including one or more of feature extraction, feature transformation, speaker adaptation, feature transformation based on multiplying an input feature vector by a matrix, feature transformation using a neural network bottleneck encoder, HMM acoustic modeling, Gaussian mixture density functions, neural networks used to produce bottleneck coefficients, neural network bottleneck features used for acoustic modeling, neural network-based acoustic modeling, adapting an acoustic model based on a set of training data, state clustering for acoustic modeling, state tying for acoustic modeling, an acoustic model with tied states, decision tree-based state tying for acoustic modeling, an acoustic model with context-dependent phoneme models, n-gram based language modeling, a decoder, a decoder that may use a beam search to reduce computational load, neural network-based language modeling, a neural network based language model such as an RNNLM, a neural network based language model used for post-processing (e.g., rescoring, reordering) of preliminary ASR results, language modeling using word embeddings, dynamic programming methods such as a Viterbi or Dijkstra search to determine word sequences from physical model 512 outputs, and end-to-end speech recognition.

The ASR models may be trained using methods known in the art for building ASR models, including language modeling, state clustering, building decision trees for acoustic modeling, building HMMs, placing lower, upper, or lower and upper limits on mixture weights in mixture density functions, among other methods for training ASR models. Additionally or alternatively, the recognizer 510 may be configured using other methods and components known in in the art for training ASR models and performing speech recognition.

In some embodiments, the ASLR model builder 540 may be analogous to and may perform operations similar to those of the ASR model builder 520. For example, in some embodiments, the acoustic feature extraction model builder 525, the acoustic feature transformation model builder 521, the acoustic model builder 522, and the script language model builder 523 may be analogous to the video feature extraction model builder 535, the video feature transformation model builder 541, the optic model builder 542, and the sign language model builder 543, respectively. The ASLR model builder 540 may use sign language to build ASLR models in a manner analogous to methods used by the ASR model builder 520 to build ASR models. For example, whereas the ASR model builder 520 may build models designed to convert audio signals to script, the ASLR model builder 540 may build models designed to convert video signals to glosses. Additionally or alternatively, whereas an ASR may extract features from the audio 516, then process the acoustic features using one or more of a feature transformer 511, physical model 512, and decoder 513, an ASLR may extract features from the video 518, then process the optic features using one or more of a feature transformer 511, physical model 512, and decoder 513.

In some embodiments, one or more components of the recognizer 510 may be configured for use in running the recognizer 510 as an ASLR. One or more components of the recognizer 510 may be used in the form used for ASR or in a form adapted for ASLR. For example, the recognizer 510 may use models created by the ASR model builder 520 when used for ASR and may use models created by the ASLR model builder 540 when used for ASLR. When the recognizer 510 is used for ASR, the acoustic feature extractor 517 may extract acoustic features from the audio 516, which may include spoken words, and send the acoustic features to the feature transformer 511. When the recognizer 510 is used for ASLR, the video feature extractor 519 may extract video features from the video 518, which may include performed signs, and send the video features to the feature transformer 511.

When used for ASR, the recognizer 510 may use the feature transformer 511 to transform acoustic features, the physical model 512 as an acoustic model to use acoustic features to determine acoustic model statistics, and the decoder 513 as a word decoder to use acoustic model statistics and a language model to determine words. When used for ASLR, the recognizer 510 may use the feature transformer 511 to transform optic features, the physical model 512 as an optic model to use video features to determine optic model statistics, and the decoder 513 as a gloss decoder to use optic model statistics and a language model to determine glosses.

In some embodiments, the recognizer 510 may be used as an ASLR. The video feature extractor 519 may extract video features from the video 518 and send video features to the feature transformer 511. The feature transformer 511 may send video features to the physical model 512, which may be configured as an optic model and may use parameters determined using the optic model builder 542. The physical model 512 may send its output to the decoder 513. The output of the physical model 512 may include statistics such as one or more of conditional probabilities, likelihoods, matching functions, and fitting statistics. The statistics may apply to one or more of phrases, signs, glosses, words, and states. The decoder 513 may use one or more outputs from the physical model 512 and the sign language model builder 543 to determine a sequence of one or more glosses. The decoder 513 may send the glosses to the language translator 514. The language translator 514 may translate the glosses from the decoder 513 to script (e.g., text in the target spoken language). The language translator 514 may send the script to the TTS synthesizer 515. The TTS synthesizer 515 may convert the script to audio. The audio may include spoken words corresponding to signs performed in the video 518.

In some embodiments, the interface between the video feature extractor 519 and the feature transformer 511 may be identical to or may be adapted from the interface between the acoustic feature extractor 517 and the feature transformer 511. Additionally or alternatively, the recognizer 510 may be configured for ASR and may include an interface between the acoustic feature extractor 517 and the feature transformer 511. The interface between the acoustic feature extractor 517 and the feature transformer 511 may be adapted for the interface between the video feature extractor 519 and the feature transformer 511. In some embodiments, the recognizer 510 may be initially configured for ASR and subsequently configured for ASLR.

In some embodiments, the ASLR model builder 540 may configure models for ASLR and may send the models to the recognizer 510. The video data 547 may be sent to the video data storage 548. The video data 547 and video data storage 548 may include one or more of video samples, audio, scripts of the video samples, glosses of the video samples, identity (e.g., name, ID number) of signers in the video samples, demographic information (e.g., age, gender, language, region, accent) of signers in the video samples, role of signers in the video samples, and other information related to the video samples. The role may include whether the signer is an interpreter, customer, or paid subject in a data collection experiment, among other roles.

The video labeler 549 may include an automated system that may transcribe video samples into text, script, or gloss. Additionally or alternatively, the video labeler 549 may include a tool that includes a user interface that enables a human labeler to tag, transcribe, label, verify, edit, classify, or otherwise provide or manipulate information included in the video data storage 548. For example, the tool may present video to the human labeler and collect one or more of text, script, gloss, mouse clicks, touchpad or mouse gestures, audio, video, and other input from the human labeler. The script or gloss input may include a transcript of the audio. The video input may include signs. Additionally or alternatively, the tool may present video and show a transcript (e.g., text, script, gloss) to a human labeler and provide an interface to enable the human labeler to edit the transcript. The tool may enable the human labeler to input information, correct errors, add missing information, delete incorrect information, add tags such as one or more of signer identifiers, lighting characteristics, video quality, gender, and non-sign gestures (e.g., scratching one's face, adjusting hair or clothing, shrugging shoulders).

The video data storage 548 may send data to the ASLR model builder 540. The ASLR model builder 540 may use data from the video data storage 548 to build ASLR models. The ASLR model builder 540 may send the ASLR models to the recognizer 510. The video feature extraction model builder 535 may build video feature transformation models and send them to the video feature extractor 519. The video feature transformation model builder 541 may build video feature transformation models and send them to the feature transformer 511. The optic model builder 542 may build one or more optic models and send them to the physical model 512. The sign language model builder 543 may build one or more language models and send them to the decoder 513.

In some embodiments, the recognizer 510 may be configured as a sign language recognizer. The ASLR model builder 540 and the recognizer 510 may include methods for training ASLR models and performing sign language recognition. These methods may be adapted from methods used for training ASR models and performing ASR and may include one or more of feature extraction, feature transformation, signer adaptation (adapted from methods used by ASR for speaker adaptation), feature transformation, feature transformation based on multiplying an input feature vector by a matrix, feature transformation using a neural net bottleneck encoder, HMM optic modeling (adapted from methods used with ASR for HMM acoustic modeling), Gaussian mixture density functions, neural networks used to produce bottleneck coefficients, neural network bottleneck features used for optic modeling, neural network-based optic modeling, adapting an optic model based on a set of training data, state clustering for optic modeling, state tying for optic modeling, an optic model with tied states, decision tree-based state tying for optic modeling, an optic model with context-dependent subsign models (adapted from methods used with ASR for phoneme models), n-gram based language modeling, a decoder, a decoder that may use a beam search to reduce computational load, neural network-based language modeling, recurrent neural network based language model such as an RNNLM, a neural network based language model used for post-processing preliminary ASLR results, language modeling using sign or gloss embeddings (adapted from methods used with ASR for word embeddings), dynamic programming methods such as a Viterbi or Dijkstra search to determine word sequences from physical model 512 outputs, and end-to-end sign language recognition, among other methods used for ASR that may be used or adapted for ASLR and ASLR modeling.

The ASLR model builder 540 may build ASLR models using other methods adapted from methods known in the art for building ASR models, including language modeling, state clustering, building decision trees for physical modeling, building HMMs, placing lower, upper, or lower and upper limits on mixture weights in mixture density functions, among other methods. Additionally or alternatively, the recognizer 510 may be configured using other methods and components known in in the art for performing speech recognition.

Modifications, additions, or omissions may be made to the environment 500 and/or the components operating in the environment 500 without departing from the scope of the present disclosure. For example, in some embodiments, the environment 500 may include any number of other components that may not be explicitly illustrated or described. As another example, in some embodiments, some components in the environment 500 may be omitted. For example, in some embodiments, the recognizer 510 may be used as an ASLR, and one or more of the audio data 527, audio labeler 529, audio data storage 528, ASR model builder 520, acoustic feature transformation model builder 525, acoustic model builder 522, script language model builder 523, pronunciation model builder 524, audio 516, acoustic feature extractor 517, video feature extractor 519, feature transformer 511, physical model 512, decoder 513, and language translator 514 may be omitted. As another example, the operations performed by components operating in the environment 500 may be distributed among multiple devices and/or systems such as remote servers. As another example, some components shown in FIG. 5 may be combined into fewer components.

As another example, the feature transformer 511 may be omitted and the video feature extractor 519 output may be sent to the physical model 512. As another example, the operation of the ASR model builder 520 and the ASLR model builder 540 may be combined. As another example, the acoustic feature extraction model builder 525, acoustic feature transformation model builder 521, acoustic model builder 522, and script language model builder 523 may be combined with the video feature extraction model builder 535, video feature transformation model builder 541, optic model builder 542, and sign language model builder 543, respectively. As another example, the audio labeler 529 may be combined with the video labeler 549. As another example, the audio data storage 528 may be combined with the video data storage 548.

As another example, additional methods known in the art for building ASR models and performing ASLR may be used or adapted for building ASLR models and performing ASLR. Additional methods may include one or more of gradient searches, backpropagation, decision tree construction, use of spectrograms for feature extraction, and unsupervised training. As another example, two or more ASLR models may be combined into fewer models. For example, one or more of the video feature extraction model, video feature transformation model, optic model, sign language model, and language translation model may be combined into one or more models. In another example, the models built by ASLR model builder 540 may be combined into a single model. In another example, one or more of the components in the recognizer 510 may not use models from the ASLR model builder 540.

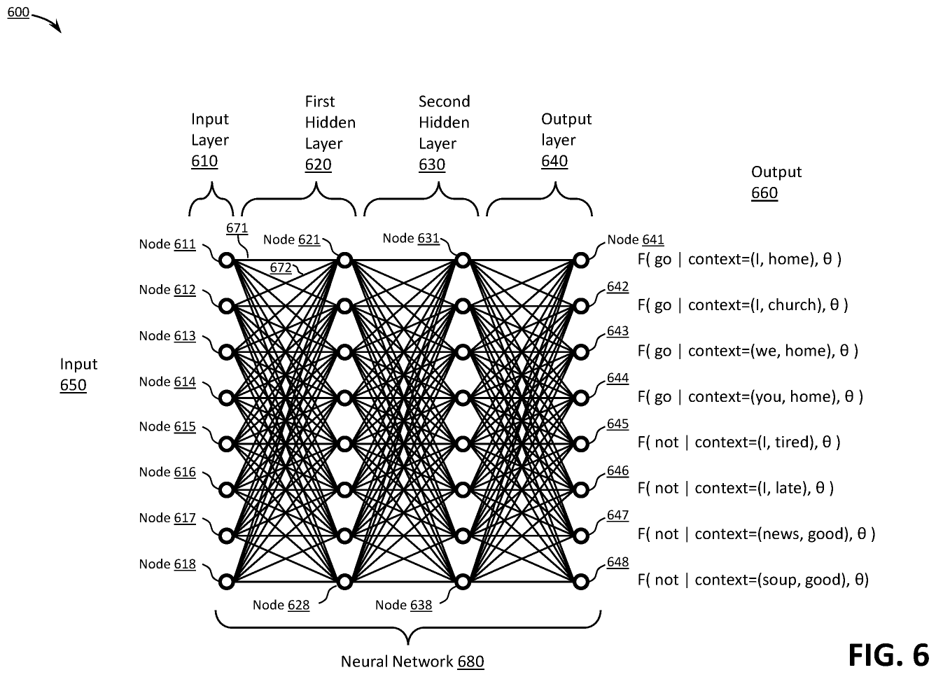

FIG. 6 illustrates an example environment 600 for optic modeling. The environment 600 may be arranged in accordance with at least one embodiment described in the present disclosure. The environment 600 may include a neural network 680, an input 650, and an output 660. The neural network 680 may include an input layer 610, a first hidden layer 620, a second hidden layer 630, an output layer 640, and connections (illustrated as straight lines between nodes) such as connections 671 and 672. Nodes may be connected by weighted connections such as the connections 671 and 272. Other connections between nodes may be illustrated, but not numbered in FIG. 6. To avoid crowding, not all connections are numbered and not all node labels include the word “Node” in FIG. 6. The input layer 610 may include input nodes 611-618. Nodes are denoted by circles. The first hidden layer 620 may include the first hidden nodes 621-628 (not all first hidden nodes are numbered in the figure). The first hidden layer 620 may include connections between the input nodes 611-618 and the first hidden nodes 621-628. The second hidden layer 630 may include the second hidden nodes 631-638 (not all second hidden nodes are numbered in the figure). The second hidden layer 630 may include connections between the first hidden nodes 621-628 and the second hidden nodes 631-638. The output layer 640 may include output nodes 641-648. The output layer 640 may include connections between the second hidden nodes 631-638 and the output nodes 641-648. The input 650 may be sent to the neural network by presenting the input 650 values as inputs to the input layer 610 nodes 611-618. The output of the neural network 680 may include the output of the output nodes 641-648. The neural network 680 may be analogous to one or more of the physical model 512 in FIG. 5 and the optic model 350 of FIG. 3.

The environment 600 illustrates an example of an optic model implemented as a neural network. Each output 660 may represent a matching function for one or more symbols in a given context. The input 650 may include features such as features generated by one or more of the video sample 310, the video feature extractor 330, and the video feature transformer 340 of FIG. 3. Additionally or alternatively, the input 650 may include contexts for features from one or more frames. Additionally or alternatively, the input 650 may include embeddings derived from features. Additionally or alternatively, the input 650 may include multiple sets of features from one or more frames. In the example embodiment illustrated, the signal generated by the output node 641 may correspond to a matching function for the sign “go,” given a specified context. The specified context may include the previous sign “I,” the following sign “home,” and θ, the input 650. The matching function for a symbol may be expressed as a conditional statistic such as F(symbol|context, θ). For example, using “go” as an example of a symbol, the if the matching function includes conditional probability, the conditional statistic for node 641 may be represented as P(go|context=(I, home), θ). The output node 642 may provide the value of a matching function, F(go|context=(I, church), θ), for the symbol “go” preceded by “I” and followed by “church,” given θ, the input 650. The examples illustrated for output nodes 642-648 may follow a similar pattern.

The connection 671 may multiply the output of the node 611 by a first weight and feed the product as a first input to node 621. The connection 672 may multiply the output of the node 612 by a second weight and feed the product as a second input to node 621. The node 621 may add the first input and second input to determine a sum. As illustrated, the outputs from nodes 613-618 may be similarly weighted and included in the sum. The node 621 may use an activation function to transform the sum and provide the transformed sum as an output from node 621 to subsequent nodes (e.g., nodes 631-638) via weighted connections. The activation function may include one or more of a sigmoid, hyperbolic tangent (tan h), linear, logistic, step, ReLU, leaky ReLU, or Gaussian function, among other functions. Other node outputs may be weighted and summed to node inputs, with signals going from left to right, as indicated by the straight lines representing weighted connections between nodes.

FIG. 6 and the accompanying description may illustrate and describe matching functions and statistics for symbols in the context of one previous and one subsequent word; however, a greater or lesser number of previous words, subsequent words, or both previous subsequent words may be included in the context. Additionally or alternatively, other methods for using context in a matching function or statistic, such as attention, transformers, or transformers with attention, may be used.

As illustrated, the environment 600 may include a fully-connected feed-forward neural network. Additionally or alternatively, the neural network of environment 600, as well as other neural networks described herein, may include feedback or recurrent connections that send signal to previous layers or backwards towards the input as in recurrent neural networks (RNNs). Other topologies are possible, including other neural network types described herein.

The number of optic model outputs 640 may be relatively large, such as when outputs 660 may include matching functions for a large number of symbols, each with multiple contexts. The number of outputs 640 and matching functions 660 may be reduced by combining multiple symbols and contexts with similar properties and behaviors into one or more groups. An output 660 may represent a group of contexts. For example, a node in the output layer 640 may include a matching function for “go” preceded by a first cluster (e.g., a cluster including “I” and “we” and followed by a second cluster (e.g., a cluster including locations such as “home” and “church”). Matching functions for symbols in the context of the same group may be estimated using the same output function. The process of grouping symbols may be performed by clustering symbols and contexts according to their similarity. The similarity may be evaluated from a visual perspective. For example, the ASL signs “sit” and “train” may start in the same hand position. The starting hand positions may be combined into a group containing both symbols “sit” and “train.” As an example using probability as a matching function, P(don't|context=(I, sit), θ) may represent the probability of the phrase “I don't sit” and P(don't|context=(I, train)) may represent the probability of the phrase “I don't train.” In some embodiments both matching functions may be combined into a single optic model output representing the probability of “don't” preceded by “I” and followed by “sit” or “train.” A decision tree may be used to perform one or more of defining, organizing, determining, and searching for clusters or groups. The decision tree may be used to select states to be tied. A decision tree may be used to find or select a sequence of one or more symbols. The decision tree may employ methods developed for building decision trees for acoustic models in speech recognizers. In adapting methods from speech recognition for ASLR, signs may be substituted for words, optic models may be substituted for acoustic models, and video features may be substituted for audio features.

Modifications, additions, or omissions may be made to the environment 600 and/or the components operating in the environment 600 without departing from the scope of the present disclosure. For example, in some embodiments, the environment 600 may include any number of other components that may not be explicitly illustrated or described. As another example, in some embodiments, some components in the environment 600 may be omitted. As another example, the numbers of inputs, outputs, nodes, layers, and connections may vary from the examples illustrated. The neural network may include more or fewer inputs, outputs, nodes, layers, nodes per layer, and connections than those shown in the example in FIG. 6. Environment 600 may show the number of components as illustrated, such as eight nodes (nodes 641-648) in the output later 650 and eight output matching functions; however, the number of nodes in the output layer 640 and outputs 660 may be fewer or greater. As another example, at least some operations performed by components operating in the environment 600 may be distributed among multiple devices and/or systems such as remote servers. As another example, some components shown in FIG. 6 may be combined into fewer components. Furthermore, the outputs 660 may be associated with various type of symbols, including one or more of words, signs, subsigns, subwords, glosses, phrases, and states.

FIG. 7 illustrates an example environment 700 for sign language communication. The environment 700 may be arranged in accordance with at least one embodiment described in the present disclosure. The environment 700 may include a video signal 760, field estimator 770, field segmenter 780, segmented image 785, data manager 791, video sample 710, runtime field estimator 720, runtime field segmenter 730, segmented image 788, ASLR 715, video data storage 790, training field estimator 725, training field segmenter 735, segmented image 786, training data manager 792, edited segmented image 787, ASLR model builder 795, and one or more ASLR models 740. In some embodiments, operation of the video sample 710, ASLR 715, video data storage 790, data manager 791, and ASLR model builder 795 may be analogous to operation of the video sample 310, ASLR 315, video data storage 390, data manager 391, and ASLR model builder 395, respectively, of FIG. 3.

The video signal 760 may provide video to the field estimator 770 and to the field segmenter 780. The video may include one or more images. The field estimator 770 may identify one or more fields of interest in the video or in the images from the video. A field of interest may include a region in the image that corresponds to one or more of objects, regions, or characteristics. Fields of interest may include one or more of the background, captioning such as displayed text transcripts, the signer's face, mouth, eyes, arms, hands, and shoulders, other parts of the signer's body, and items the signer may be wearing. Identifying a field of interest may include one or more of determining the location of a field of interest, determining a region of the image that includes the field of interest, determining one or more outlines enclosing the field of interest, and specifying one or more regions in an image that contain the field of interest. For example, the field estimator 770 may identify the location of the signer's arms and hands. Additionally or alternatively, the field estimator 770 may identify the background or regions in an image that do not correspond to the signer. The location of a field may include the field's location in an image, coordinates, size, shape, and orientation. The location of a field may include the coordinates of a point in the field such as a corner, top, bottom, side, or center of the field. The field estimator 770 may provide information about a field, such as the location of the field, to the segmenter 780. The field segmenter 780 may use information from the field estimator 770 to create a segmented image 785.

A data manager 791 may enable a human labeler to correct errors in the segmented image 785. For example, the data manager 791 may display an image with one or more markings to indicate the location of one or more fields of interest. The data manager 791 may display an identity (e.g., “arm,” “hand,” “mouth”) of the field of interest. The data manager 791 data manager 791 may enable the human labeler to modify, insert, delete, augment, or replace at least part of one or more boundaries defining the field of interest.

In some embodiments, the field segmenter 780 may create a segmented image 785. The segmented image 785 may include information about one or more fields in one or more of one or more images and the video signal 760. For example, the segmented image 785 may include an image from the video signal 760 with one or more regions removed. Removing a region may include one or more of marking as deleted, erasing, deleting, and obscuring the region. Additionally or alternatively, removing a region may include creating an image that corresponds to one or more regions in the image other than the removed region. The field segmenter 780 may create a segmented image 785 with one or more regions removed. The removed regions may correspond to one or more fields of interest. Additionally or alternatively, the removed regions may correspond to regions not identified as fields of interest. For example, the segmented image 785 may include an image of the signer with the background removed. As another example, the segmented image 785 may include one or more images of the signer's arms, hands, and mouth, with other regions corresponding to the signer removed.

In some embodiments, the segmented image 785 may include an image with one or more regions removed. Additionally or alternatively, the segmented image 785 may include an image where one or more selected regions appear and other regions are removed.

In some embodiments, regions may be removed from an image, set to black, or set to a value that does not correspond to a visible color such as transparent or undefined, among other forms. Additionally or alternatively, the segmented image 785 may include a description of a removed region such as one or more of its location, size, shape, and dimensions. The description may include a box or outline containing the removed region. The description may include an array of coordinates that describe an outline of the region. In some embodiments, regions to be retained may be described using methods described herein for removing regions.

Examples of methods of operation of the environment 700 will now be described for at least one embodiment described in the present disclosure. In some embodiments, the video sample 710 may include video where a person performing sign language (a signer) is signing. The video sample 710 may include a background.

The video and images in a video may include multiple types of fields, including one or more of background fields, arms, hands, arms and hands, head, face, mouth, shoulders, remainder, and body. We may define the signer's remainder as one or more regions in the image that correspond to one or more of the signer's shoulders, neck, torso, legs, and feet. Additionally or alternatively, we may define the signer's remainder as visible parts of the signer other than the arms, hands, and face. Additionally or alternatively, we may define the signer's remainder as parts of the body not used to perform sign language. We may define the background as one or more regions in the image that are not part of the signer. Additionally or alternatively, we may define the background as one or more regions in the image that lie behind the signer. We may define the arms and hands as one or more regions in the image that correspond to one or both arms and hands, including fingers, of the signer. We may define the signer's head as one or more regions in the image that belong to the signer's head, including one or more of the face, eyes, eyebrows, mouth, and other parts of the face.

The field estimator 770 may operate in one or more of multiple modes, at least some of which are described herein. Other modes are possible.

In a first mode, the field estimator 770 may select regions in the video signal 760 that belong to the background using one or more of multiple methods. One method may be to identify regions of one or more pixels that do not change significantly, or that change less than a selected threshold, over a selected period of time. The method may use a metric such as variance to determine the degree to which regions change over a selected set of frames and declare the regions as belonging to the background if the metric falls below a selected threshold. Other metrics such as standard deviation and mean absolute difference may be used without departing from the scope of the present disclosure. For example, the method may group pixels into groups, such as into three-by-three blocks. Additionally or alternatively, edge detection may be used to identify edges in one or more images and one or more identified edges may be used to bound at least part of a group of pixels. For example, a group of pixels may be selected and the group membership may be further limited to pixels on one side of an identified edge. Additionally or alternatively, a metric may average the standard deviation across each color channel such as red, green, and blue of each pixel over a period of time such as one second, ten seconds, or one minute.

Other arrangements for averaging variance over a selected period of time may be used such as determining the variance within color channels and summing across color channels, determining variance over a block of pixels, and converting pixels to grayscale and determining variance over time of the grayscale image. If the variance, averaged over one or more of the pixels in the block, one or more color channels, and over the grayscale image falls below a threshold such as 1% or 10% of the full brightness range, the group of pixels may be identified as part of the background. Additionally or alternatively, another statistic such as standard deviation may be used instead of standard variance. Additionally or alternatively, heuristics, such as one or more of image quality, position of a region on the screen, proximity of a region of interest to other background regions, and location of a region relative to the signer or to parts of the signer's remainder, head, arms, and hands, may be used to determine whether one or more regions of an image represent part of the background. Additionally or alternatively, object recognition may be used to identify the background. Additionally or alternatively, object recognition may be used to identify which regions the signer occupies and determine the background regions as those that do not correspond to the signer.

In some cases, the signer may move with respect to the background, obscuring or revealing portions of the background. In some embodiments, the field estimator 770 may construct a model of the background, including portions that are sometimes obscured. When a region of one or more pixels is determined to be part of the background model, the field estimator 770 may label the region as background. When a region of one or more pixels does not match the background model or is determined to be part of the signer, the field estimator 770 may label the region as belonging to the signer.

In some embodiments, steps for implementing the first mode of the field estimator 770 may include
1. Select a set of one or more images from a video signal.
2. Divide each of the selected set of images into one or more blocks. The blocks may include one or more pixels. The blocks may be rectangular, such as a two-by-two or three-by-three block of pixels. The blocks may be substantially hexagonal. The blocks may be circular. The blocks may be irregular. Each block may occupy the same region in each of multiple images.
3. Determine the variance of one or more of the blocks across the selected set of images. For example, red (i,f), green (i,f), and blue (i,f) may represent the red, green, and blue color channels, respectively, for each pixel i in each image f. In some embodiments, variance may be determined as

$$variance = {\sum }_{i , f} \{ {[ red ( i , f ) ]}^{2} + {[ green ( i , f ) ]}^{2} + {[ blue ( i , f ) ]}^{2} \} - {[ {\sum }_{i , f} red ( i , f ) ]}^{2} - [ {\sum }_{i , f} {green ( i , f )}^{2} - {[ {\sum }_{i , f} blue ( i , f ) ]}^{2} ,$$

where the sums are taken over the pixels i in the block and the images fin the selected set of images. Additionally or alternatively, variance may be determined using a common definition of variance such as where the sum of squared differences may be divided by the number of samples. Additionally or alternatively, the variance may be divided by the number of pixels per block times the number of images. Other methods of determining variance or other metrics that indicate a degree of change are anticipated and may be used without departing from the scope of the present disclosure. For example, average brightness variation across the pixels of a grayscale version of a block may be determined and used in place of variance of the color version.
4. Compare the variance to a selected threshold. Additionally or alternatively, the standard deviation may be determined as the square root of the variance and the standard deviation may be compared to a selected threshold (and replace “variance” with “standard deviation” in steps #5 and #6 below).
5. If the variance is less than the threshold, label the block as background.
6. If the variance is greater than or equal to the threshold, label the block as not background.

In a second mode of the field estimator 770, the field estimator 770 may select regions in the video corresponding to the signer's head using one or more of multiple methods. The regions corresponding to the signer's head may include regions identified as parts of the head, including one or more of the eyes, eyebrows, mouth, including lips, tongue, and teeth, and other parts of the face. One method for selecting regions in the video corresponding to the signer's head may be to use object recognition to locate the head. Additionally or alternatively, and other method may be to use face detection to locate the face and use the location of the face as the head location. Additionally or alternatively, facial recognition may be used to locate the face.

In a third mode, the field estimator 770 may select regions in the video corresponding to the signer's face. The third mode may use methods described herein for locating the signer's head. Additionally or alternatively, the third mode may use face location methods currently used with facial recognition to locate the signer's face and facial features.

In a fourth mode, the field estimator 770 may select regions in the video corresponding to the signer's body or some portion thereof using methods described with respect to other modes of the field estimator 770. For example, the field estimator 770 may use machine learning to build a model trained to determine one or more regions in an image occupied by the signer's body. The signer's body may include one or more of arms, hands, head, face and facial features, shoulders, and other parts of the signer's body, clothing, and accessories.

In a fifth mode, the field estimator 770 may use object recognition to locate the signer's arms and hands. For example, a neural network or other machine learning model may be trained on images of hands and arms. The model may identify and locate hands and arms in an image.

In a sixth mode, the field estimator 770 may extract video of a signer from a designated region in an image. The image may correspond to screen content presented on a display. The screen content may include a video call, broadcast video, recorded video, or combinations thereof. The designated region may include a video of a window that includes an interpreter. The interpreter's window may be at a predetermined location in the image. Additionally or alternatively, the interpreter's window may be detected by searching for one or more of a rectangular field with straight edges, a field different from the rest of the image, a field that is smaller than a selected size, a field with a size within a range of sizes of typical interpreter windows, a field in a corner of the screen, and a field that includes motion greater than a selected threshold. The field in a corner of the screen may be in the bottom-right, bottom-left, top-right, or top-left corner. In some embodiments, the field may be circular, oval, or rectangular.

In some embodiments, selecting regions or locating fields in one or more images may include motion correction or camera motion compensation. For example, if the camera is in motion, causing the signer and background to shift, rotate, or shift and rotate in the image, one or more of the field estimator 770 and field segmenter 780 may apply motion compensation. The motion compensation may hold the image relatively steady so that fields may be more easily identified, located, and segmented. For example, one or more of the field estimator 770 and field segmenter 780 may compare two or more images to determine the motion of the image and may shift, rotate, or shift and rotate the image in the opposite direction so that the image remains substantially steady. Additionally or alternatively, motion compensation may be applied to a portion of the image that does not include the entire image. Additionally or alternatively, one or more of the field estimator 770 and field segmenter 780 may use motion compensation to hold the image of the signer relatively steady during periods of time where the signer shifts in the image frame. Additionally or alternatively, motion compensation may not be applied to the image and methods for locating fields may estimate motion and take the estimated motion into account in locating fields of interest.

In some embodiments, one or more modes of operation for the field estimator 770 may use machine learning to determine the content of one or more regions in one or more of the video sample 710 and video from the video data storage 790. Determining the content of regions in one or more of the video sample 710 and video from the video data storage 790 using machine learning may include determining whether a region corresponds to a field of interest. Machine learning may include using one or more images with a field of interest to train a neural network or another data-driven content classifier, including for determining whether a region in an image corresponds to a field of interest. Additionally or alternatively, the training may use one or more images that do not include the field of interest.

In some embodiments of a method for using machine learning to determine whether a region in an image corresponds to a field of interest, a model of a field of interest may be constructed using a set of one or more selected images. The selected images may be extracted from a video. One or more regions in one or more images may be determined that include the field of interest. The field of interest may include one or more of a signer's face, eyes, eyebrows, mouth (which may include lips, teeth, and tongue), head, arms, hands, shoulders, remainder, clothing, accessories such as a hat or wristband, and one or more other parts of the signer's body. Additionally or alternatively, the field of interest may include one or more of the background, text such as captioning, graphics added to the image, and objects held near or in proximity to the signer. One or more images may be selected that include the field of interest. Additionally or alternatively, one or more images may be selected that do not include the field of interest. One or more regions in the selected images may be tagged according to whether they include the field of interest. For example, a set of images may be selected, at least some of which may include a signer. One or more regions including the signer may be tagged. For example, one or more fields of interest may be tagged by one or more outlines indicating the boundary between the signer and the background. At least some fields of interest may include the signer's arms and hands. Additionally or alternatively, at least some fields of interest may include the signer's face. Additionally or alternatively, at least some fields of interest may include the signer's mouth. Additionally or alternatively, at least some fields of interest may include the signer's eyes and eyebrows. Additionally or alternatively, at least some fields of interest may include at least part of the signer's body, clothing, and accessories. One or more of the selected images, regions, fields of interest, and tags may be used by a machine learning method to train a machine learning model. The model may be composed of multiple models. Training the machine learning model may include determining one or more model parameters. One or more of the field estimator 770 and field segmenter 780 may use the machine learning model and an inference engine such as one or more of a classifier, neural network, and set of rules to create a segmented image 785.

In some embodiments, a field estimator 770 model may be trained on a first set of images that include a field of interest and a second set of images that do not include a field of interest. The model may then be used to locate the field of interest. For example, the first set of images may contain a signer and the second set of images may not contain a signer. Additionally or alternatively, the first set of images may contain a signer with a background and the second set of images may contain a signer with no background. For example, in the second set of images, pixels corresponding to the background may be set to a single color such as black, set to a nonexistent color, deleted, marked as invisible or nonexistent, or otherwise tagged as part of a background.

In some embodiments, the field estimator 770 may be used to select a region in an image. Additionally or alternatively, the field segmenter 780 may be used to remove the region. For example, the field estimator 770 may select regions in an image corresponding to the background and send information on the locations of the background regions to the field segmenter 780. The field segmenter 780 may use the background location information to remove the background from the image. In some embodiments, the field segmenter 780 may create a segmented image 785 including the signer with no background.

In some embodiments, the field estimator 770 may select regions in an image corresponding to the background, remove at least some portions of the image outside the selected regions, and send the resulting background image to the field segmenter 780. The field segmenter 780 may remove the background image from the video signal 760 to create a segmented image 785 with the background removed.

In some embodiments, the field estimator 770 may extract fields of interest from the video signal 760 to generate a segmented image 785. The segmented image 785 may include multiple channels, each channel including one or more fields of interest. For example, the field estimator 770 may extract the arms and hands into a first channel, the mouth into a second channel, the eyes and eyebrows into a third channel, the shoulders into a fourth channel, and the remainder into a fifth channel. The segmented image 785 containing multiple channels may be provided to an ASLR such as the ASLR 715. The segmented image 785 containing multiple channels may be provided to an ASLR model builder such as the ASLR model builder 795.

The ASLR 715 may use different channels for different purposes. For example, the ASLR 715 may use the arms and hands to infer the base sign being performed. The ASLR 715 may use the mouth formation to resolve uncertainties when a sign has multiple meanings or to aid in recognizing what sign is being performed. For example, if a first sign and a second sign look similar or identical, one or more of the mouth formation and movement may be used to clarify one or more of what is being signed and what the sign means. Additionally or alternatively, one or more of the eyes and eyebrows may indicate what manner of emotion or pitch inflection is to be used when generating speech. Additionally or alternatively, raised eyebrows may indicate that the signer is asking a question. The orientation of the signer's shoulders (e.g., facing left, right, or forward) may be used to indicate who is speaking in a narrative or conversation. In some embodiments, a gloss may include information from multiple channels. The information from multiple channels may include one or more of facial features such as the mouth formation and motion, eye movement, eyebrow position, eyebrow movement, head movement, and movement of other parts of the body such as the shoulders. For example, “He said to the person next to him, ‘Do you understand?’” may be glossed as “UNDERSTAND (eyebrows-raised, facing-right, shoulders-right).” The information from multiple channels may be used by one or more of the ASLR model builder 795 and the ASLR 715 in recognizing sign language.

One or more of the field estimator 770 and field segmenter 780 may be used to identify, remove, extract, or otherwise segment images for processing by one or more of the ASLR model builder 795 and the ASLR 715. By segmenting images, ASLR training and runtime methods may be simplified and may provide more accurate results, compared to using unsegmented images. In some embodiments, the video sample 710, runtime field estimator 720, runtime field segmenter 730, and segmented image 788 may be analogous to the video signal 760, field estimator 770, field segmenter 780, and segmented image 785, respectively. Additionally or alternatively, the video data storage 790, training field estimator 725, training field segmenter 735, training data manager 792, and segmented image 786 may be analogous to the video signal 760, field estimator 770, field segmenter 780, data manager 791, and segmented image 785, respectively. Additionally or alternatively, the edited segmented image 787 may be analogous the segmented image 785. The runtime field estimator 720 and the training field estimator 725 may include implementations or variations of the field estimator 770 and may use methods similar or identical to those of the field estimator 770. Additionally or alternatively, the runtime field segmenter 730 and the training field segmenter 735 may include implementations or variations of the field segmenter 780 and may use methods substantially similar or identical to those of the field segmenter 780. Accordingly, at least some of the descriptions of operation of components in the top ⅓ of FIG. 7 (i.e., components including and to the right of the video signal 760) may apply to the components in the bottom ⅔ of FIG. 7 (i.e., components including and to the right of the video sample 710 and the video data storage 790).

In some embodiments, video from the video data storage 790 may be segmented using one or more of the training field estimator 725 and training field segmenter 735 in a manner analogous to that described herein with respect to the field estimator 770 and field segmenter 780, respectively. The training field segmenter 735 may generate a segmented image 786 and send it to the training data manager 792. The training data manager 792 may enable one or more of a human and an automated module to modify the segmented image 786 to create an edited segmented image 787. Additionally or alternatively, the training data manager 792 may us an automated system such as an ASLR to modify the segmented image 786 to create an edited segmented image 787. The training data manager 792 may send one or more of the segmented image 786 and the edited segmented image 787 to the ASLR model builder 795. The ASLR model builder 795 may use one or more of the segmented image 786 and the edited segmented image 787 to build one or more the ASLR models 740.

In some embodiments, video from the video sample 710 may be segmented using one or more of the runtime field estimator 720 and the runtime field segmenter 730 in a manner analogous to that described with respect to the field estimator 770 and field segmenter 780, respectively, creating the segmented image 788. The ASLR 715 may use the segmented image 788 to convert sign to text. The ASLR may generate at least one of glosses, audio, and script.

Modifications, additions, or omissions may be made to the environment 700 and/or the components operating in the environment 700 without departing from the scope of the present disclosure. For example, in some embodiments, the environment 700 may include any number of other components that may not be explicitly illustrated or described. As another example, in some embodiments, some components in the environment 700 may be omitted. For example, the field estimator 770 may be omitted and the field segmenter 780 may operate without input from the field estimator 770. The field segmenter 780 may receive input from the video signal 760. Additionally or alternatively, the runtime field estimator 720 may be omitted and the runtime field segmenter 730 may operate with input from the video sample 710. Additionally or alternatively, the training field estimator 725 may be omitted and the training field segmenter 735 may operate with input from the video data storage 790. Additionally or alternatively, the field segmenter 780 may perform at least some operations of the field estimator 770. Additionally or alternatively, the field estimator 770 may perform at least some operations of the field segmenter 780. As another example, the training data manager 792 may be omitted and the training field segmenter 735 may send the segmented image 786 to the ASLR model builder 795 for use in building ASLR models 740. As another example, the operations performed by components operating in the environment 700 may be distributed among multiple devices and/or systems such as remote servers. As another example, some components shown in FIG. 7 may be combined into fewer components.

As another example, the ASLR 715 may perform at least some operations described with reference to one or more of the runtime field estimator 720 and the runtime field segmenter 730. Additionally or alternatively, the ASLR model builder 795 may perform at least some operations described with reference to one or more of the training field estimator 725 and the training field segmenter 735.

FIG. 8 is a flowchart of an example method 800 to interpret sign language. The method 800 may be arranged in accordance with at least one embodiment described in the present disclosure. The method 800 may be performed, in some embodiments, by a device or system, such as one or more of the ASLR 315, the ASLR model builder 395, and the data manager 391 of FIG. 3. In these and other embodiments, the method 800 may be performed based on the execution of instructions stored on one or more non-transitory computer-readable media. Although illustrated as discrete blocks, various blocks may be divided into additional blocks, combined into fewer blocks, or eliminated, depending on the desired implementation.

In some embodiments, k subsign endpoints may be used to delimit subsigns, which may be portions of a given sign. A set of first subsign endpoints may be determined in a first iteration. For example, the sign may be divided into k substantially equal subsections, each representing an initial subsign or state. For example, k may be equal to 2, 3, 4, or 5, or a number greater than 5. The number k may be the same for all signs. Additionally or alternatively, the number k may vary across different signs. An ASLR model builder, such as the ASLR model builder 395 in FIG. 3, may use a first model and the first subsign endpoints to build a second model that may include models for subsections. The second model may include a set of second subsign endpoints. In some embodiments, the ASLR may determine the set of second subsign endpoints using forced decision, based on a transcript of video that is input to the ASLR. An ASLR model builder may use the second subsign endpoints to build a third model. The third model may be used to determine a set of third subsign endpoints, and so on. Using this iterative process, an initial set of subsign endpoints may be refined to determine improved subsign endpoints. Improved subsign endpoints may enable an ASLR model builder to build improved models for improved accuracy. Additionally or alternatively, the process for refining subsign endpoints may refine sign endpoints. Sign endpoints may be the start and end points of signs. Subsign endpoints may be the start and end points of subsigns.

The method 800 may begin at block 805, where a data manager may present a first video to a human labeler. The first video may include one or more human, machine, or human and machine signers performing sign language. The first video may include one or more segments. Segments may be portions of video that may include one or more signs or subsigns. The data manager may play audio associated with the first video. The audio may include sounds produced by the signer such as one or more of speech, clapping, slaps, and puffs of air. The audio may include voiceover audio. The voiceover audio may contain speech corresponding to signs performed by the signer.

The data manager may include an editor configured to present at least part of the first video on a display. The editor may be configured to collect input, such as endpoints and tags, from a segment labeler. In some embodiments, the segment labeler may be a human labeler. Additionally or alternatively, the segment labeler may be an automated labeler. The endpoints may include timestamps that indicate the time of the start, end, or start and end of one or more segments. A segment may include a sequence of images in a video corresponding to one or more signs, subsigns, states, sequences of signs, sequences of subsigns, sequences of states, or combinations thereof. Additionally or alternatively, a segment may include a sequence of frames in a video showing one or more signs, subsigns, or states. Additionally or alternatively, the editor may collect input such as one or more of glosses, script, notations about the video quality, notations on about the signer's demographics or skill, and judgements as to the usefulness of a segment for ASLR training. A tag may indicate the name of the segment. One or more of the tag and name of the segment may include the name of the sign shown in the video. For example, if a segment shows a person signing “mother,” the tag may include the text “mother.”

A timestamp may reflect a time relative to a reference point such as the starting point of the first video, the starting point of a video clip, clock time (i.e., the time of day), or some other reference point. For example, if an endpoint occurs at 2 hours, 11 minutes, 32.104 seconds from the start of the first video, the timestamp of the endpoint may read 02:11:32.104. The timestamp may include a starting time, ending time, or starting and ending time of one or more of a sign, a subsign, a state, a phrase, and a segment. For example, a sign for the word “sky” may include three subsigns, each representing a portion of a sequence of motions forming the sign for “sky.” The editor may collect one or more of the name of the sign (“sky”), names of each subsign (e.g., “sky1,” “sky2,” and “sky3”), timestamps marking the beginning and ending of the sign, and timestamps marking the beginning and ending of one or more of the subsigns. Additionally or alternatively, the editor may collect a timestamp that marks the end time of a first segment and the start time of the next segment. For example, if two segments are adjacent, a single timestamp may mark the boundary between the first segment and the second segment.

In some embodiments, the editor may collect the start time and end time of a segment. For example, if the sign for “sky” starts at 02:33:32.000 and lasts 1.5 seconds, the editor may collect a tag for the name of the sign (“sky”), the starting time (02:33:32.000) of the sign, and the ending time (02:33:33.500) of the sign. In some embodiments, tags and timestamps may be formatted as name-value pairs. In the “sky” example, the tags and timestamps may appear as “sign=sky start=02:33:32.000 end=02:33:33.500.” Additionally or alternatively, the editor may collect one or more of a tag for the name of the first subsign (e.g., “sky1”), a starting time of the first subsign, and an ending time of the first subsign, e.g., “subsign=sky1 start=02:33:32.000 end=02:33:32.500.” Additionally or alternatively, the editor may collect the starting time and duration (e.g., a span of time from the start time to the end time) of a segment.

At block 810, the sign endpoints may be marked. In some embodiments, input from a segment labeler may be used to mark one or more sign endpoints. For example, a data manager may collect one or more endpoint positions from a segment labeler. For example, the data manager may enable a segment labeler to type or mark endpoint times using one or more of a keyboard, mouse, touchscreen, voice command, pen, touchpad, foot pedal, and software program. The endpoint times may appear on a display using one or more of digits, lines, shaded regions, and other graphic constructs. Additionally or alternatively, a machine-based labeler such as an ASLR may be used to mark the sign endpoints.

At block 815, a value for k may be selected, where k may be the number of subsigns to be used for a given sign. The value of k may be the same for all signs or it may vary from sign to sign. The value for k may be determined using automatic means, such as using larger values of k for signs that are longer in duration. Additionally or alternatively, the data manager may collect one or more values for k from a segment labeler.

At block 820, the sign may be divided into k subsigns. The subsigns may be set to be of substantially equal length. Subsign timestamps may be used to mark one or more of the subsign endpoints. Additionally or alternatively, the data manager may collect subsign endpoints from a segment labeler. Additionally or alternatively, subsign endpoints may be automatically determined in response to the video content. For example, subsign endpoints may be set at points where there may be relatively little motion in the first video. Additionally or alternatively, subsign endpoints may be set at points where there may be relatively greater motion in the first video.

At block 825, ASLR models may be built. In some embodiments, an ASLR model builder, such as the ASLR model builder 795 in FIG. 7, may use one or more of the tags, sign timestamps, and subsign timestamps to determine one or more ASLR model parameters. The model parameters may be included in one or more models such as the ASLR models 740 of FIG. 7.

At block 830, a second video may be sent to an ASLR, such as the ASLR 715 of FIG. 7. The second video may include multiple video clips. The second video may include one or more video clips selected from a corpus of video samples. If block 830 is executed multiple times, the second video may include one or more video clips that are different from the video clips selected for one or more previous iterations. For example, in each iteration, a different video clip may be selected from the corpus of video samples until the clips in the corpus have been used once, and then the selection process may start over, using video clips from the corpus a second time, and so on. In some embodiments, the second video may be different from the first video. Additionally or alternatively, the second video may be the same as the first video.

At block 835, the second video may be aligned with endpoints. For example, an ASLR may mark the second video with one or more sign endpoints. Additionally or alternatively, an ASLR may mark the second video with one or more subsign endpoints. In some embodiments, the ASLR may convert a second video to a sequence of glosses, where the glosses represent a sequence of one or more signs. Additionally or alternatively, the ASLR may use a preexisting transcript of the second video as a guide to the contents of the second video. The ASLR may be configured to recognize the preexisting transcript and locate the timestamps for one or more of the signs and subsigns. The ASLR may determine one or more sign endpoints in the second video that correspond to the sequence of glosses. The ASLR may label the sign endpoints. Additionally or alternatively, one or more of the preexisting transcript and the ASLR labels may include text in script.

At block 840, one or more new sign endpoints may be determined. The sign endpoints may be determined based on the endpoints determined by the ASLR. The method for determining sign endpoints may include one or more of the methods described with reference to block 835.

At block 845, one or more subsign endpoints may be determined. The subsign endpoints may be determined based on one or more of the endpoints output by the ASLR and the new sign endpoints determined at block 840. The method for determining subsign endpoints may include one or more of the methods described with reference to block 835.

At block 850, a test may be performed to determine whether an exit criterion is met. If no, the method may proceed to block 825. If yes, the method may proceed to block 855. If the method proceeds to block 825, a new iteration may begin using new endpoints determined using steps described with reference to blocks 825-845.

Determining whether the exit criterion is met may be responsive to an indication of whether further iterations are likely to materially improve the model. As an example, the test may determine the error rate obtained by sending one or more test videos to an ASLR using the current model and comparing the ASLR output to one or more known transcriptions of the test videos. If the error rate is below a first selected threshold, the exit criterion may be met. Additionally or alternatively, if the change in error rate, compared to the error rate from a previous iteration, is below a second selected threshold, the exit criterion may be met.

Additionally or alternatively, the test may determine a metric indicating how much the endpoints have changed since a previous iteration. For example, the metric may include the average absolute difference in time between one or more timestamps from a previous iteration and one or more timestamps from the current iteration. Other metrics of how much timestamps have changed may be used such as the total absolute difference, total difference squared, average difference squared, and absolute maximum difference. The metric may be compared to a third selected threshold. If the metric is not below the third selected threshold, the exit criteria may not be met, and the method may proceed to block 825. If the metric is below the third selected threshold, the exit criteria may be met, and the method may proceed to block 855.

Additionally or alternatively, the exit criterion may include a combination of tests. For example, the exit criterion may be met if any of one or more of the metrics described above with respect to the first, second, and third selected thresholds falls below their respective thresholds. As another example, the exit criterion may be met if one or more of the metrics described above with respect to the first, second, and third selected thresholds fall below their respective thresholds.

At block 855, one or more of the sign endpoints, subsign endpoints, and model parameters may be saved. The endpoints, model parameters, or endpoints and model parameters may be incorporated into one or more models such as the ASLR models 740 of FIG. 7.

At block 860, a third video may be sent to an ASLR.

At block 865, the ASLR may convert the third video to a sequence of one or more glosses. The ASLR may use one more of one or more models and model parameters such as those described with reference to block 855 to convert the third video to gloss.

At block 870, the sequence of one or more glosses may be converted to script. The conversion may use a translator, such as the language translator 370 of FIG. 3 or the language translator 514 of FIG. 5.

At block 875, the script may be converted to audio. The audio may include speech and may correspond to a spoken form of signs performed by a signer in the third video. An HP client may play the audio for an HP.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 800 may not divide signs into subsigns. In these and other embodiments, model parameters for signs may be determined and model parameters for subsigns and states may not be determined. For example, k may be set to one and block 845 may be omitted. In another example, an automated labeler, which may include an ASLR, may assist or replace the segment labeler. As another example, blocks 805, 810, 815, and 820 may be omitted and block 825 may use one or more of a preexisting ASLR and a segment labeler. In another example, in block 810, one or more of tags and endpoints for one or more of subsigns or states may be marked in addition to or instead of for signs.

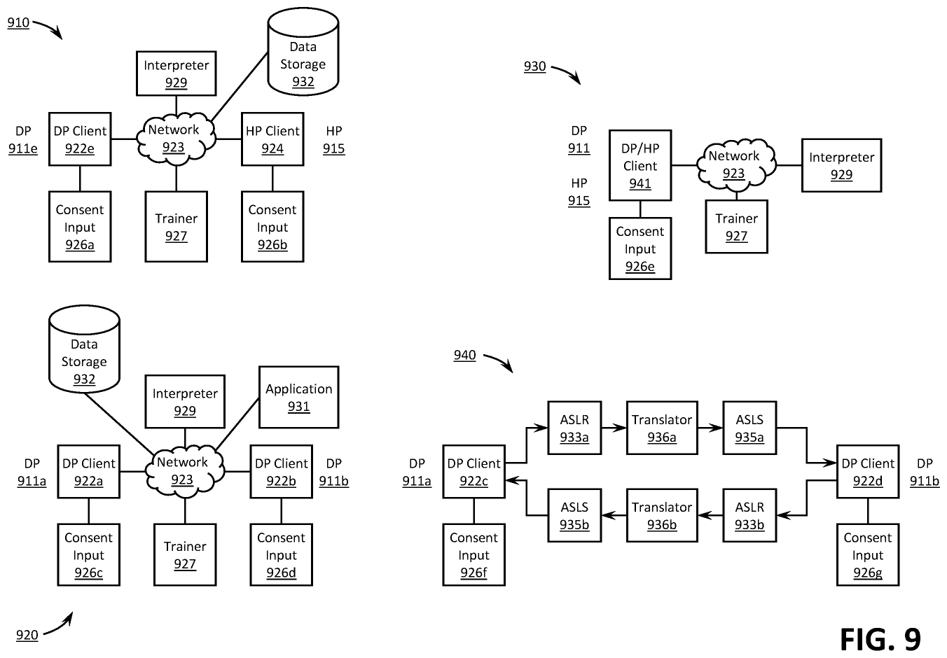

FIG. 9 illustrates example environments 910, 920, 930, and 940 for sign language communication. The environments 910, 920, 930, and 940 may be arranged in accordance with at least some embodiments described in the present disclosure. As illustrated, the environments 910, 920, 930, and 940 may each include one or more of a DP 911a, DP 911b, DP 911e, HP 915, DP client 922a, DP client 922b, DP client 922c, DP client 922d, DP client 922e, network 923, HP client 924, trainer 927, interpreter 929, application 931, data storage 932, ASLR 933a, ASLR 933b, ASLS 935a, ASLS 935b, translator 936a, translator 936b, and DP/HP client 941. The environments of FIG. 9 may further include consent inputs 926a, 926b, 926c, 926d, 926e, 926f, and 926g, which may be referred to collectively as the consent inputs 926 or individually as the consent input 926. References herein to consent input 926 may apply to one or more of consent inputs 926a, 926b, 926c, 926d, 926e, 926f, and 926g. References herein to DP 911 may apply to one or more of the DP 911a, DP 911b, and DP 911e. References herein to DP client 922 may apply to one or more of DP client 922a, DP client 922b, DP client 922c, DP client 922d, and DP client 922e.

In some embodiments, descriptions herein of one or more of the consent inputs 926 may apply to other consent inputs 926. Single letter suffixes, such as a, b, c, and so on, following a component number may denote instances of the component. An instance of a component with a single letter suffix may be substantially the same as the component with the same number and without a suffix. The suffixes may be added herein for clarity in cases such as where multiple instances of the same component appear in the same environment. For example, the DP client 922a, DP client 922b, DP client 922c, DP client 922d, and DP client 922e may operate similarly, may occupy different positions in various environments and may be connected to different components. Accordingly, a description of one instance of a component may apply to other instances (e.g., other components with the same number and different suffixes). As another example, consent inputs 926, 926a, 926b . . . , 926g may be multiple instances of the same component. Other examples of a component having multiple instances may include ASLS 935a and ASLS 935b, ASLR 933a and ASLR 933b, and DP 911a, DP 911b, and DP 911e.

In some embodiments, operation of the DP 911, HP 915, DP client 922, network 923, HP client 924, trainer 927, ASLR 933a, ASLR 933b, ASLS 935a, and ASLS 935b may be analogous to the DP 125 of FIG. 1, HP 130 of FIG. 1, DP client 127 of FIG. 1, network 180 of FIG. 1, HP client 132 of FIG. 1. ASLR model builder 395 of FIG. 3, ASLR 215 of FIG. 2, ASLR 215 of FIG. 2, ASLS 220 of FIG. 2, and ASLS 220 of FIG. 2, respectively. In some embodiments, the translators 936a and 936b may include at least some of the functionality of one or more of the language translator 370 of FIG. 3 and the language translator 514 of FIG. 4.

In some embodiments, the interpreter 929 may include at least some of the functionality of one or more of the interpreter 110 of FIG. 1, the interpreter 210 of FIG. 2, the ASLR 315 of FIG. 3, the recognizer 510 of FIG. 5, and the ASLR 715 of FIG. 7. Additionally or alternatively, the interpreter 929 may include a client used by a human interpreter such as one or more of the agent client 137a-137d of FIG. 1 and the agent client 237 of FIG. 2. Additionally or alternatively, the interpreter 929 may use one or more of human interpreters and machine interpreters for interpreting sign language and human language translators and machine language translators for language translation. For example, one or more components of figures and descriptions herein may be combined to perform the operation of the interpreter 929. For example, the interpreter 929 may include one or more of an ASLR, ASLS, human interpreter, and agent client. The interpreter 929 may use one or more methods for interpreting sign language described herein, such as the methods described with reference to FIGS. 1 and 2 for determining whether a call is to be interpreted using an automated system or a human interpreter or both.

The environments illustrated in FIG. 9 may include various arrangements in accordance with at least one embodiment described in the present disclosure. Components with matching names and numbers (ignoring suffixes) shown in FIG. 9 may each be included in one or more of environments 910, 920, 930, and 940, and may each operate in an analogous manner across the various environments shown in FIG. 9. Additionally or alternatively, components shown in FIG. 9 may be adapted to different environments. Operation of the various components shown with matching names and numbers (ignoring suffixes) may be similar across at least some environments illustrated in FIG. 9. Accordingly, operation of at least some components may not be described or may be partly described for each environment.

In some environments illustrated in FIG. 9 and elsewhere herein, communication between components may be facilitated by a network 923. Operation of the network 923 may be analogous to operation of the network 180 of FIG. 1 and the network 280 of FIG. 2. The network 923 may include a local network such as a WiFi network or Ethernet network. Additionally or alternatively, the network 923 may include a wide area network such as a cellular network provided by a telecom carrier.

In some embodiments, the DP client 922 may be used by the DP 911. The HP client 924 may be used by the HP 915.

The consent inputs 926 may include one or more of a human, hardware, and software to enable one or more users to consent to recording or to refuse consent to record. The users may include one or more of the HP 915, DP 911a, DP 911b, DP 911e, the agent 135 of FIG. 1, and the agent 235 of FIG. 2. The consent inputs 926 may include one or more of buttons, displays, screen icons, microphones, cameras, IVR systems, human agents, sign language avatars, fields in one or more databases, touch-tone inputs, and other methods for enabling a user to provide or refuse consent. For example, a user may be communicatively coupled to a human agent or an IVR system that may request consent to record. The human agent may use a client configured with a display and camera so that the human agent may communicate (e.g., to request and confirm consent) with the HP 915 or DP 911 using sign language. The user may respond via one or more of a screen click, button press, sign language, and voice command. As another example, the consent input may display a prompt on a screen and request the user to press a button, click an icon on a display, or respond using sign language. The button or icon may read “yes,” “I consent,” or another indication that the user consents to recording at least part of the call. Additionally or alternatively, the consent input 926 may provide a complementary option for refusing consent such as one or more of clicking an icon, typing a response, responding with a voice command, responding in sign language, and pressing one or more buttons. Additionally, or alternatively the consent input may present a sign language request using an ASLS avatar or recorded video and may collect consent via sign language to be recorded, recognized using an ASLR, or recorded and recognized using an ASLR. In some embodiments, the consent input 926 may collect consent from all participants on a call. Additionally or alternatively, the consent input 926 may collect consent from some participants and not from other participants. For example, the consent input 926 may collect consent from one or more HPs and not from one or more DPs. As another example, the consent input 926 may collect consent from one or more DPs and not from one or more HPs.

In some embodiments, the consent input 926 may request consent to record audio. Additionally or alternatively, the consent input 926 may request consent to record video. Additionally or alternatively, the consent input 926 may request consent to record audio and video. Additionally or alternatively, the consent input 926 may request consent to record the call and may not specify whether audio, video, or audio and video are to be recorded. In some embodiments, where the present description refers to a user granting or refusing consent, it may be understood to mean that the user grants or refuses, respectively, consent to record one or more of audio, video, and text. The determination of whether to record one or more of audio, video, and text may be responsive to whether the user grants consent to record one or more of audio, video, and text, respectively. In some embodiments, if the user grants consent to record and the consent input 926 does not inform the user whether the consent request applies to audio, video, text, or a combination thereof, then audio, video, text, or a combination thereof may be recorded.

The consent input 926 may collect input from a user to determine whether the user grants consent to record at least part of the call. The consent input 926 may create a database or log entry indicating whether the user granted consent, refused consent, or neither granted nor refused consent. The database or log entry may include one or more of the identity of the user, account number, user ID of the user, username of the user, part or all of a social security number, identity of other parties on the call, communication device identifiers, time, date, type of service provided to the user (e.g., audio, captioned call, video, sign language interpreting, text), type of sign language (e.g., ASL, BSL), spoken language (e.g., English, Spanish), phone numbers, email addresses, or IP addresses of devices used by one or more parties on the call, an indication of whether the user granted consent, an indication of whether the user refused consent, and at least one of an audio, video, or text record of the user granting or refusing consent.

If the user grants consent, the consent input 926 may record at least part of the call. In this and other embodiments, the consent input 926 may use the data storage 932 to record call content. The call recording may be encrypted. The trainer 927 may use the call recording to train models such as one or more of ASR, ASLR, and NLP models. If the user refuses consent, the trainer may not record the call. Additionally or alternatively, if the user refuses consent, the consent input 926 may not record the call and the trainer 927 may use call content to train ASLR models. Call content may include one or more of audio, video, and text. Additionally or alternatively, call recordings may include one or more of audio, video, and text. In training ASLR models, the trainer 927 may adapt model parameters in a manner that optimizes a cost function such as minimizing the error rate. Additionally or alternatively, if the user refuses consent, the consent input 926 may not record the call, and the trainer 927 may not use call content to train ASLR models. The trainer 927 may use one or more of call content (which may include recordings) and user response (e.g., responses to the request to consent to recording) from multiple users to train ASLR models. In some embodiments, if a user has neither granted nor refused consent, the decision to record or train using the user's content may be made as if the user refused consent. Additionally or alternatively, if a user has neither granted nor refused consent, the decision to record or train using call content from a call where the user is a participant may depend at least partly on whether one or more of the other call participants have granted or refused consent.

In some embodiments, the consent input 926 may include one or more of an ASR and ASLR. One or more of the ASR and ASLR may be part of the interpreter 929. For example, the consent input 926 may use one or more of an ASR, ASLR, and human listener to determine whether a user granted or refused consent. The consent input 926 may play a prompt to the user. The prompt may be in one or more of text on a display, an audio signal, and a video. The audio may include speech. The video may include sign language. The consent input 926 may capture audio from the user and send the audio to an ASR. The user may be the HP 915. The ASR may generate a result indicating what the user said. The consent input 926 may use the ASR result to determine whether the user granted consent. Additionally or alternatively, the consent input 926 may capture video from the user and send the video to an ASLR. The user may be the DP 911. The ASLR may convert the video to one or more of text, script, and gloss. The ASLR may generate a result indicating what the user said. The consent input 926 may use the ASLR result to determine whether the user granted consent.

The consent input 926 may record the user response. The user response may include one or more of audio, video, clicks, button presses, transcript of audio, transcript of sign language video, and other actions by the user. Additionally or alternatively, if the user grants consent, the consent input 926 may record the user response. If the user refuses consent, the consent input 926 may not record the user response.

The consent input 926 may use a natural language processor (NLP) to determine whether the user granted or refused consent. The NLP may use the user response, which may include one or more of speech, sign language, and other actions, to determine whether the user granted or refused consent. The NLP may use machine learning to build a consent model that models how a user may grant or refuse consent. The NLP may use the consent model to determine whether the user granted or refused consent. For example, the NLP may generate a list of text strings that correspond to examples of user responses. Some examples may include text strings that indicate the user grants consent. Some examples may include text strings that indicate the user refuses consent. The NLP may compare the user response to the list of text strings and select an example text string that substantially matches the user response. If the user response substantially matches a text string that indicates the user grants consent, the consent input 926 may send a signal to the data storage 932 to record at least part of the call. Additionally or alternatively, if the user response substantially matches a text string that indicates the user refuses consent, the consent input 926 may not send a signal to the data storage 932 to record at least part of the call. For example, if the consent model includes text strings “yes” and “OK” granting consent and text strings “no” and “I do not” refusing consent and the user says or signs “yes,” the NLP may match the user response “yes” to the text string “yes” in the consent model and the consent input 926 may record at least part of the call.

In some embodiments, a user, which may be one or more of the DP 911 and HP 915, may have an account with at least one service provider that provides service associated with one or more components of the environment 910. The service provider may include one or more of a communications provider, sign language interpreting provider, captioning provider, and language translation provider. By setting up the account and agreeing to terms of service, the user may agree to a provision granting consent to record. The account may include a profile, created at the time the user sets up the account or at another time. The profile may include an entry indicating that the user has agreed to the provision or otherwise granted consent to record. In determining whether to record, the consent input 926 may use one or more of the existence of the user's account (which may indicate that the user agreed to grant consent to record) and the entry in the user's profile indicating consent to record.

The consent input 926 may request consent and collect a user response at one or more of before the call, at the start of the call, during the call, at the end of the call, and after the call. The consent input 926 may collect a user response and enable or disable recording for one or more of a single call (e.g., the current call, previous call, or next call), for multiple calls, or for all calls. For example, the consent input 926 may use a response from the user to mark a field in the user's account profile granting or refusing consent for subsequent calls. The consent input 926 may enable the user to grant or refuse consent for certain types of calls such as one or more of calls with one or more specified parties, business calls, residential calls, calls marked as possible spam calls, calls marked as possible fraudulent calls, inbound calls, outbound calls, all calls, and the current call. The consent input 926 may enable a user to revoke consent the user has previously granted.

In some embodiments, the consent input 926 may record at least part of the call before the consent input 926 obtains consent. At a selected time, such as during the call, at the end of the call, or after the call, if the consent input 926 does not obtain consent, the consent input 926 may delete the call recording. For example, the consent input 926 may record the user response to a consent request and at least part of the call. Later, an auditor may review the user response to a consent request and determine whether the user granted or refused consent. The auditor may include one or more of an ASR, ASLR, NLP, human listener, service provider representative, and human sign language interpreter. If the auditor determines that the user refused consent, the call recording may be deleted. If the auditor determines that the user granted consent, the call recording may be retained. The retained recording may be marked as having consent. The retained recording may be transferred to a location designated for recordings where consent has been obtained.

In some embodiments, if the user grants consent, means may be provided to enable the user to access the call recording. Access may include one or more of watching, listening, deleting, forwarding to another person, and downloading. Means to access the call recording may be provided via a web site or via a smartphone app.

An example of the operation of the environment 910 follows. In some embodiments, the interpreter 929 may convert sign language performed by DP 911e to the corresponding spoken, written, or spoken and written language. The HP client 924 may present output of the DP 911e to the HP 915. The spoken language may be generated in the form of one or more of text, script, and audio. The audio may include speech. The speech may include an interpretation of the sign language obtained by the DP client 922e.

The DP client 922e may collect sign language video from the DP 911e and send the video to the interpreter 929. The interpreter 929 may interpret the sign language to generate an output. The output may include one or more of text, script, audio, and video. The interpreter 929 may send the output to the HP client 924. The HP client 924 may present at least part of the output to the HP 915. The HP 915 may type or speak into the HP client 924. The HP client 924 may forward one or more of text and audio from the HP 915 to the interpreter 929. The interpreter 929 may use one or more of text and audio from the HP client 924 to generate sign language video. The interpreter 929 may send the video to the DP client 922e. The DP client 922e may present the sign language video to the DP 911e.

In some embodiments, the DP client 922e and HP client 924 may be geographically separated. The DP client 922e and HP client 924 may be in different cities, for example. The DP client 922e and HP client 924 may communicate with each other and with other components of the environment 910 via the network 923. Additionally or alternatively, the DP client 922e and HP client 924 may be co-located. For example, the DP client 922e and HP client 924 may be in the same room. As another example, the DP 911e and the HP 915 may be visually in sight of each other. Additionally or alternatively, the DP client 922e and HP client 924 may be connected to the same local network 923. Additionally or alternatively, the DP client 922e and HP client 924 may be directly communicatively coupled and may not be communicatively coupled through a network.

The consent input 926a may collect consent from the DP 911e. Collecting consent may include communicating with the DP client 922e. If the DP 911e grants consent, the consent input 926 may record one or more of the DP 911e side of the conversation, the HP 915 side of the conversation, an interpreter, a language translator, and other parties on the call. The determination of which, if any, parties are recorded may depend on one or more of information the consent input 926a collects from the DP 911e, information in a profile configured by DP 911e, information in a profile configured by the HP 915, policies of a service provider providing a service that enables the DP 911e and the HP 915 to communicate, legal conditions for recording call content, legal conditions for using call content to train models, and other factors.

The consent input 926b may collect consent from the HP 915. Collecting consent may include communicating with the HP client 924. Operation, methods, policies, options, and capabilities for enabling the HP 915 to grant or refuse consent may be similar to those described herein in reference to the DP 911e and consent input 926b.

In some embodiments, the operation of the consent input 926a and the consent input 926b may be similar or identical. Additionally or alternatively, the operation of the consent input 926a and the consent input 926b may differ in some respects. For example, the consent input 926a may collect consent via video and the consent input 926b may collect consent via audio. As another example, the consent input 926a may use an ASLR to interpret a sign language response (e.g., one or more performances collected as video) from the DP 911e into a text form and the consent input 926b may use an ASR to convert a voice response (e.g., one or more utterances collected as audio) of the DP 911e into text.

In some embodiments, the determination of whether to record at least part of a call may depend, at least partly, on state laws for one or more calling parties. The law may vary according to a calling party's state. A calling party's state may be determined based on the state where the calling party is located at the time of the call. Additionally or alternatively, a calling party's state may be determined based on the state indicated by a record, such the calling party's account profile, indicating the calling party's address. Additionally or alternatively, a calling party's state may be determined based on the state indicated by the calling party's communication device identifier. In some embodiments, a calling party's communication device identifier may be determined using Caller ID. For example, a calling party's state may be determined based the state associated with the calling party's telephone number, area code, or IP address. Additionally or alternatively, a calling party's state may be determined using an electronic message indicating the calling party's location. The electronic message may be determined using one or more of a GPS capability of the calling party's communication device, the location of the nearest cell tower, cell tower triangulation, assisted GPS (A-GPS), and a message from a communication carrier indicating the communication device's location.

The consent input 926 may use multiple rules to determine whether to record at least part of a call. One or more of the rules may depend, at least partly, on one or more of which calling parties grant consent, which calling parties refuse consent, the laws of each calling party's region (e.g., province or state), national laws and regulations, policies of organizations providing communication service, policies of organizations providing sign language interpreting service, policies of organizations receiving communications service, policies of organizations receiving sign language interpreting service, contractual requirements, and other factors. For example, if an entity such as a business or government organization authorizes recording for employees, the consent input 926 may use the entity authorization in determining whether to record. Entity authorization may be based on employment agreements. For example, the consent input 926 may record calls where at least one employee is a calling party and the employer has authorized recording. As another example, the consent input 926 may record calls where all calling parties are employees of the same employer and the employer has authorized recording. As another example, the consent input 926 may record participants for which consent has been obtained and not record participants for which consent has not been obtained.

In some embodiments, a one-party state may be defined as a state requiring consent from at least one calling party to record. A two-party state may be defined as a state requiring consent from all calling parties to record. In some embodiments, the consent input 926 may record a call if it may legally be recorded, based on one or more of which parties consent, state laws pertaining to one or more calling parties, federal or national laws pertaining to one or more calling parties, and on other laws and regulations such as one or more of FCC regulations, GDPR, CCPA, LGPD, HIPAA, GLBA, the Electronic Communications Privacy Act of 1986 (ECPA), and other privacy laws, policies, and regulations. As an example, if all calling parties are in one-party states and at least one party grants consent, at least part of the call may be recorded. As another example, if at least one calling party is in a one-party state and grants consent, at least part of the call may be recorded. As another example, if at least one calling party is in a two-party state and does not grant consent, the call may not be recorded. As another example, each party who grants consent may be recorded and each party who does not grant consent may not be recorded. For example, if a first party grants consent and a second party does not grant consent, the first party may be recorded and the second party may not be recorded. In some embodiments, the consent input 926 may request consent from all calling parties on a call. Additionally or alternatively, the consent input 926 may request consent from at least one calling party and may not request consent from at least one calling party. For example, the consent input 926 may request consent from all calling parties in two-party states and not from calling parties in one-party states, with the constraint that the consent input 926 may request consent from at least one calling party. In some embodiments, if a participant associated with a one-party state grants consent, the consent input 926 may record all parties.

In some embodiments, if one or more of sign language interpreters or spoken language translators are on a call and the consent input 926 determines that recording is permitted based on one or more of laws, consent (e.g., consent from calling parties other than the one or more of interpreters and translators), and other factors, the consent input 926 may record one or more of the sign language interpreters and spoken language translators. Additionally or alternatively, the consent input 926 may collect consent from the interpreters or translators.

In some embodiments, the consent input 926 may determine whether a calling party is of legal age. In determining whether the calling party is of legal age, the consent input 926 may request and collect input from the calling party using methods analogous to those described herein for collecting consent. The legal age determination may be responsive to one or more of national law, state law, the calling party's age, and an estimate of the calling party's age. The determination of whether a calling party is of legal age may be determined by one or more of asking the calling party to indicate whether the calling party is at least a specific age and asking the calling party to indicate whether the calling party is of legal age. Legal age may be the age at which a calling party may legally consent to recording. Legal age may be a specified age such as 12, 13, 14, 15, 16, 17, 18, 19, 20, or 21. Additionally or alternatively, determination of whether a calling party is of legal age may use one or more of voice analysis and image analysis. The consent input 926 may collect consent from the calling party. Additionally or alternatively, the consent input 926 may collect consent from a parent or legal guardian on the calling party's behalf. If a calling party is determined to be of legal age and grants consent to record, the calling party may be recorded. If a calling party is determined not to be of legal age, the calling party may not be recorded. If a calling party is determined not to be of legal age and grants consent to record, the determination of whether to record may be made as if the calling party had not granted consent. If a calling party is determined not to be of legal age and a parent or legal guardian grants consent on the calling party's behalf, the consent input 926 may record the calling party.

Other combinations of state laws and consent by various calling parties and corresponding rules used by the consent input 926 are anticipated within the scope of the present disclosure. In determining whether to record, the consent input 926 may use other criteria in addition to consent and legal requirements. Other criteria may include one or more of whether the data storage 932 has sufficient bandwidth and memory space to record, whether one or more calling parties meet certain specified requirements such as requirements pertaining to one or more of gender, age, demographics, language, accent, quality of audio, and quality of video. Other criteria may include selecting a random, periodic, or other subset of calls to record, such as using a rule to record a specified percentage of calls.

When the consent input 926 records call content, a visual indicator such as a red dot, a text indicator such as “recording,” “REC,” or a text message such as “this call is being recorded” may be presented on one or more of the DP client 922e display, the HP client 924 display, and the agent client 237 of FIG. 2. Additionally or alternatively, when the data storage 932 records call content, an audible indicator such one or more beeps or an announcement such as “this call is being recorded” may be played on one or more of the DP client 922e speaker and HP client 924 speaker.

In some embodiments, call content may be redacted to remove protected information, before storing call content in the data storage 932. Additionally or alternatively, call content may be stored in the data storage 932, read from the data storage 932, redacted, and rewritten into the data storage 932. Protected information may include one or more of personal information, sensitive information, private information, confidential information, biometric information, and personally identifiable information (PII). Protected information may be identified using one or more of keyword spotting applied to text such as a text transcript, natural language processing trained to identify protected information, and indications from one or more of the calling parties and the application 931.

In some embodiments, a user client may record at least part of the call. The user client may include one or more of the DP client 922e and the HP client 924. The user client may save the recording in a location that is not accessible by the data storage 932. The location may include the user client. The user may elect to send the recording to the data storage 932. In sending the recording to the data storage 932, the user may use one or more of the user client or a web site. If the user uses the user client to elect to send the recording to the data storage 932, the user client may provide the recording to the data storage 932. If the user does not elect to send the recording to the data storage 932, the user client may not provide the recording to the data storage 932. Additionally or alternatively, the location that is not accessible by the data storage 932 may include an ASLR model builder such as one or more of the trainer 927 and the ASLR model builder 395 of FIG. 3. The trainer 927 may use the recording to build one or more ASLR models.

In some embodiments, the user client may include a subset of the functionality of the ASLR model builder. The user client may record content from at least part of a call. The user client may use the recording of at least part of a call to train a model. Additionally or alternatively, the user client may receive a set of parameters from the ASLR model builder. The set of parameters may include at least a portion of one or more ASLR models. The user client may use the recording to modify at least some parameters from the set of parameters. The user client may send at least some of the modified parameters to the ASLR model builder. The ASLR model builder may use the modified parameters from the user client to build one or more ASLR models. The ASLR model builder may receive and use modified parameters from multiple user clients to build one or more ASLR models. By distributing the work of building ASLR models across multiple user clients, the ASLR model builder may train ASLR models on call content without uploading call content. For example, the ASLR model builder may distribute a master ASLR model to multiple user clients. Each user client may use call content to update its copy of the master ASLR model to create an updated ASLR model. Multiple user clients may each upload their respective updated ASLR models to the ASLR model builder. The ASLR model builder may combine the updated ASLR models to update the master ASRL model. For example, the ASLR model builder may average the updated ASLR models from the user clients to form a composite ASLR model. The ASLR model builder may use a weighted average of the composite ASLR model and the previous master ASLR model to create a new master ASLR model.

Modifications, additions, or omissions may be made to the environment 910 and/or the components operating in the environment 910 without departing from the scope of the present disclosure. For example, in some embodiments, the environment 910 may include any number of other components that may not be explicitly illustrated or described. Further, depending on certain implementations, the environment 910 may not include one or more of the components illustrated and described. For example, in some embodiments, the data storage 932 may be omitted. As another example, in some embodiments, one or more of the consent input 926a and consent input 926b may be omitted. As another example, the operations performed by components operating in the environment 910 may be distributed among multiple devices and/or systems such as remote servers. As another example, some components operating in the environment 910 may be combined into fewer components. For example, in some embodiments, one or more of the interpreter 929, the data storage 932, and the consent input 926 may be combined into one component.

An example of the operation of the environment 920 follows. In some embodiments, components of the environment 920 may enable two or more signing parties, e.g., the DP 911a and DP 911b, to communicate in sign language via video. Additionally or alternatively, components of the environment 920 may enable one or more signing parties to communicate with the application 931. The application 931 may provide a service for a business such as a medical service provider, financial institution, government agency, contact center, online ordering service, or retail establishment. In some embodiments, the application 931 may include one or more of an HP, an IVR system, a voicemail system, a sign mail system, a chat service, an application, a data collection system, a business agent, a sales agent, a customer care agent, a call center agent, a language translation service, a human language translator, a web site, a dictation system, a dialog engine, an ASR, a TTSS, a user identification system, a billing system, one or more information sources such as one or more of weather, traffic, and news sources, an audio editing system, and a video editing system. In some embodiments, the HP may be analogous to the HP 915.

In some embodiments, the application 931 may include an IVR system. The application 931 may include an audio interface that plays prompts and collects audio input via one or more of voice, sign language, button presses, screen clicks, and touch-tones. The interpreter 929 may enable a DP 911 and the application 931 to communicate by converting a spoken form to sign language and sign language to a spoken form. The conversion may use one or more of an ASLR and an ASLS. The DP may include one or more of the DP 911a and the DP 911b. The application 931 may provide the ASLR with vocabulary such as one or more of a transcript of prompts played by the application 931, words likely to be spoken to the application 931, and phrases likely to be spoken to the application 931. The ASLR may use the vocabulary provided by the application 931 to convert sign language to text, such as by one or more of adding the vocabulary to the ASLR vocabulary and increasing the weight or likelihood of words or signs in the ASLR recognition vocabulary. Additionally or alternatively, the application 931 may include a video interface that communicates in sign language with a DP.

In some embodiments, the application 931 may include one or more of a voicemail or sign mail system. An HP may leave a voicemail message. The message may be stored in the data storage 932. The interpreter 929 may convert the voicemail message to sign language and send it to the DP client 922a. The DP 911a may watch the message in sign language on a display. Additionally or alternatively, the DP 911a may leave a sign mail message, which may be a video message that includes sign language. The interpreter 929 may convert the sign mail to a message in one or more of audio and text. An HP may do one or more of listening to the audio message and reading the text message. Additionally or alternatively, the DP 911a may use the DP client 922a to leave a sign mail message and the DP 911b may watch the sign mail message using the DP client 922b.

The chat service may include one or more of human agents and automated chatbots. The chat service may include a text interface. The text interface may communicate by receiving and generating text. The interpreter 929 may convert text generated by the chat service into sign language video. Additionally or alternatively, the chat service may play one or more pre-recorded sign language videos. One or more pre-recorded sign language videos may be sent to the DP client 922a and presented on a display to the DP 911a. A camera in the DP client 922a may capture sign language video from the DP 911a and send the sign language video to the interpreter 929. The interpreter 929 may convert the sign language video to text. The interpreter 929 may use the text to communicate with the application 931 (which may include a chat service). For example, the interpreter 929 may send the text to the chat service. The chat service may respond to text from the interpreter 929 by generating a text response. Additionally or alternatively, the interpreter 929 may use a TTSS to convert the text to voice. Additionally or alternatively, the interpreter 929 may convert the text converted from sign language into touch tones or into other forms of electronic messages. The interpreter 929 may send one or more of the text, voice, touch tones, and other forms of electronic messages to the application 931.

The application 931 may engage the DP 911a in a conversation. The conversation may include a series of turns where the DP 911a signs, the interpreter 929 converts the signs into text and sends the text to the application 931, the application 931 generates a text response, the interpreter 929 converts the text response into sign language video, the DP client 922a presents the sign language video to the DP 911a, the DP 911a signs a response, and so on. The conversation may begin with the DP 911a. Additionally or alternatively, the conversation may begin with the application 931.

In some embodiments, the application 931 may include a data collection system and may collect data from the DP 911a. For example, the application 931 may use the interpreter 929 and DP client 922a to present a first video to the DP 911a. The first video may include sign language. The sign language may be one or more of a question, an answer to a question, a request from the application 931 for the DP 911a to provide information, a request from the application 931 for the DP 911a to perform spontaneous discourse, a sign language interpretation of text provided to the DP 911a, and a turn in a conversation between the DP 911a the application 931. The DP client 922a may collect a second video from the DP 911a. The interpreter 929 may convert the second video to interpreted text. One or more of the second video and the interpreted text may be recorded by one or more of the data storage 932 and the application 931. The recording may be used for one or more of training an ASLR, training an ASR, marketing, and sales.

In some embodiments, the application 931 may include a business agent. The business agent may include one or more of a human agent and an automated agent. The automated agent may communicate using one or more of sign language, text such as instant messaging, touch-tones, audio, and ASR. The business agent may use a client for communicating with one or more of the DP client 922a and the DP client 922b. The business agent may have access to account information of the DP 911a. The business agent may be an agent in a call center and may be associated with a client. The client may enable the agent to perform duties associated with call center agents, including one or more of selling products, managing accounts, collecting money to pay bills, product ordering, providing information such as product and account information, performing customer service, executing financial transactions, and processing refunds. The business agent may perform language translation. The language translation may be performed by one or more humans, one or more machines, or a combination thereof. The business agent may act as one or more of a sales agent, a customer care agent, a call center agent, a captioning agent, an interpreter, and a language translator.

In some embodiments, the application 931 may include a user identification system. The user identification system may determine, confirm, or determine and confirm the identity of a person such as one or more of the DP 911a, the DP 911b, and a HP. In confirming, determining, or confirming and determining the person's identity, the user identification system may use one or more of a voice sample from the person, an image of the person's face, a fingerprint, a reading of the person's hand geometry, a retinal scan, and one or more other biometric readings from the person.

In some embodiments, the application 931 may include one or more of a billing system, a user registration system, and an information source that may include one or more of news, weather, sports, horoscope, and financial market information. For example, the application 931 may collect user information from a user and use it to create or update an account for the user. The user information may include one or more of the user's name, address, account number, social security number, device identifier such as a telephone number, gender, language, billing information such as a credit card number, and hearing status. The hearing status may include one or more of hearing, hard of hearing, deaf, hard of hearing in need of text-based accommodations such as call captioning, and deaf in need of sign language interpreting. The application 931 may collect consent to provide a service such as an assistive service including one or more of call captioning and sign language interpreting. In some embodiments, the application 931 may collect an agreement from the user on payment terms for a service.

Additionally or alternatively, the application 931 may track billing information based on services used by the user. The billing information may include one or more of the amount of time used, the type of service used, and a billing rate. The billing rate may vary in response to one or more of the volume of minutes used by at least one caller, whether the call is subsidized by a government agency, whether the call is subsidized by a non-government entity, call variables, call type, whether the call is high-priority, and the account type of at least one caller. In some embodiments, the billing rate may vary in response to whether the call is interpreted by a human or by an automated system. For example, the billing rate may be greater for a human interpreter than for a machine-based interpreter. As another example, if a call is interpreted partly by machine and partly by a human interpreter, a first billing rate may apply to one or more portions of the call interpreted by machine and a second billing rate may apply to one or more portions of the call interpreted by a human. For example, if an ASLS is used for interpreting voice to sign and a human is used to interpret sign language to voice, a first billing rate may apply when the ASLS interprets a spoken form to sign language, and a second billing rate may apply when the human interprets sign language to a spoken form. In some embodiments, one or more of the first and second billing rates may be free. In another example, lower-priority calls such as a call between residences may use an ASLR and may incur charges at a first rate and high-priority calls such as medical calls may use a human interpreter and may incur charges at a second rate. The billing rate may vary in response to a supply and demand pricing schedule. The pricing schedule may be responsive to how many human interpreters are available. The billing rate may vary based on the financial status of one or more of the callers. The billing rate may vary in response to whether one or more of the callers is certified as eligible to use the service at a specific rate such as free. For example, if one or more of the callers is one or more of registered in the Telecommunications Relay Service-User Registration Database (TRS-URD) and meets specified requirements such as having a documented need for an assistive service, the billing rate may be one or more of discounted or free.

The billing information may be used to generate an invoice. The invoice may include information such as one or more of the identity of the caller, the caller's registration number, at least part of the caller's social security number, an identifier for the caller's communication device, the amount due, a payment due date, a time frame for which services were or will be provided, one or more billing rates, at least some of the billing information, and at least some of the user information. The application 931 may send an invoice to one or more of the user and a third party. The application 931 may collect payment from one or more of the user and the third party. Additionally or alternatively, the application 931 may send an invoice to one or more of the user and the third party. The third party may be a government agency such as the FCC. Additionally or alternatively, if a caller is not registered in the TRS-URD, the invoice may be sent to the caller for payment. If the caller is registered in the TRS-URD, the invoice may be sent to a government entity such as the FCC or a government affiliate for payment.

In some embodiments, the application 931 may include one or more games. The one or more games may interact with the DP client 922 and may allow the DP 911 to play games. The application 931 may include means for paying the DP 911 for game usage or charging and collecting fees from the DP 911 for game usage. The games may collect data such as one or more of audio, video, and text. The application 931 may save the data in the data storage 932. The data may be used for one or more of sales, marketing, research, developing ASLS, and developing building ASRL. The data may be used to build ASLR models.

In some embodiments, the application 931 may include logic for tutoring a student on topics such as one or more of sign language, reading, learning a new language, writing, math, history, computer science, typing, a foreign languages, and science. The tutoring may be conducted at least partly in sign language. The application 931 may collect a phrase from the student and perform the corresponding signed phrase in sign language. The phrase may include one or more words or one or more signs. The application 931 may present a signed phrase on a display for the student and ask the student to speak or type the corresponding phrase. The application 931 may present a phrase to the student and ask the student to perform the corresponding signed phrase. The application 931 may use an ASLR to determine whether the student correctly performed the signed phrase. The application 931 may provide feedback to the student. The feedback may include one or more of advising the student whether the student signed the phrase correctly, presenting a video of how the phrase may be signed, verbal instructions played using a speaker, text instructions shown on a display, and asking the student to try again. The application 931 may use the interpreter 929 to generate sign language for the student. Additionally or alternatively, the application 931 may use the interpreter 929 to understand sign language performed by student. The application 931 may record video of the student performing sign language in the data storage 932. Video recorded from the student may be used to train ASLR models.

In some embodiments, the application 931 may act as a sign language dictionary. For example, the application 931 may collect input in a spoken form from a user such as a spoken or typed phrase, retrieve or generate a video of a signed phrase corresponding to the spoken or typed phrase, and present the video to the user. Additionally or alternatively, the application 931 may act as a reverse sign language dictionary. For example, the application 931 may collect video of signed input from a user and use an ASLR to convert the signed input to one or more of one or more of written text (e.g., using a display) or spoken words (e.g., using a speaker).

In some embodiments, the application 931 may act as a sign language translator. For example, the DP client 922a may collect a sign or phrase video in a first language from the DP 911a. The application 931 may instruct the video to be sent to the interpreter 929. The interpreter 929 may convert the video into text in a first language. The application 931 may translate the text into a second language. The application may perform language translation using a language translator such as the translator 936a of environment 940. An SLSS may convert the text in the second language to video using the interpreter 929. The DP client 922b may present the video to the DP 911b.

In some embodiments, the application 931 may enable the components of the environment 920 to operate as a dictation system. A user, such as one or more of a DP or HP, may provide content that may include one or more of a voice sample, a video sample, and a text sample. The data storage 932 may record the content. The content may be converted to text. The text may be stored in the data storage 932. The content may be translated from a first spoken or signed language to a second spoken or sign language. The application 931 may enable the user to manipulate the content. Manipulating the content may include one or more of retrieving (e.g., viewing, listening, downloading), deleting, and editing the content. The content may be used to build one or more of ASR models, ASLR models, ASLS models, TTS models, language models, language translation models, voiceprints, speaker identification models, speaker verification models, and face identification models. The language translation models may include models for conversion of one or more of gloss to script, script to gloss, and spoken form in a first language to spoken form in a second language.

In some embodiments, the application 931 may include a web site. The web site may be accessible via one or more of the HP client 924 of the environment 910, the DP client 922a, and the DP client 922b. The web site may provide content to one or more of the HP client 924, DP client 922b, and DP client 922b. The web site may collect content from one or more of the HP client 924, DP client 922b, and DP client 922b. The content may include one or more of audio, video, text, timestamps, and labels. In some embodiments, the DP client 922a may collect sign language video from the DP 911a. The interpreter 929 may convert the video to information such as one or more of text, mouse clicks, and gestures and send the information to the web site. Additionally or alternatively, the web site may send information such as one or more of images, video, and text to one or more of the interpreter 929 and the DP client 922a. The interpreter 929 may convert the text to sign language video and send the sign language video to the DP client 922a. The DP client 922a may present one or more of the information from the web site and the sign language video to the DP 911a.

In some embodiments, the application 931 may enable a human labeler to edit recorded video. The application 931 may retrieve video from the data storage 932 for editing and may save the edited video in the data storage 932. The human labeler may edit the recorded video using one or more of the HP client 924, DP client 922a, and DP client 922b. Editing video may include one or more of marking timestamps, marking sign endpoints, providing labels, tagging segments of video as usable or not usable for building a model, extracting video segments, rearranging video segments, and deleting video segments. Labels may include one or more of names of signs, glosses, script, interpretation into gloss, interpretation into script, timestamps, sign endpoints, subsign endpoints, and comments. The application 931 may provide video to the DP client 922a. The DP client 922a may enable the human labeler to view and edit the video. For example, the human labeler may use the DP client 922a to label signs in gloss and mark sign endpoints. The editor may enable a human labeler to find and edit content previously created.

One or more of the consent inputs 926c and 926d, may collect consent from one or more of the DP 911a and DP 911b, respectively. The consent input 926c may collect consent from the DP 922a. In some embodiments, the consent input 926c and consent input 926d may operate in a manner analogous to the consent input 926a and consent input 926b of environment 910. The operation of the consent input 926c and consent input 926d may be analogous to the operation of the consent input 926a and consent input 926b of environment 910.

The application 931 may record content from a calling party (e.g., DP 911a, DP 911b, HP) who grants consent. The application 931 may not record content from a calling party who does not grant consent. For example, if the DP 911a grants consent, the DP client 922a may collect video from the DP 911a and send the video to the application 931. The application 931 may save the video in the data storage 932. If the DP 911a does not grant consent, the DP client 922a may not collect video from the DP 911a. Additionally or alternatively, if the DP 911a does not grant consent, the application 931 may not save the video. As another example, if the HP grants consent, the HP client 924 of environment 910 may collect audio from the HP and the application 931 may save the audio in the data storage 932.

Additionally or alternatively, if the DP 911a does not grant consent, the application 931 may record video from the DP client 922a and may not record audio from the DP client 922a. If neither the DP 911a nor the DP 911b grants consent, the application 931 may record video from one or more of the DP client 922a and the DP client 922b and may not record audio from either DP client 922. If the DP 911a grants consent and the DP 911b does not grant consent, the application 931 may record audio and video from the DP client 922a, may record video from the DP client 922b, and may not record audio from the DP client 922b.

An example of the operation of the environment 930 follows. In some embodiments, the DP/HP client 941 is configured to enable the DP 911 and the HP 915 to communicate. The DP/HP client 941 may include at least some of the functionality of the DP client 922e and HP client 924 of the environment 910. The DP/HP client 941 may collect sign language video from a DP 911 and send the video to an interpreter 929. In some embodiments, the interpreter 929 may be remote from the DP/HP client 941 and may be accessed via the network 923. Additionally or alternatively, the DP/HP client 941 may include the interpreter 929. For example, the DP/HP client 941 may include a tablet or smartphone and the interpreter 929 may be an app running on the tablet or smartphone. The interpreter 929 may convert the sign language video to a spoken form and send the spoken form to the DP/HP client 941. The DP/HP client 941 may present the spoken form to the HP 915. The DP/HP client 941 may include one or more of an application, a smartphone, a tablet computer, a laptop, a desktop computer, a camera, a microphone, a speaker, a display, a keyboard, a touchpad, a Braille display, a Braille keyboard, and a mouse. The components of the environment 930 may enable a DP to communicate with an HP in physical proximity to the DP.

In some embodiments, the DP/HP client 941 may include a wearable device. For example, the DP/HP client 941 may be included with or attached to one or more of a pair of glasses, belt, strap, clothing, suspenders, or accessories such as a necklace, brooch, bracelet, wristband, hat, watch, headband, headset, or one or more earbuds. The DP/HP client 941 may be communicatively coupled with a wireless communication device such as a smartphone. The wireless communication device may provide communication access to one or more of the network 923, computing resources, models, a dialog system, a website, software, and data storage. For example, the DP/HP client 941 may send sign language video to a smartphone. The smartphone may convert the sign language video to a spoken form and may send the spoken form to the DP/HP client 941 where the spoken form may be presented to the HP 915. Additionally or alternatively, the smartphone may send the sign language video via the network 923 to the interpreter 929. The interpreter 929 may convert the sign language video to the spoken form and send the spoken form via the network 923 and the smartphone to the DP/HP client 941 where the spoken form may be presented to the HP 915.

In some embodiments, components of the environment 930 may enable communication between a DP 911 and HP 915 who are in physical proximity to each other, such as face to face or in the same room. Additionally or alternatively, components of the environment 930 may enable communication between a DP 911 and HP 915 who are in communication via an audio connection such as a telephone or via an audio/video connection such as a video phone or audio/video communication software such as one or more of Zoom, Microsoft Teams, Skype, Webex, or FaceTime. For example, the DP/HP client 941 may include both the interpreter 929 (or a network connection to the interpreter 929) and a communication client. The DP may communicate using the DP/HP client 941 and an HP may communicate using a remotely-located device that communicates with the DP/HP client 941 over the network 923. In some embodiments, one or more of the components of the environment 930 may be integrated into the wireless communication device.

In some embodiments, the DP/HP client 941 may determine the location of a signer such as the DP 911. The location may be determined by analyzing video from a camera included in the DP/HP client 941 to detect motion that resembles sign language. The DP/HP client 941 may use the location of the signer to direct the camera to capture video from the signer. For example, the camera may change the viewing field. Changing the viewing field may include one or more of rotating, panning up or down, panning left or right, and zooming in or out. Changing the viewing filed may including one or more of digitally processing the image from the camera and using mechanical devices such as motors to adjust optics. Optics may include one or more of lenses and mirrors. Video captured in the viewing field may be sent to the interpreter 929.

In some embodiments, one or more components of the environment 930 may be integrated into a wearable device. The DP/HP client 941 may be configured as a wearable device with a camera configured to collect video from the DP 911. For example, a camera attached to a pair of glasses or another wearable device may be configured to capture video of the hands and arms of the DP 911. In some embodiments, the DP 911 may wear the wearable device. The DP/HP client 941 may send the video to an interpreter 929. The interpreter 929 may convert the video to speech and play the speech using a speaker. Additionally or alternatively, the DP/HP client 941 may collect audio from an HP and send the audio to the interpreter 929. The interpreter 929 may convert the audio to one or more of sign language or text, which may be displayed in the glasses and may be visible to the DP 911.

In some embodiments, the DP/HP client 941 may include a hand sensor such as one or more of a ring, watch, glove, and wristband containing one or more of one or more cameras, one or more position sensors, and one or more accelerometers. The DP 911 may wear a hand sensor on one or both hands or arms. One or more signals from the one or more hand sensors may be sent to the ASLR. The ASLR may use the one or more signals as input features. The ASLR may use the one or more of signals and video from a wearable device to generate one or more of text, script, audio, and speech.

In some embodiments, the DP/HP client 941 may collect audio from the HP 915. The audio may be converted to text using an ASR. The text may be displayed on a wearable device such as glasses. Additionally or alternatively, the text may be converted to sign language video using an ASLS and displayed on a wearable device such as glasses.

Sign language video may be collected from one or more of multiple perspectives. Sign language video collected from a first perspective, such as from a wearable device worn by the DP 911, may appear different from that of sign language video collected from a second perspective, such as from a camera facing the DP 911. The interpreter 929 may be configured to use a first one or more ASLR models when receiving video from the first perspective and to use a second one or more ASLR models when receiving video from the second perspective. For example, an ASLR may use a first optic model when receiving video from a wearable device such as glasses worn by the DP 911 and may use a second optic model when receiving video from a camera facing the DP 911. The first optic model may be trained using video collected from the perspective of the wearable device. The second optic model may be trained using video collected from a camera facing the DP 911. In some embodiments, the ASLR may use the same language model and gloss-to-script translation model for two or more of the camera's perspectives. Additionally or alternatively, the ASLR may include a neural network with multiple sections. One or more sections may include weights that remain substantially constant across multiple camera perspectives. One or more sections may use a different set of weights for different perspectives. For example, one or more sections may use a first set of weights for the first perspective and a second set of weights for the second perspective.

In some embodiments, a wearable device may collect audio from an HP 915 using one or more microphones. The audio may be sent to an ASR and converted to text to be presented to the DP 911. The wearable device may display the text for the DP 911. Additionally or alternatively, the text may be sent to an ASLS. The ASLS may convert the text to sign language. The sign language may be displayed on the wearable device and presented to the DP 911. The one or more microphones may be directional so that speech from the HP 915 is louder than sounds from at least some other directions. The directional behavior of the one or more microphones may be provided by a beamformer. In some embodiments, the beamformer may be directed in the direction that a wearable device such as a pair of glasses is facing. Additionally or alternatively, the beamformer may select a direction based on where the DP 911 is looking. For example, if the DP is wearing glasses that include one or more cameras, where one or more cameras capture one or more images of the DP's eyes, the one or more corresponding images may be processed to determine where the DP is looking and direct the beamformer in the same direction. Additionally or alternatively, the ASR may combine the video signal of the mouth of the HP 915 with the audio signal from the one or more microphones to determine what the HP 915 is saying. The ASR may extract features from the video signal of the mouth of the HP 915 and use the features in recognizing the speech of the HP 915.

In some embodiments, the components of the environment 940 may enable two signing calling parties who use different sign languages to communicate. For example, the DP 911a may sign in ASL and the DP 911b may sign in BSL. An example of the operation of the environment 940 follows. The DP client 922c may collect video including a first sign language from the DP 911a and send the video including a first sign language to the ASLR 933a. The ASLR 933a may convert the video including a first sign language to script in a first language and send the script to the translator 936a. The translator 936a may convert the script in a first language to script in a second language and send the script in the second language to the ASLS 935a. The ASLS 935a may convert the script in the second language to video including a second sign language and send the video including the second sign language to the DP client 922d. The DP client 922d may present the video including the second sign language to the DP 911b. As an example, the DP 911a may sign in LSM and the DP 922d may sign in ASL. The DP client 922c may collect LSM video. The ASLR 933a may convert LSM video to Spanish script. The translator 936a may convert Spanish script to American English script. The ASLS 935a may convert American English script to ASL video. The DP client 922d may display the ASL video to the DP 911b.

Additionally or alternatively, the DP client 922d may collect video in a second sign language from the DP 911b. The ASLR 933b, translator 936b, ASLS 935b, and DP client 922c, respectively, may convert the second sign language to script in a second language, then to script in the first language, and then to the first sign language, and present the first sign language to the DP 911a.

In some embodiments, the ASLR 933a may generate script and the translator 936a may convert script in a first language to script in a second language. The translation of script may use text translation methods such as transformers trained on parallel script corpora. Additionally or alternatively, the ASLR 933a may generate gloss and the translator 936a may convert gloss in the first language to gloss in the second language. The translator 936a may use a translation method trained on parallel gloss corpora. Additionally or alternatively, the ASLR 933a and the ASLS 935a may convert sign language video directly to a different sign language. For example, ASLR 933a and the ASLS 935a may be combined into a component that converts video in the first sign language into video in the second sign language. The component may use an attention transformer, trained on sign language video in the first and second languages, to perform the direct video conversion. In this example, the ASLR 933a may not generate script or gloss.

Modifications, additions, or omissions may be made to one or more of the environments 910, 920, 930, and 940 and the components operating in one or more of the environments 910, 920, 930, and 940 without departing from the scope of the present disclosure. For example, in some embodiments, the environments 910, 920, 930, and 940 may include any number of other components that may not be explicitly illustrated or described. As another example, in some embodiments, some components in the environments 910, 920, 930, and 940 may be omitted. As another example, in some embodiments, some components in the environments 910, 920, 930, and 940 may be combined or distributed among multiple devices and/or systems such as remote servers.

As another example, in environment 920, the application 931 may be communicatively coupled to one or more of the DP clients 922a and 922b, may be in physical proximity (such as in the same room) to one or more of the DP clients 922a and 922b, and may not be communicatively coupled via the network 923. As another example, one or more operations performed by one or more of the interpreter 929, trainer 927, data storage 932, application 931, consent input 926, translator 936a, ASLR 933a, and ASLS 935a may be incorporated into one or more of the DP client such as the DP client 922a or the DP client 922b and an HP client such as the HP client 924.

In another example, in some embodiments, the network 923 may be omitted. In these and other embodiments, signals may be communicated between components through one or more of other networks, connections such as infrared, Bluetooth, wired connections, or other communication methods. Additionally or alternatively, signals between some components may be communicated via the network 923 and signals between other components may not be communicated via the network 923.

As another example, in some embodiments, the application 931 may send billing invoices, collect payments, or both. Additionally or alternatively, the application 931 may generate billing information and send the billing information to one or more of a payment invoicing system and a payment collection system.

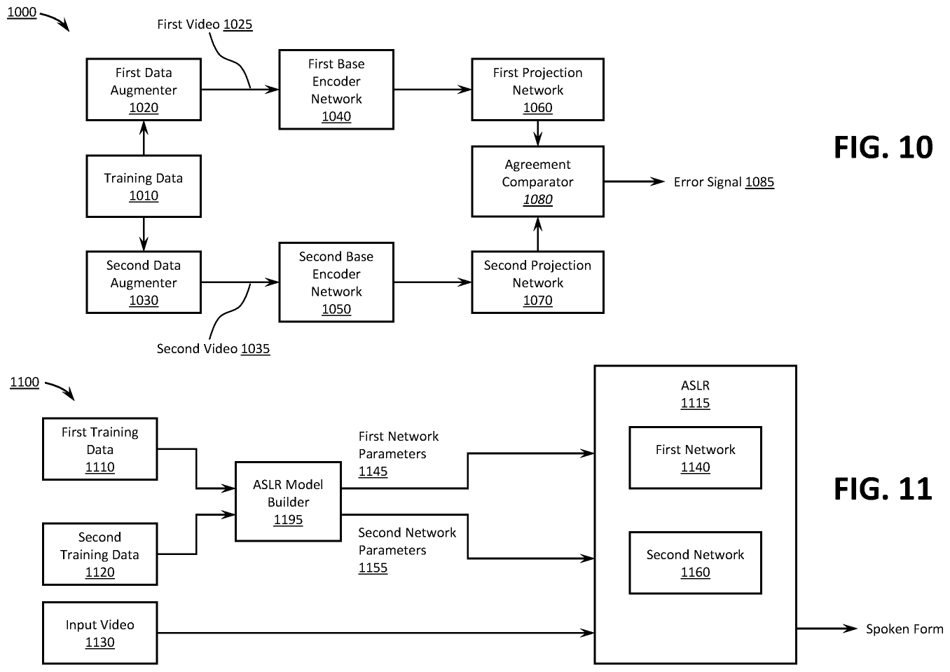

FIG. 10 illustrates an example environment 1000 for training a network such as a neural network. The environment 1000 may include training data 1010, a first data augmenter 1020, a second data augmenter 1030, a first base encoder network 1040, a second base encoder network 1050, a first projection network 1060, a second projection network 1070, an agreement comparator 1080, a first video 1025, a second video 1035, and an error signal 1085. The first video 1025 and second video 1035 may each include one or more video samples. The video samples may each include a sequence of one or more images. The video samples may include one or more of one or more humans and one or more machines performing sign language. A machine may include a computer running software. For example, the first video 1025 and the second video 1035 may each include an image sampled from a video showing sign language. As described below, the first video 1025 and the second video 1035 may include different transformations of the same image or different images from similar scenes. The components of the environment 1000 may train a first base encoder network 1040 to learn visual representations of sign language. In some embodiments, the environment 1000 may use contrastive learning to train one or more of the first base encoder network 1040.

In some embodiments, the training data 1010 may be augmented by the first data augmenter 1020 to generate the first video 1025. The training data 1010 may be augmented by the second data augmenter 1030 to generate the second video 1035. Augmenting the training data 1010 may include transforming the image. Transforming the image may include one or more of converting the image to grayscale, converting the image to black and white, zooming in or out, rotating, quantizing brightness values, quantizing color values, adjusting brightness up or down, adjusting contrast up or down, adjusting the gamma, adjusting color saturation up or down, horizontal flip, vertical flip, horizontal shear, vertical shear, diagonal shear, cropping, resampling, scaling, leaving the image as-is, adding noise, adding Gaussian noise, smoothing, blurring, adding Gaussian blur, sharpening, Sobel filtering, high-pass filtering, inverting brightness values (e.g., making the image look like a negative), swapping or copying brightness across color channels (e.g., turning the blue channel green and the green channel blue), low-pass filtering, adding objects to the image, removing objects from the image, applying a linear filter, adding jitter, adding color distortion, changing the aspect ratio, stretching or compressing the image in at least one direction, deleting part of the image, obscuring part of the image, encoding the image, and changing one or more of the brightness, contrast, and saturation of one or more color or grayscale channels. Encoding the image may include one or more of using data rate compression and reducing the bit rate or file size or both.

The first data augmenter 1020 and the second data augmenter 1030 may apply different transformations. For example, an image from the training data 1010 may be left as-is by the first data augmenter 1020 and the second data augmenter 1030 may apply a transformation, such as converting the image to grayscale. As another example, the second data augmenter 1030 may generate a second video 1035 using a generative network such as a GAN.

In some embodiments, the first video 1025 and the second video 1035 may each include different transformations of the same image. Additionally or alternatively, the first video 1025 and the second video 1035 may each include different images that feature a common characteristic. For example, the common characteristic may be that each image may show approximately the same position and point in time of a sign from two different performances. For example, each image may each be sampled from a different frame in the same video sequence or from a different video sequence. For example, a first video sequence showing a person performing a sign may be aligned with a second video sequence of a different person performing the same sign or the same person performing the same sign at a different time. The alignment may synchronize the two sequences so that the signs are performed at substantially the same time. The first video 1025 may include an image taken from the first video sequence and the second video 1035 may include an image taken from the second video sequence at substantially the same point in the sign performance.

The first video 1025 may be sent to a first base encoder network 1040. The output of the first base encoder network 1040 may be sent to the first projection network 1060. The second video 1035 may be sent to a second base encoder network 1050. The output of the second base encoder network 1050 may be sent to the second projection network 1070.

The agreement comparator 1080 may use the output of the first projection network 1060 and the output of the second projection network 1070 to determine an error signal 1085. For example, the error signal 1085 may include the summed absolute difference between the output of the first projection network 1060 and the output of the second projection network 1070. The error signal 1085 may include a contrastive loss function. The error signal 1085 may be larger when the outputs of the first projection network 1060 and the second projection network 1070 are different than when the two outputs are similar. The error signal 1085 may be used to train one or more of the first base encoder network 1040, the second base encoder network 1050, the first projection network 1060, and the second projection network 1070. The training may include adjusting weights in one or more of the first base encoder network 1040, second base encoder network 1050, first projection network 1060, and second projection network 1070 to minimize the error signal 1085.

Additionally or alternatively, the networks in environment 1000 may train on negative pairs. A negative pair may include an image from the first video 1025 that is substantially different from the image provided by the second video 1035. A negative pair may be selected to be substantially different by including one or more of images of different sign language signs, images with different labels, a person performing sign language in the first video 1025 and a person not performing sign language in the second video 1035, and a first object such as a car in the first video 1025 and a second object such as a tree that is unrelated to the first object in the second video 1035. The first video 1025 and the second video 1035 may each include images showing substantially different scenes and the training may include adjusting weights to maximize the error signal 1085.

In some embodiments, one or more of the first base encoder network 1040, the second base encoder network 1050, the first projection network 1060, and the second projection network 1070 may include one or more neural networks. In some embodiments, the first base encoder network 1040 and the second base encoder network 1050 may include one or more of substantially identical topologies, substantially identical structures, and substantially identical parameters such as neural network connection weights. Additionally or alternatively, the first projection network 1060 and the second projection network 1070 may include one or more of substantially identical topologies, substantially identical structures, and substantially identical parameters such as neural network connection weights. In some embodiments, adjustments to parameters in one base encoder network made during training may be made to corresponding parameters in the other base encoder network so that parameters in the first base encoder network 1040 may be held at substantially the same values as corresponding parameters in the second base encoder network 1050. In these and other embodiments, the first base encoder network 1040 parameters may be substantially identical to the corresponding parameters in the second base encoder network 1050. Additionally or alternatively, adjustments to parameters in one projection network made during training may be made to parameters in the other projection network so that parameters in the first projection network 1060 may be held at substantially the same values as corresponding parameters in the second projection network 1070. In these and other embodiments, the first projection network 1060 parameters may be substantially identical to the corresponding parameters in the second projection network 1070.

By minimizing the difference or maximizing the agreement between the output of the first projection network 1060 and the output of the second projection network 1070 when the first data augmenter 1020 and the second data augmenter 1030 output different transformations of the same image (or, additionally or alternatively, the first video 1025 and the second video 1035 contain similar images) from the training data 1010, the first base encoder 1040 may learn one or more visual representations of sign language. In some embodiments, after the first base encoder 1040 is trained, one or more other components such as other networks in the environment 1000 may not be used. In some embodiments, the first base encoder 1040 may be used as part of an ASLR system such as the ASLR 1215 described with reference to FIG. 11. For example, the first base encoder 1040 may be used to transform an image into a space that excludes at least some irrelevant information. For example, the video feature extractor 330 of FIG. 3 may include the first base encoder 1040. Additionally or alternatively, the video feature transformer 340 of FIG. 3 may include the first base encoder 1040.

Modifications, additions, or omissions may be made to the environment 1000 and/or the components operating in the environment 1000 without departing from the scope of the present disclosure. For example, in some embodiments, the environment 1000 may include any number of other components that may not be explicitly illustrated or described. Further, depending on certain implementations, the environment 1000 may not include one or more of the components illustrated and described. For example, one or more of the first projection network 1060 and the second projection network 1070 may be omitted. As another example, one or more of the first data augmenter 1020 and the second data augmenter 1030 may be omitted. As another example, the first data augmenter 1020 and the second data augmenter 1030 may obtain one or more images from separate sources such as video sequences recorded at different times or of different people. As another example, other training methods may be used to train the first base encoder network 1040 to learn one or more visual representations of sign language, including one or more of pretraining, Barlow Twins, feature clustering, simple framework for contrastive learning of visual representations (SimCLR), bootstrap your own latent (BYOL), contrastive learning, supervised contrastive learning, contrastive representation learning, and hard negative mining.

As another example, the first base encoder network 1040 and the first projection network 1060 may form an autoencoder. The autoencoder may include an encoder portion and a decoder portion. The first base encoder network 1040 may form the encoder portion. The first projection network 1060 may form the decoder portion. One or more bottleneck layers may exist at the connection between the first base encoder network 1040 and the first projection network 1060. The error signal 1085 may be determined using the difference between the input of the first base encoder network 1040 and the output of the first projection network 1060.

FIG. 11 illustrates an example environment 1100 for sign language communication. The environment 1100 may include a first training data 1110, a second training data 1120, an input video 1130, an ASLR model builder 1195, first network parameters 1145, second network parameters 1155, and an ASLR 1115. The ASLR 1115 may include a first network 1140 and a second network 1160. In some embodiments, the input video 1130, ASLR model builder 1195, and ASLR 1115 may be analogous to the video sample 310, ASLR model builder 395, and ASLR 315, respectively, of FIG. 3 and to the video 518, ASLR model builder 540, and recognizer 510, respectively, of FIG. 5.

In some embodiments, one or more of the first network 1140 and the second network 1160 may perform at least part of the operation of one or more of the video buffer 320, video feature extractor 330, feature buffer 325, video feature transformer 340, optic model 350, decoder 360, language translator 370, and TTS synthesizer 380 of FIG. 3. In some embodiments, the ASLR model builder 1195 may be analogous to at least part of one or more of the video feature extraction model builder 335, the video feature transformation model builder 345, the optic model builder 355, the language model builder 365, the language translation model builder 375, and the uploader 302 of FIG. 3.

The ASLR model builder 1195 may train the ASLR 1115. Training the ASLR 1115 may include determining ASLR model parameters. Determining the ASLR model parameters may include determining weights in one or more of the first network 1140 and the second network 1160. Training the ASLR 1115 may include training one or more of the first network 1140 and the second network 1160. Training the first network 1140 may include determining a set of one or more first network parameters 1145. The first network 1140 may use the first network parameters 1145 to perform at least some steps for converting sign language video into a spoken form. Training the second network 1160 may include determining a set of one or more second network parameters 1155. The second network 1160 may use the second network parameters 1155 to perform at least some steps for converting sign language video into a spoken form.

The ASLR model builder 1195 may use the first training data 1110 and second training data 1120 to determine one or more of the first network parameters 1145 and second network parameters 1155. The first network parameters 1145 and second network parameters 1155 may include neural network weights.

In some embodiments, the first training data 1110 may be unlabeled (i.e., may not include labels). The second training data 1120 may include labels. Labels may include textual or other information about the content of an image, a video, or an image and a video. For example, if a video includes a sequence of images of a person signing “father,” a label for the sequence of images may include the word “father.” The labeled video data may include labels that indicate which signs correspond to selected segments of the video. For example, the labels may indicate the endpoints and identity of signs in the videos. The endpoints of a sign may include the start time and end time of a sign. The identity of a sign may include one or more of the name of the sign, the corresponding spoken form (e.g., the word or phrase) of the sign, and the gloss.

The ASLR model builder 1195 may use the first training data 1110 to determine the first network parameters 1145. In determining the first network parameters 1145, the ASLR model builder 1195 may use one or more methods described with reference to FIG. 10, such as one or more of data augmentation, pretraining, and contrastive learning, for training the first base encoder network 1040.

In some embodiments, the first network 1140 may be trained using methods described with reference to FIG. 10 for training the first base encoder network 1040. Additionally or alternatively, the ASLR model builder 1195 may use weights from the trained first base encoder network 1040 as pretraining weights for the first network 1140. Additionally or alternatively, the ASLR model builder 1195 may use the second training data 1120 to determine the second network parameters 1155. Additionally or alternatively, the ASLR model builder 1195 may use the second training data 1120 to determine the first network parameters 1145 and the second network parameters 1155. In some embodiments, the ASLR model builder 1195 may use the first training data 1110 to pretrain the first network 1140. After the first network 1140 is pretrained, the ASLR model builder 1195 may use the second training data 1120 to tune one or more of the first network 1140 and the second network 1160.

Tuning a network may include starting with a first set of network parameters. In some embodiments, the first set of network parameters may be random. Additionally or alternatively, the first set of network parameters may be determined using at least one prior training episode such as a pretraining step. Tuning the network may include one or more additional training episodes to determine a second set of network parameters using the first set of network parameters as starting points. In some embodiments, one or more pretraining steps may occur before one or more tuning steps.

In some embodiments, video features may be sent to the input of the first network 1140. The output of the first network 1140 may be sent to the input to the second network 1160. The output of the second network 1160 may include the spoken form. Additionally or alternatively, the output of the second network 1160 may include gloss. The gloss may be sent to a language translator such as the language translator 370 of FIG. 3. The language translator may convert gloss to script. Additionally or alternatively, the output of the second network 1160 may be sent to the input to the first network 1140. The output of the first network 1140 may include one or more of gloss and the spoken form. Additionally or alternatively, the second network 1160 may be omitted. The first network 1140 may be pretrained using the first training data 1110 and tuned using the second training data 1120. In some embodiments, the ASLR 1115 may be configured as a transformer with one or more of attention, self-attention, and multi-head attention.

In some embodiments, the ASLR 1115 may include at least one neural network that includes the first network 1140 and the second network 1160. In some embodiments, the first network 1140 may include a first set of one or more layers in the neural network and the second network 1160 may include a second set one or more layers in the neural network. Additionally or alternatively, the first network 1140 may include a second set of one or more layers in the neural network and the second network 1160 may include a first set one or more layers in the neural network. One or more outputs of the first set of layers may be sent to the second set of layers. In a first phase, the ASLR model builder 1195 may use the first training data 1110 to train one or more of the first set of one or more layers and the second set of one or more layers. The first phase may be denoted as a pretraining phase. The ASLR model builder 1195 may include an instance of the ASLR 1115 for training. The ASLR model builder 1195 may use the second training data 1120 to train one or more of the first set of one or more layers and the second set of one or more layers. In some embodiments, the output of the first set of layers may be sent to the input to the second set of layers. Additionally or alternatively, the output of the second set of layers may be sent to the input of the first set of layers. In some embodiments, the first network 1140 may include an encoder. Additionally or alternatively, the second network 1160 may include a decoder.

In some embodiments, determining the parameters for the first network 1140 and the second network 1160 may include a pretraining phase followed by a tuning phase. The pretraining phrase may include determining a first set of weights by setting the weights to a constant value such as zero or one, setting the weights to random values, pretraining the weights using one or more methods described herein for training the first base encoder network 1040 of FIG. 10, or combinations thereof. The pretraining phase may use data from the first training data 1110 as input to the ASLR 1115. The data from the first training data 1110 may be unlabeled. Additionally or alternatively, the data from the first training data 1110 may be labeled. In some embodiments, the parameters of the first network 1140 may include the first set of weights. Additionally or alternatively, the parameters of one or more of the first network 1140 and the second network 1160 may include the first set of weights.

The tuning phase may include using one or more of video, gloss, and text from the second training data 1120 as input to the ASLR 1115. The video may include sign language. A first gloss may correspond to one or more labels associated with the sign language in the video. The ASLR 1115 may output a second gloss. The tuning phase may include comparing the first gloss to the second gloss to generate an error signal. The error signal may be responsive to how close the first gloss is to the second gloss. For example, the error signal may include the number of errors that appear in the second gloss, using the first gloss as a reference. The tuning phase may include adjusting the first set of weights to generate a second set of weights. The tuning phase may include further adjusting the second set of weights. Generating the second set of weights may include determining a set of weights that reduces the error signal. In some embodiments, tuning the ASLR 1115 may include adjusting weights in one or more of the first network 1140 and the second network 1160. Additionally or alternatively, tuning the ASLR 1115 may include not adjusting weights in one or more of the first network 1140 and the second network 1160. Additionally or alternatively, the tuning phase may include using one or more of video and gloss from one or more of the first training data 1110, the second training data 1120, and the input video 1130 as input to the ASLR model builder 1195.

An example of pretraining and tuning follows. In a pretraining phase, the ASLR model builder 1195 may use video from the first training data 1110 to pretrain the first network 1140. In a tuning phase, the ASLR model builder 1195 may use labeled video from the second training data 1120 to adjust weights in the second network 1160. The labeled video may include sign language video and corresponding gloss. Additionally or alternatively, in the tuning phase, the ASLR model builder 1195 may use labeled video from the second training data 1120 to adjust weights in the first network 1140 and the second network 1160.

After the ASLR 1115 is at least partly trained, the input video 1130 may be sent to the ASLR 1115. The ASLR 1115 may convert the video 1130 to one or more of gloss and a spoken form. After the ASLR 1115 is used to interpret sign language video from the input video 1130, the ASLR model builder 1195 may continue to train the ASLR 1115. This training may include determining or adjusting at least some model parameters using at least part of the input video 1130. In some embodiments, ASLR model builder 1195 may use call content such as one or more of audio, video, and text from live calls to train the ASLR 1115. Live calls may include calls currently in progress at the time of training. Live calls may include communication sessions between one or more callers using a service such as one or more of video calling, telephone calls, in-person conversations where at least two calling parties are in proximity to each other, and interpreted calls. Additionally or alternatively, the ASLR model builder 1195 may train the ASLR 1115 using call content from one or more of live calls, recorded calls, and other data sources. Training on call content may include the ASLR model builder 1195 using call content to determine one or more of the first network parameters 1145 and the second network parameters 1155. Training the ASLR 1115 on call content may occur during the call. In some embodiments, training the ASLR 1115 on call content may not occur substantially after the call ends. The ASLR model builder 1195 may temporarily retain (e.g., record, store on an HDD, store on an SSD, store in volatile memory such as RAM) call content during the call and delete the call content substantially at the end of the call. The ASLR model builder 1195 may use temporarily retained call content, up to the time the call content is deleted, to build ASLR models.

The end of the call may be defined as a point in time lying in an interval between the time when at least one calling party disconnects and an amount of time T after at least one calling party disconnects. Additionally or alternatively, the interval may start when all calling parties have disconnected. The interval of length T may give training systems time to respond to one or more indications that the interval has started and may give recording systems time to delete call content. Within the time interval, call content may be deleted. Additionally or alternatively, training the ASLR 1115 using call content from the call may end within the time interval. The ASLR 1115 may be trained using data sources other than call content after the interval ends. The length T of the interval may be a period of time such as 1, 2, 5, 10, 15, 30 or 60 seconds. Additionally or alternatively, the interval T may be determined to be less than a maximum period of time such as 1, 2, 5, 10, 15, 30 or 60 seconds.

In some embodiments, the ASLR model builder 1195 may train the ASLR 1115 using call content from one or more simultaneous live calls. For example, call content from one or more live calls occurring simultaneously may be sent to the ASLR model builder 1195. In a first step, the ASLR model builder 1195 may use call content from one or more calls simultaneously to train one or more of the ASLR 1115, the first network 1140, the second network 1160, first network parameters 1145, and second network parameters 1155. For example, the ASLR model builder 1195 may simultaneously use call content from a first call and a second call for training. Additionally or alternatively, the ASLR model builder 1195 may simultaneously use call content from one or more live calls and recorded data such as one or more of the first training data 1110 and the second training data 1120 for training.

If the first call ends and the second call continues, the ASLR model builder 1195 may delete content from the first call substantially at the end of the first call. In some embodiments, if the second call continues, the ASLR model builder 1195 may continue to train using call content from the second call.

In some embodiments, in a first step, the ASLR model builder 1195 may use call content from a first and second call to train the first network 1140. In a second step, the ASLR model builder 1195 may use data from the second training data 1120 to train the second network 1160. Data from the second training data 1120 may be labeled. Additionally or alternatively, in the second step, the ASLR model builder 1195 may use data from the second training data 1120 to train the first network 1140 and the second network 1160.

Modifications, additions, or omissions may be made to the environment 1100 and/or the components operating in the environment 1100 without departing from the scope of the present disclosure. For example, in some embodiments, the environment 1100 may include any number of other components that may not be explicitly illustrated or described. Further, depending on certain implementations, the environment 1100 may not include one or more of the components illustrated and described. For example, the first training data 1110 or the second training data 1120 may be omitted or the first training data 1110 and the second training data 1120 may be combined. As another example, the first network parameters 1145 or the second network parameters 1155 may be omitted or the first network parameters 1145 and the second network parameters 1155 may be combined. As another example, the operations performed by components operating in the environment 1100 may be distributed among multiple devices and/or systems such as remote servers. As another example, some components shown the environment 1100 may be combined into fewer components. As an example, at least some of the operations of the ASLR model builder 1195 may be incorporated into the ASLR 1115.

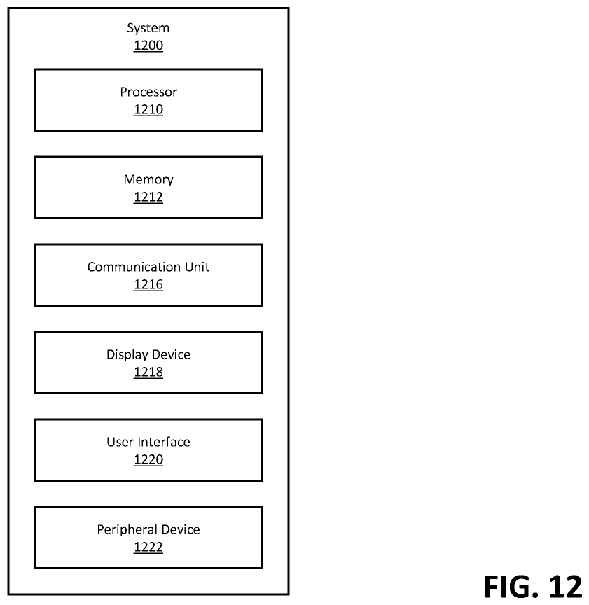

FIG. 12 illustrates an example system 1200 used for sign language communication as described in this disclosure. The system 1200 may include a processor 1210, memory 1212, a communication unit 1216, a display device 1218, a user interface unit 1220, and a peripheral device 1222, which all may be communicatively coupled. In some embodiments, the system 1200 may be part of any of the systems or devices described in this disclosure.

For example, the system 1200 may be part of the environment 100 of FIG. 1 and may be configured to perform one or more of the tasks described above with respect to the DP client 127, the HP client 132, the agent client 137, or the interpreter 110. As another example, the system 1200 may be part of the environment of FIG. 2 and may be configured to perform one or more of the tasks described above with respect to the DP client 227, the HP client 232, the agent client 237, or the interpreter 210. As another example, the system 1200 may be part of the system 300 of FIG. 3 and may be configured to perform one or more of the tasks described above with respect to the ASLR 315 or ASLR model builder 395. As another example, the system 1200 may be part of the environment 500 of FIG. 5 and may be configured to perform one or more of the tasks described above with respect to the recognizer 510, the ASLR model builder 540, the language translator 514, or the video labeler 549. As another example, the system 1200 may be part of the device 700 of FIG. 7 and may be configured to perform one or more of the tasks described above with respect to the field estimator 770, the field segmenter 780, the runtime field estimator 720, the runtime field segmenter 730, the ASLR 715, the training field estimator 725, the training field segmenter 735, or the ASLR model builder 795. As another example, the system 1200 may be part of the environments 910, 920, 930, or 940 of FIG. 9 and may be configured to perform one or more of the tasks described above with respect to the components of the environments 910, 920, 930, or 940. As another example, the system 1200 may be part of the environment 1000 of FIG. 10 and may be configured to perform one or more of the tasks described above with respect to the first data augmenter 1020, the second data augmenter 1030, the first base encoder network 1040, the first projection network 1060, or the agreement comparator 1080. As another example, the system 1200 may be part of the environment 1100 of FIG. 11 and may be configured to perform one or more of the tasks described above with respect to the ASLR model builder 1195 or the ASLR 1115.

Generally, the processor 1210 may include any suitable special-purpose or general-purpose computer, computing entity, or processing device including various computer hardware or software modules and may be configured to execute instructions stored on any applicable computer-readable storage media. For example, the processor 1210 may include a microprocessor, a microcontroller, a parallel computing array such as a single instruction multiple data (SIMD) processor, a vector processor, a graphics processing unit (GPU), tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 12, it is understood that the processor 1210 may include any number of processors distributed across any number of networks or physical locations that are configured to perform individually or collectively any number of operations described herein. In some embodiments, the processor 1210 may interpret and/or execute program instructions and/or process data stored in the memory 1212. In some embodiments, the processor 1210 may execute the program instructions stored in the memory 1212.

For example, in some embodiments, the processor 1210 may execute program instructions stored in the memory 1212 that are related to operations for interpreting sign language such that the system 1200 may perform or direct the performance of the operations associated therewith as directed by the instructions.

The memory 1212 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 1210.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 1210 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 1216 may include any component, device, system, or combination thereof that is configured to transmit or receive information over a network. In some embodiments, the communication unit 1216 may communicate with other devices at other locations, the same location, or even other components within the same system. For example, the communication unit 1216 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), a telephone jack, and/or the like. The communication unit 1216 may permit data to be exchanged with a network and/or any other devices or systems described in the present disclosure.

The display device 1218 may be configured as one or more displays that may present images, words, etc., like an LCD, LED, OLED, projector, or other type of display. The display device 1218 may be configured to present video, text captions, user interfaces, and other data as directed by the processor 1210. For example, when the system 1200 is included in one or more of the DP client 127, HP client 132, and agent client 137 of FIG. 1, the display device 1218 may be configured to present one or more of text and sign language video.

The user interface unit 1220 may include any device to allow a user to interface with the system 1200. For example, the user interface unit 1220 may include a mouse, a track pad, a keyboard, buttons, and/or a touchscreen, among other devices. The user interface unit 1220 may receive input from a user and provide the input to the processor 1210. In some embodiments, the user interface unit 1220 and the display device 1218 may be combined.

The peripheral device 1222 may include one or more devices. For example, the peripheral devices may include a microphone, an imager, a camera, and/or a speaker, among other peripheral devices. In these and other embodiments, the microphone may be configured to capture audio. The imager may be configured to capture images. The images may be captured in a manner to produce video or image data. In some embodiments, the speaker may present audio received by the system 1200 or otherwise generated by the system 1200 by broadcasting the audio.

Modifications, additions, or omissions may be made to the system 1200 without departing from the scope of the present disclosure. For example, in some embodiments, the system 1200 may include any number of other components that may not be explicitly illustrated or described. Further, depending on certain implementations, the system 1200 may not include one or more of the components illustrated and described.

As indicated above, the embodiments described herein may include the use of a special-purpose or general-purpose computer (e.g., the processor 1210 of FIG. 12) including various computer hardware or software modules, as discussed in greater detail below. Further, as indicated above, embodiments described herein may be implemented using computer-readable media (e.g., the memory 1212 of FIG. 12) for carrying or having computer-executable instructions or data structures stored thereon.

In some embodiments, a first method to interpret sign language is provided. The first method may comprise establishing a communication session; obtaining a video signal from the communication session that may include sign language; extracting features from the video signal; determining a matching function; using the matching function and a language model to determine one or more symbols; and using the one or more symbols to determine a script.

In some embodiments, the first method to interpret sign language may further comprise converting the script to an audio signal; directing the audio signal to a communication device, the communication device configured to present the audio signal to a user of the communication device.

In some embodiments, the one or more symbols may include glosses.

In some embodiments, using the one or more symbols to determine a script may include using language translation to convert glosses to script.

In some embodiments, a first corpus of glosses and a second corpus of script may be used to train a language translator.

In some embodiments, converting glosses to script may comprise using a language translator.

In some embodiments, the language translator may include a transformer with attention.

In some embodiments, the one or more symbols may include script.

In some embodiments, the language model may use a statistical language model.

In some embodiments, the language model may use a neural network.

In some embodiments, the language model may use a transformer with attention.

In some embodiments, the language model may include a matching function of one or more symbols.

In some embodiments, the language model may include a fitting statistic.

In some embodiments, the matching function may include a conditional probability.

In some embodiments, the matching function may include a joint probability.

In some embodiments, using the language model to determine one or more symbols may further comprise using the language model in a step that occurs after the one or more symbols have been determined.

In some embodiments, a second method to interpret sign language is provided. The second method may comprise establishing a first communication session; obtaining a first video that may include sign language and that may be unlabeled from the first communication session; using the first video to train a network; establishing a second communication session after the first communication session; obtaining a second video that may include sign language and that may be labeled from the second communication session; using the second video to train the network; establishing a third communication session; obtaining a third video from the third communication session; and using the network to obtain one or more symbols from the third video.

In some embodiments, the second method to interpret sign language may further comprise deleting the first video substantially at the end of the first communication session.

In some embodiments, the second video may include one or more labels, the one or more labels indicating one or more signs performed in the second video.

In some embodiments, an ASLR may be used to determine labels for the first video, the one or more labels indicating one or more signs performed in the first video.

In some embodiments, an ASLR may be used to determine labels for the second video, the one or more labels indicating one or more signs performed in the second video.

In some embodiments, the second method to interpret sign language may further comprise translating glosses into script.

In some embodiments, the second method to interpret sign language may further comprise converting the script to an audio signal.

In some embodiments, a third method to interpret sign language using an automated interpreter or a human interpreter is provided. The third method may comprise establishing a communication session and determining a call treatment in response to one or more call variables.

In some embodiments, call variables may include one or more of call characteristics, account status, and call type.

In some embodiments, the third method may further comprise connecting an automated interpreter to the communication session in response to the call treatment indicating use of an automated interpreter.

In some embodiments, the third method may further comprise connecting a human interpreter to the communication session in response to the call treatment indicating use of a human interpreter.

In some embodiments, the third method may further comprise obtaining a first audio from the communication session and using a speech recognizer to convert the first audio to a first text.

In some embodiments, the third method may further comprise using the first text to generate a first video and presenting the first video on a display, the first video including sign language.

In some embodiments, the third method may further comprise obtaining a second video from the communication session and sending the second video to an automated interpreter in response to the call treatment indicating use of an automated interpreter.

In some embodiments, the third method may further comprise obtaining a second video from the communication session and sending the second video to a human interpreter in response to the call treatment indicating use of a human interpreter.

In some embodiments, obtaining a second video from the communication session and sending the second video to an automated interpreter in response to the call treatment indicating use of an automated interpreter may further comprise using the second video to generate a second text; using the second text to generate a second audio; and using a speaker to play the second audio.

In some embodiments, the third method may further comprise using an automated interpreter to convert audio to sign language and using a human interpreter to convert sign language to audio.

In some embodiments, the third method may further comprise not using a human interpreter to convert audio to sign language and not using an automated interpreter to convert sign language to audio.

In some embodiments, the third method may further comprise using a human interpreter to convert audio to sign language and using an automated interpreter to convert sign language to audio.

In some embodiments, the third method may further comprise using not using an automated interpreter to convert audio to sign language and not using a human interpreter to convert sign language to audio.

In some embodiments, the third method may further comprise using an automated interpreter to convert audio to sign language and using a human interpreter to convert sign language to audio and to convert audio to sign language.

In some embodiments, the third method may further comprise using an automated interpreter to convert audio to sign language and using a human interpreter to convert sign language to audio in response to the call treatment indicating use of an automated interpreter for sign language generation and a human interpreter for sign language recognition.

In some embodiments, call variables may include a DP's preference for a human or an automated interpreter.

In some embodiments, call variables may include account status of the DP.

In some embodiments, call variables may include availability of human interpreters.

In some embodiments, the third method may further comprise connecting a human interpreter to the communication session in response to a human interpreter being available and connecting an automated interpreter to the communication session in response to a human interpreter not being available.

In some embodiments, the third method may further comprise determining the performance of the automated interpreter; comparing the performance to a selected standard; and, if the performance fails to meet the selected standard, disconnecting the human interpreter from the communication session.

In some embodiments, determining the performance of the automated interpreter may include obtaining a confidence score from the automated interpreter and using the confidence score to determine the performance of the automated interpreter.

In some embodiments, disconnecting the automated interpreter from the communication session may comprise connecting a human interpreter to the communication session.

In some embodiments, the third method may further comprise connecting an automated interpreter for a participant with a free account and a human interpreter for a participant with a paid account.

In some embodiments, a fourth method to interpret sign language is provided. The fourth method may comprise establishing a communication session; obtaining a first audio from the communication session; using the first audio to generate a first text; presenting the first text on a display associated with a human interpreter; generating a timestamp; using the timestamp to determine a first amount of time; delaying the first audio by the first amount of time; using a speaker to play the delayed first audio; obtaining a first video from the human interpreter; and using a display to present the first video.

In some embodiments, the timestamp may mark the start of a spoken word in the audio.

In some embodiments, the timestamp may mark the end of a spoken word in the audio.

In some embodiments, the first video may include sign language.

In some embodiments, using the first text to generate a first video may further comprise playing the audio over a speaker.

In some embodiments, the speaker may be associated with the human sign language interpreter.

In some embodiments, the first video may be presented on a display visible to a deaf user.

In some embodiments, using the first text to generate a first video may comprise using an automated sign language interpreter.

In some embodiments, the first amount of time may be a constant value, the constant value determined using an average processing delay of a speech recognizer.

In some embodiments, when the first audio is played before the first text is presented on a display, the first amount of time may be increased.

In some embodiments, when the first audio is played after the first text is presented on a display, the first amount of time may be decreased.

In some embodiments, the timestamp may be determined using an automatic speech recognizer.

In some embodiments, the first amount of time may be determined using the timestamp.

In some embodiments, the first amount of time may be determined so that the first audio is played at substantially the same time as the first text is presented.

In some embodiments, the fourth method may not generate a timestamp or delay the first audio.

In some embodiments, a fifth method to interpret sign language is provided. The fifth method may comprise establishing a communication session; obtaining a first video signal that may include sign language from the communication session; presenting the first video signal on a display in view of a first human interpreter; collecting a second video signal from the first human interpreter; and using an automated interpreter to convert the second video signal to a first text.

In some embodiments, the fifth method may further comprise converting the first text to audio and presenting the audio on a speaker.

In some embodiments, the automated interpreter may be adapted to the first human interpreter.

In some embodiments, the fifth method may further comprise determining the quality of the text; comparing the quality to a selected standard; and, if the quality fails to meet the selected standard, disconnecting the first human interpreter from the communication session.

In some embodiments, determining the quality of the text may include obtaining a confidence score from the automated interpreter and using the confidence score to determine the quality of the text.

In some embodiments, determining the quality of the first text may include using an automated interpreter to convert the second video signal to a second text and comparing the first text to the second text.

In some embodiments, comparing the first text to the second text may comprise determining one or more of an agreement rate, a disagreement rate, an error rate, and an accuracy rate.

In some embodiments, disconnecting the first human interpreter from the communication session may comprise connecting a second human interpreter to the communication session.

In some embodiments, the first human interpreter may be selected from a pool of deaf interpreters.

In some embodiments, connecting a second human interpreter to the communication session may include selecting a hearing interpreter.

In some embodiments, disconnecting the first human interpreter from the communication session may comprise connecting an automated interpreter to the communication session.

In some embodiments, a sixth method to interpret sign language is provided. The sixth method may comprise establishing a communication session; using a first human interpreter and an automated interpreter to interpret the communication session; comparing the output of the first human interpreter and the output of the automated interpreter to determine a score; and using the score to evaluate the first human interpreter.

In some embodiments, the score may be transmitted to one or more of the first human interpreter, another person, and a report.

In some embodiments, the score may be transmitted to one or more of the first human interpreter, another person, and a report during the communication session.

In some embodiments, the score may be transmitted to one or more of the first human interpreter, another person, and a report after the communication session.

In some embodiments, measuring the score may comprise determining one or more of an agreement rate, a disagreement rate, an error rate, and an accuracy rate.

In some embodiments, the sixth method may further comprise comparing the score to a threshold and, if the score falls below the threshold, raising an alert.

In some embodiments, the sixth method may further comprise comparing the score to a threshold and, if the score exceeds the threshold, raising an alert.

In some embodiments, the sixth method may further comprise responsive to an alert being raised, notifying one or more of the first human interpreter and another person.

In some embodiments, the sixth method may further comprise responsive to an alert being raised, disconnecting the first human interpreter from the communication session.

In some embodiments, disconnecting the first human interpreter from the communication session may further comprise connecting a second human interpreter to the communication session.

In some embodiments, the first human interpreter may be selected from a pool of deaf interpreters.

In some embodiments, connecting a second human interpreter to the communication session may include selecting a hearing interpreter.

In some embodiments, disconnecting the first human interpreter from the communication session may comprise connecting an automated interpreter to the communication session.

In some embodiments, comparing the output of the first human interpreter and the output of the automated interpreter to determine a score may comprise obtaining a first video from the communication session; presenting the first video on a display visible to the first human interpreter; obtaining a first audio from the first human interpreter; using a speech recognizer to convert the first audio to a first text; using an automated interpreter to convert the first video to a second text; and comparing the first text to the second text.

In some embodiments, comparing the first text to the second text may comprise determining one or more of an agreement rate, a disagreement rate, an error rate, an accuracy rate, and a count of the total number of word insertions, deletions, and substitutions.

In some embodiments, determining the error rate may comprise aligning the first text and the second text to each other, comparing the first text to the second text, and determining the total number of word insertions, deletions, and substitutions.

In some embodiments, determining the error rate may further comprise dividing the total number of word insertions, deletions, and substitutions by the number of words, wherein the number of words may be the number of words in the first text, the number of words in the second text, or the average number of words in the first text and the second text.

In some embodiments, comparing the output of the first human interpreter and the output of automated interpreter to determine a score may comprise obtaining a second audio from the communication session; presenting the second audio to the first human interpreter; obtaining a second video from the first human interpreter; using an automated interpreter to convert the second audio into a third video; and comparing the second video to the third video to determine a score.

In some embodiments, comparing the second video to the third video to determine a score may comprise using an automated interpreter to convert the second video to a third text; using an automated interpreter to convert the third video to a fourth text; and comparing the third text to the fourth text.

In some embodiments, comparing the third text to the fourth text may comprise aligning the third text with the fourth text and determining one or more of an agreement rate, a disagreement rate, an error rate, an accuracy rate, and a count of the total number of word insertions, deletions, and substitutions.

In some embodiments, comparing the output of the first human interpreter and the output of automated interpreter to determine a score may comprise obtaining a third audio from the communication session; presenting the third audio to the first human interpreter; obtaining a fourth video from the first human interpreter; determining whether the third audio includes speech; determining whether the fourth video includes signing; and determining whether the third audio from the communication session includes speech at substantially the same time as the fourth video includes signing.

In some embodiments, determining whether the fourth video includes signing may comprise processing the fourth video using motion detection.

In some embodiments, determining whether the third audio from the communication session includes speech may comprise processing the third audio using energy detection.

In some embodiments, comparing the output of the first human interpreter and the output of automated interpreter to determine a score may comprise obtaining a fifth video from the communication session; presenting the fifth video to the first human interpreter; obtaining a fourth audio from the first human interpreter; determining whether the fifth video includes signing; determining whether the fourth audio includes speech; and determining whether the fifth video includes signing at substantially the same time as the fourth audio includes speech.

In some embodiments, determining whether the fifth video includes signing may comprise processing the fifth video using motion detection.

In some embodiments, determining whether the fourth audio from the communication session includes speech may comprise processing the fourth audio using energy detection.

In some embodiments, a seventh method to interpret sign language is provided. The seventh method may comprise establishing a communication session; obtaining a video signal from the communication session that may include sign language; extracting features from the video signal; and using the features and a first model to determine a first matching function of a first symbol, wherein the first matching function is responsive to the first symbol and a first context of the first symbol.

In some embodiments, the first context of the first symbol may include one or more of a second symbol and a third symbol.

In some embodiments, the second symbol may immediately precede the first symbol.

In some embodiments, the third symbol may immediately follow the first symbol.

In some embodiments, one or more of the first symbol, the second symbol, and the third symbol may represent signs.

In some embodiments, one or more of the first symbol, the second symbol, and the third symbol may represent subsigns.

In some embodiments, one or more of the first symbol, the second symbol, and the third symbol may represent sign phrases.

In some embodiments, the first symbol may represent a second subsign in a first sign and a first subsign in a second sign.

In some embodiments, a seventh method further comprises using the features and a second model to determine a second matching function of the first symbol, wherein the second matching function is responsive to the first symbol and a second context of the first symbol.

In some embodiments, the first model may be implemented using a neural network.

In some embodiments, the different components, methods, modules, engines, and services described herein may be implemented as objects or processes that execute on a computing system (e.g., as separate threads). While some of the systems and methods described herein may be generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” “one or more of A, B, and C, etc.,” or “one or more of A, B, or C, etc,” is used, in general such a construction is intended to include A alone, B alone, C alone, A and B together, A and C together, B and C together, or A, B, and C together, etc. For example, the use of the term “and/or” is intended to be construed in this manner. As another example, a convention analogous to “one or more of A and B” is intended to include A alone. B alone, or A and B together.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

We claim:

1. A method comprising:
obtaining a first video data including sign language originating at a first device during a communication session;
obtaining, during the communication session, one or more features from the first video data;
determining one or more matching functions from the one or more features;
determining, using a language model, a first set of one or more symbols from the one or more matching functions; and
determining a second set of one or more symbols from the first set of one or more symbols.

2. The method of claim 1, wherein the first set of one or more symbols includes gloss.

3. The method of claim 1, wherein the second set of one or more symbols includes script.

4. The method of claim 1, wherein the language model uses gloss.

5. The method of claim 1, wherein determining a second set of one or more symbols from the first set of one or more symbols includes language translation from gloss to script.

6. The method of claim 1, further comprising providing the second set of one or more symbols for presentation on a display during the communication session.

7. The method of claim 1, further comprising:
generating a first audio from the second set of one or more symbols and
providing the first audio for presentation during the communication session.

8. The method of claim 1, wherein the language model includes a statistical language model.

9. The method of claim 1, wherein the language model uses at least one neural network.

10. The method of claim 1, further comprising determining a third set of one or more symbols from the second set of one or more symbols.

11. The method of claim 10, wherein determining a third set of one or more symbols from the second set of one or more symbols includes language translation from a first spoken language to a second spoken language.

12. The method of claim 11, further comprising:
generating a second audio from the third set of one or more symbols; and
providing the second audio for presentation during the communication session.

13. A method comprising:
obtaining a first video data including sign language originating at a first device during a communication session;
obtaining, during the communication session, one or more features from the first video data;
determining one or more matching functions from the one or more features using a first model, wherein the first model is associated with a second part of a first sign and a first part of a second sign; and
determining a first set of one or more symbols from the one or more matching functions.

14. The method of claim 13, further comprising translating the first set of one or more symbols into a second set of one or more symbols.

15. The method of claim 13, wherein the first set of one or more symbols includes gloss and the second set of one or more symbols includes script.

16. The method of claim 14, further comprising:
generating a first audio from the second set of one or more symbols; and
providing the first audio for presentation during the communication session.

17. The method of claim 13, further comprising determining one or more matching functions from the one or more features using a second model of a third sign.

18. The method of claim 17, wherein the second part of the first sign includes a first one or more states, the first part of the second sign includes a second one or more states, and the third sign includes a third one or more states.

19. The method of claim 18, wherein:
at least one state in the first part of the second sign is tied to at least one state in the third sign.

20. The method of claim 18, wherein:
at least one state in the first part of the second sign and at least one state in the third sign are the same state.
